(19) United States
(12) Patent Application Publication
(10) Pub. No.: US 2017/0116873 A1
(43) Pub. Date: Apr. 27, 2017

(54) CROWD-SOURCED ASSESSMENT OF PERFORMANCE OF AN ACTIVITY

(71) Applicant: C-SATS, Inc., Seattle, WA (US)

(72) Inventors: Thomas Sean Lendvay, Seattle, WA (US); Adam Muir Monsen, Seattle, WA (US); Derek Alan Streat, Seattle, WA (US)

(21) Appl. No.: 14/922,867

(22) Filed: Oct. 26, 2015

(51) Int. Cl. G09B 7/00; G09B 5/02

(52) U.S. Cl. CPC G09B 7/00; G09B 5/02

(57) ABSTRACT

Embodiments are directed to deploying a crowd to assess the performance of human-related activities. Content, such as video, audio, and/or textual content is captured. The content documents a subject's performance of the subject activity. The content, as well as an associated assessment tool (AT), are provided to reviewers. The AT includes questions that are directed to assessing domains of the performance. The reviewers review the content and assess the performance of the subject activity by providing assessment data. The assessment data includes answers to the questions of the AT. After a statistically significant number of independent reviewers have provided a statistically significant volume of assessment data, the assessment data is collated to generate statistical reviewer distributions of the independent assessments of various domains of the performance. A report is generated based on the collated assessment data. The report includes an overview of the crowd-sourced assessment of the performance.

### TECHNICAL FIELD

The present disclosure relates generally to the assessment of a performance of an activity, and more particular, but not exclusive, to deploying an online crowd to review content documenting a performance of the activity and assess the performance of domains of the activity.

### BACKGROUND

Assessing the performance of an individual or team or group of individuals is required in many areas of human activity, including professional activities, athletic activities, customer-service activities, and the like. For instance, the training of an individual or group to enter into a professional field requires lengthy cycles of the individual or group practicing an activity related to the field and a teacher, trainer, mentor, or other individual who has already mastered the activity (an expert) assessing the individual's or group's capabilities. Even after the lengthy training period, certain professions require an on-going assessment of the individual's or group's competency to perform certain activities related to the field. In many fields of human activity, the availability of experts to observe and assess the performance of others is limited. Furthermore, the cost associated with an expert assessing the performance of others may be prohibitively expensive. Finally, even if availability and cost challenges are overcome, expert peer review, which is often unblinded, can yield biased and inaccurate results.

Additionally, the wide availability of inexpensive video cameras, and other content capturing devices, is enabling an increasing demand for ex post facto assessments of individuals or groups performing activities. For example, due to the wide adoption of dashboard cameras and body cameras by law-enforcement agencies, the volume of video content documenting the activities of police officers is increasing at a staggering rate. Such an increasing supply of content and increasing demand for assessing individuals or groups documented in the content is further exacerbating issues associated with a limited pool of individuals assessing the performance of other individuals or groups. It is for these and other concerns that the following disclosure is offered.

### BRIEF DESCRIPTION OF THE DRAWINGS

FIG. 1 is a system diagram of an environment in which embodiments of the invention may be implemented;

FIG. 2 shows an embodiment of a client computer that may be included in a system such as that shown in FIG. 1;

FIG. 3 illustrates an embodiment of a server computer that may be included in a system such as that shown in FIG. 1;

FIG. 4 shows an overview flowchart for a process to deploy a plurality of reviewers to assess the performance of subject or group activity, in accordance with at least one of the various embodiments;

FIG. 5A shows an overview flowchart for a process for capturing content documenting subject or group activity, in accordance with at least one of the various embodiments;

FIG. 5B shows an overview flowchart for a process for processing captured content, in accordance with at least one of the various embodiments;

FIG. 6A shows an overview flowchart for a process for associating an assessment tool with content, in accordance with at least one of the various embodiments;

FIG. 6B shows an overview flowchart for a process for providing processed content and an associated assessment tool to the subject for subject feedback, in accordance with at least one of the various embodiments;

FIG. 7 shows an overview flowchart for a process or providing the content and the associated assessment tool to the reviewers, in accordance with at least one of the various embodiments;

FIG. 8 shows an overview flowchart for process for collating assessment data provided by reviewers, in accordance with at least one of the various embodiments

FIG. 9 shows a non-limiting exemplary embodiment of a protocol for a nurse to follow when using a glucometer device to measure the glucose level of a patient;

FIG. 10A illustrates an exemplary embodiment of an assessment tool that may be associated with content documenting a surgeon's performance of a robotic surgery in the various embodiments;

FIG. 10B illustrates another exemplary embodiment of an assessment tool that may be associated with content documenting another performance of a healthcare provider;

FIG. 11A illustrates an exemplary embodiment web interface employed to provide a reviewer at least content documenting a surgeon's performance of a robotic surgery and the associated assessment tool of FIG. 10A;

FIGS. 11B-11C illustrates another exemplary embodiment web interface 1180 employed to provide a reviewer at least content documenting a nurse's performance of using a glucometer device to measure blood glucose levels and an associated assessment tool;

FIG. 11D illustrates an exemplary embodiment web interface employed to provide a reviewer at least content documenting a sales associate's performance of a customer interaction and an associated assessment tool;

FIG. 12A illustrates an exemplary embodiment of portion of a report, generated by various embodiments disclosed here, that provides a detailed overview of the crowd-sourced assessment of the subject's performance of the subject activity;

FIG. 12B illustrates an exemplary embodiment of another portion of the report of FIG. 12A, generated by various embodiments disclosed here, that provides the detailed overview of the crowd-sourced assessment of the subject's performance of the subject activity;

FIG. 12C illustrates an exemplary embodiment of yet another portion of the report of FIG. 12A, generated by various embodiments disclosed here, that provides the detailed overview of the crowd-sourced assessment of the subject's performance of the subject activity;

FIG. 12D illustrates additional learning opportunities that are automatically provided to a subject by the various embodiments disclosed herein;

FIG. 12E illustrates an exemplary embodiment of a team dashboard that is included in a report, generated by various embodiments disclosed here, that provides a detailed overview of the crowd-sourced assessment of a sales team's performance of various customer interactions;

FIG. 13A illustrates a scatterplot showing a correlation between reviewer generated overall scores and expert reviewer generated overall scores, consistent with the various embodiments disclosed herein;

FIG. 13B illustrates a curve showing a correlation between a reviewer generated overall score and an expert-assessed failure rate;

FIG. 13C illustrates the curve demonstrating the various embodiments enabling the improvement of subject skills;

FIG. 13D illustrates a histogram showing a crowd-sourced assessment of the success rate for performing each step in a protocol that is provided to a subject;

FIGS. 14A-14B show exemplary embodiment web interfaces that enable real-time remote mentoring;

FIG. 15A shows an exemplary embodiment team dashboard for a team of five surgeons being trained by one of the various embodiments disclosed herein, wherein the dashboard shows the improvement of each of the surgeons over a period of time;

FIG. 15B shows the exemplary embodiment team dashboard of FIG. 15A, wherein the dashboard shows the team's overall improvement over the period of time;

FIG. 15C shows the exemplary embodiment team dashboard of FIG. 15A, wherein the dashboard shows the team's improvement over the period of time for various technical domains;

FIG. 15D shows the exemplary embodiment team dashboard of FIG. 15A, wherein the dashboard shows various metrics for the team that may be viewable by a manager of the team; and

FIG. 16 shows a training module to train a crowd reviewer that is consistent with the various embodiments disclosed herein.

### DETAILED DESCRIPTION OF THE INVENTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may be entirely hardware embodiments, entirely software embodiments, or embodiments combining software and hardware aspects. The following detailed description should, therefore, not be limiting.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “subject” may refer to any individual human or a plurality of humans, as one as one or more robots, machines, or any other autonomous, or semi-autonomous apparatus, device, or the like, where the various embodiments are directed to an assessment of the subject's performance of an activity. In addition, as used herein, the terms “subject activity,” or “activity” may refer to any activity, including but not limited to physical activities, mental activities, machine and/or robotic activities, and other types of activities, such as writing, speaking, manufacturing activities, athletic performances, and the like. The physical activity may be performed by, or controlled by a subject, where the various embodiments are directed to the assessment of the performance of the subject activity by the subject. Many of the embodiments discussed herein refer to an activity performed by a human, although the embodiments are not so constrained. As such, in other embodiments, an activity is performed by a machine, a robot, or the like. The performance of these activities may also be assessed by the various embodiments disclosed herein.

As used herein, the term “content” may refer to any data that documents the performance of the subject activity by the subject. For instance, content may include, but is not limited to image data, including still image data and/or video image data, audio data, textual data, and the like. Accordingly, content may be image content, video content, audio content, textual content, and the like.

As used herein, the term “expert reviewer” may refer to an individual that has acquired, either through specialized education, experience, and/or training, a level of expertise in regards to the subject activity. An expert reviewer may be qualified to review content documenting the subject activity and provide an assessment to aspects or domains of the subject activity that require expert-level judgement. An expert reviewer may be a peer of the subject or may have a greater level of experience and expertise in the subject activity, as compared to the subject. An expert reviewer may be known to the subject or may be completely anonymous.

As used herein, the term “crowd reviewer” may be a layperson that has no or minimal specialized education, experience, and/or training in regards to the subject activity. A crowd reviewer may be qualified to review content documenting the subject activity and provide an assessment to aspects or domains of the subject activity that do not require expert-level judgement. A crowd reviewer may be trained by the embodiments discussed herein to develop or increase their experience in evaluating various subject performances.

As used herein, the terms “technical aspect” or “technical domains” may refer to aspects or domains of the subject activity that may be reviewed and assessed by a crowd reviewer and/or an expert reviewer. As used herein, the terms “non-technical aspect” or “non-technical domains” may refer to aspects or domains of the subject activity that require an expert-level judgement to review and assess. Accordingly, an expert reviewer is qualified to review and assess non-technical aspects or domains of the performance of the subject activity. In contrast, a crowd reviewer may not be inherently qualified to review and assess non-technical aspects or domains of the performance of the subject activity. However, embodiments are not so constrained, and a crowd reviewer may be qualified to assess non-technical aspects of domains, such as but not limited to provider-patient interactions, bedside manner, and the like.

Briefly stated, embodiments are directed to deploying a crowd to assess the performance of human-related or other activities, such as but not limited to machine or robot-related activities. In many circumstances, the use of expert reviewers to assess the performance of individuals may be prohibitively expensive. Furthermore, a requirement for the timely assessment of a large number of subjects may overwhelm a limited availability of expert reviewers. However, by reviewing content that documents the performance of a subject activity, a crowd of non-expert reviewers may quickly and efficiently converge on an assessment of the subject's performance of the subject activity.

For many activities, or at least a portion of the domains associated with many activities, the assessment provided by a crowd of non-expert reviewers is equivalent to, similar to, or at least highly correlated with an expert reviewer generated assessment of the same performance. Accordingly, in various embodiments, the “wisdom of the crowd” is harnessed to quickly, efficiently, and cost-effectively determine an assessment of the performance of subject activities.

In various embodiments, content, such as but not limited to video, audio, and/or textual content is captured. The content documents a subject's performance of a subject activity. The content, as well as an associated assessment tool (AT), are provided to a plurality of reviewers. The AT includes questions that are directed to assessing various domains of the performance of the subject activity. The reviewers review the content and assess the domains of the performance.

In various embodiments, the reviewers provide assessment data, including answers to the questions included in the AT. The reviewer-generated answers to the questions are based on each reviewer's independent assessment of the documented performance. After a statistically significant number of independent reviewers have provided a statistically significant volume of assessment data, the assessment data is collated to generate statistical reviewer distributions of the assessment of various technical and non-technical domains of the performance of the subject activity. In the various embodiments, a party that is directing the review may determine the desired statistical significant. A report may be generated based on the distributions of the collated reviewer assessment data. The report may include various levels of details indicating an overview of the crowd-sourced assessment of the performance of the subject activity.

In the various embodiments, the activity that is documented and assessed may be virtually any activity that is regularly performed by one or more humans, as well as machines, robots, or other autonomous or semi-autonomous apparatus. The subject activity may be related to health care, law enforcement, athletics, customer service, retail, manufacturing, or any other activity that humans regularly perform. Due to the ever-increasing available bandwidth of the internet, as well as the wide adoption of networked computers, such as but not limited to desktops, laptops, smartphones, tablets, and the like, large volumes of content documenting the activity of subjects may be provided to large numbers of reviewers almost instantaneously. Furthermore, because large numbers of reviewers are scattered across the globe and available at almost any hour of any given day, statistically significant distributions of assessment data used to assess the performance of the subject activity may be generated relatively quickly upon the availability of the content documenting the subject activity.

Some of the various embodiments are directed to assessing the performance of activities that only experts may perform, such as but not limited to providing healthcare services, law-enforcement duties, legal services, or customer-related services, as well as athletic or artistic performances.

However, a crowd of non-experts may accurately and precisely assess the performance of the technical and possibly other domains of the subject activity, even for subject activities that require an expert to perform. Statistical distributions generated from assessment data provided by a large number of independent, widely available, and cost-effective non-expert reviewers may determine an assessment that is as good, or even better, than an assessment determined by costly expert reviewers, for at least the technical domains of the subject activity.

For instance, in one non-limiting exemplary embodiment, the subject activity to be assessed may be robotic surgery. Although only surgeons (experts) may perform a robotic surgery, non-surgeons may assess technical domains of the performance of a robotic surgery. For example, in various embodiments, non-surgeons (crowd reviewers) may assess technical domains of the performance of a robotic surgery documented in video content. Such technical domains include, but are not otherwise limited to depth perception, bimanual dexterity, efficiency force sensitivity, robotic control, and the like. Statistical distributions of non-expert generated independent assessments of such technical domains may provide assessments that are similar to, or at least correlated with, assessments provided by expert reviewers. Furthermore, non-expert reviewers may readily assess if a subject has followed a particular protocol when performing the subject activity.

Accordingly, the reviewers that review the content and assess the performance of the subject activity may include a plurality of relatively inexpensive and widely available non-expert reviewers, i.e. crowd reviewers. In addition to or in the alternative, the reviewers may include honed crowd reviewers. A honed crowd reviewer is a crowd reviewer, i.e. a non-expert reviewer, that has been certified, qualified, validated, trained or otherwise credentialed based on previous reviews and assessments provided by the honed crowd reviewer, or through valid criteria inherently making them honed such as demographic information that makes the crowd or crowd worker particularly suited to the task of assessment (i.e. a medical technician within the pool of crowd workers assessing a medical technique) A honed crowd reviewer may have previously reviewed and assessed the performance of a significant number of subjects and/or subject activities.

In some embodiments, various tiered-levels of honed crowd reviewers may be included in the plurality of reviewers. For instance, a honed crowd reviewer may be a top-tiered, a second-tiered, a third-tiered honed crowd reviewer, or the like. A tier or rating of a particular honed crowd reviewer may be based on the crowd reviewer's previous experience relating to reviewing content and assessing documented performances or relating to the vocation or skill of the crowd reviewer. In some embodiments, a honed crowd reviewer has demonstrated previous success in independently replicating the assessment of other honed crowd reviewers and/or expert reviewers. In at least one embodiment, the previous assessments of a honed crowd reviewer are similar to, or at least highly correlated with, assessments provided by other honed reviewers and/or expert reviewers.

Thus, for any given assessment task, the content and an associated AT are provided to a plurality of reviewers. Depending upon various constraints of the assessment task, such as overall budget, time constraints, number of subjects to be assessed, the total volume of content to be reviewed, desired level of statistical significance, and the like, the plurality of reviewers may include various absolute numbers and ratios of crowd reviewers, honed crowd reviewers, and/or expert reviewers.

As mentioned above, expert reviewers may have limited availability and their reviewing and assessment services may be relatively expensive. The availability of honed crowd reviewers is significantly greater and the associated cost of their services is significantly less than the cost of expert reviewers. In various embodiments, the cost of crowd reviewer services may be even less than the cost of honed crowd reviewer services. Furthermore, crowd reviewers may be more readiliy available than honed crowd reviewers. Accordingly, the absolute numbers and ratios of crowd reviewers, honed crowd reviewers, and expert reviewers included in a specific plurality of reviewers may be based upon the type of activity to be reviewed and assessed, the desired statistical significance of the assessment, as well as budgetary and time constraints of the assessment task.

In various embodiments, the AT used to assess the performance of the subject activity is automatically associated with the content based on at least the type of subject activity that is documented in the content. The AT may include one or more questions that are directed to the domains to be assessed by the plurality of reviewers.

The associated AT may be a validated AT. For instance, an AT that has been previously validated for robotic surgeries may be automatically associated with content documenting the performance of a robotic surgery. The association between the content documenting the performance and an AT may be based on at least the efficacy of the AT as demonstrated in prior research, the accuracy of the AT as demonstrated in prior performance assessments, and tags generated for the content. The tags may at least partially indicate the type of subject activity documented in the content. In various embodiments, a blended AT may be generated to associate with the content. The blended AT may include questions from a plurality of AT within an AT database. Individuals may be enabled to include additional questions with the associated AT.

The various embodiments are directed to practically any situation where an assessment of the performance of an activity is advantageous. For instance, the various embodiments may be deployed in educational and/or training scenarios, where an assessment of a subject's performance is instrumental in training and improving the skills of the subject. For instance, the various embodiments may be used by medical training institutions. Such embodiments may be employed to generate quick and cost-effective feedback to health care providers, such as doctors, nurses, and the like, that are in training Such feedback may accelerate the learning experience of doctors, nurses, attorneys, athletes, law-enforcement officers, and other professionals that must develop skills by practicing an activity and incorporating feedback of an assessment of their performance of the activity.

Various embodiments may be used by potential employers and/or recruiters. Employers may quickly determine the skills of potential employees by crowd sourcing the reviewing and assessment of content documenting multiple performances of the potential employees. The potential employees may be ranked based on the crowd-sourced assessment. Employers may base hiring decisions, entry levels, compensation packages, and the like on such rankings of potential employers.

Furthermore, the various embodiments may enable employers to achieve better outcome by ensuring employees use improved techniques and adhere to proper protocol. Recruiters may employ at least one of the various embodiments to quickly and cost-effectively objectively evaluate the skills of a large number of potential job candidates. Employers may use at least one of the various embodiments to ensure customer support representatives adhere to proper protocol. Employers may eliminate bias in the performance assessment of employers. Similarly, the various embodiments may reduce risk for peer or employee review and improve compliance to protocols related to human-resources activities and requirements. Retail locations may be continuously monitored to ensure adherence to organization standards, as well as sanitary and customer-service oriented goals.

Similarly, organizations that are charged with credentialing specialists may determine if candidate specialists have reliably demonstrated the minimum requirements to receive credentials, based on the various embodiments of crowd-sourced assessments disclosed herein. Protocol training facilities, as well as organizations that are required to verify compliance of safety regulations may deploy at least a portion of their monitoring and assessing tasks to a crowd via various embodiments disclosed herein.

Some embodiments may be used to satisfy requirements in regards to continuing education of professionals, such as licensed doctors, lawyers, certified public accountants (CPAs), and the like. For instance, a surgeon may obtain required continuing medical education (CME) credits by either being assessed by a crowd or assessing other surgeons via the various embodiments disclosed herein. Likewise, attorneys may obtain continuing legal education (CLE) credits by assessing the performance of other attorneys, or being assessed by crowds including non-attorneys.

The various embodiments may be employed in promotional and marketing contexts. For instance, an institution may have the skills of each of their agents, or at least random samples of their agents, routinely assessed by a crowd. The crowd assessment provides an objective measurement of the agents' skills. The institution may actively promote itself by publicizing the objective determinations of its agents' skills, as compared to other institutions that have similarly been objectively assessed.

In other contexts, the various embodiments may be used to determine a history of the performance of a practitioner, such as a medical care practitioner. Content documenting a progression of the practitioner's performance may be provided to various crowds. Patterns of performances that meet or fall below a standard of case may be detected via assessing the performances. Such embodiments may be useful in the context of malpractice settings. In at least one embodiment, at least an approximate geo-location of the reviewers in the crowd is determined. Such locational information may be used in the various embodiments to determine local and global standards of care for various practitioners. In at least some embodiments, at least one or more reviewers, such as but not limited to a crowd reviewer, may provide real-time, or near real-time, feedback and/or review data, to the subject as the subject performs the subject activity. In at least one embodiment, a plurality of reviewers may provide real-time, or near real-time, review data to the subject, so that the subject may improve their performance of the subject activity, as the subject is performing the subject activity.

### Illustrated Operating Environment

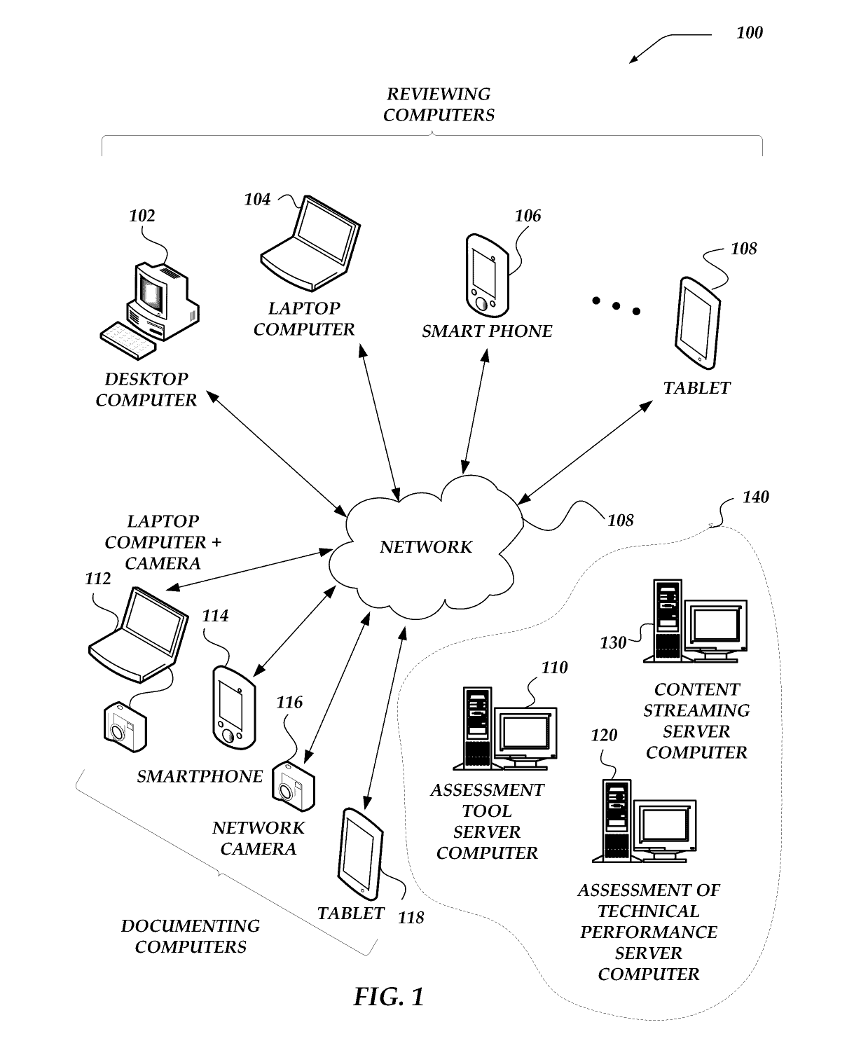

FIG. 1 shows components of one embodiment of an environment in which various embodiments of the invention may be practiced. Not all of the components may be required to practice the various embodiments, and variations in the arrangement and type of the components may be made without departing from the spirit or scope of the invention. As shown, system 100 of FIG. 1 may include assessment tool server computer (ATSC) 110, assessment of technical performance server computer (ATPSC) 120, content streaming server computer (CSSC) 130, reviewing computers 102-106, documenting computers 112-118, and network 108.

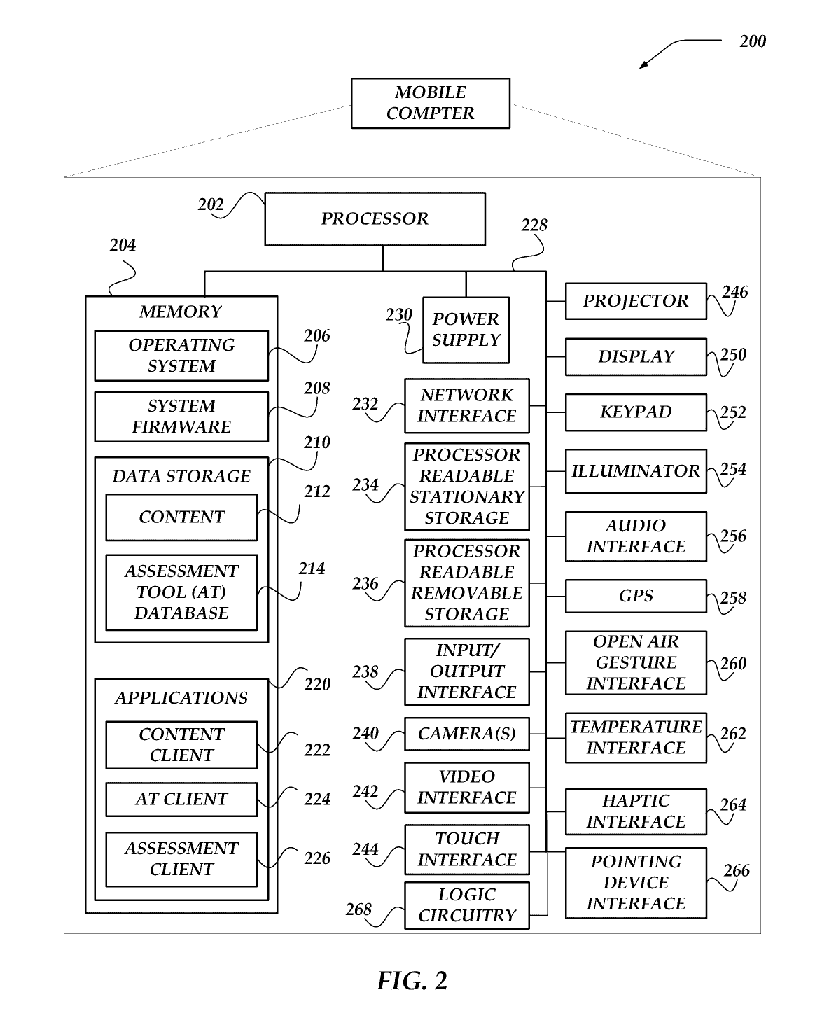

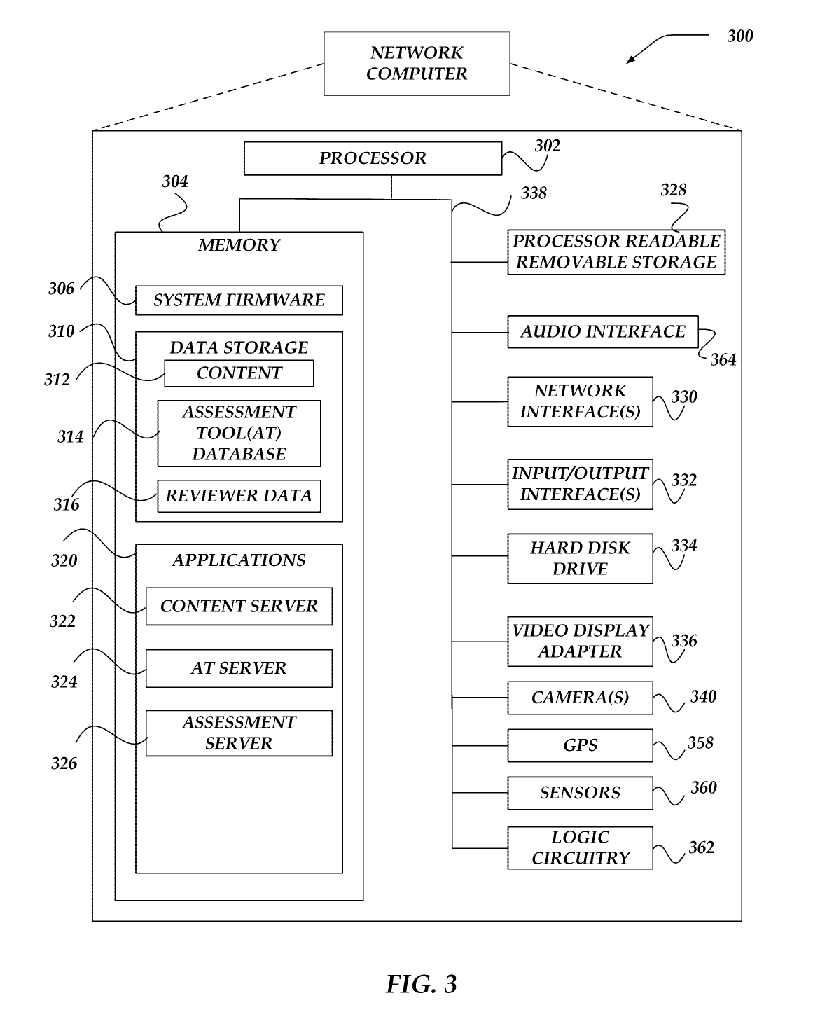

In various embodiments, system 100 includes an assessment of technical performance (ATP) platform 140. ATP platform 140 may include one or more server computers, such as but not limited to ATSC 110, ATPSC 120, and CSSC 130. ATP platform 140 may include one or more instances of mobile or network computers, including but not limited to any of mobile computer 200 of FIG. 2 and/or network computer 300 of FIG. 3. In at least one embodiment, ATP platform 140 includes at least one or more of the documenting computers 112-118 and/or one or more of the reviewing computers 102-106. Various embodiments of ATP platform 140 may enable the continuous evaluation of a subject iteratively performing a subject activity, which may in turn enable the improvement of the domains of the subject's performance.

Although not shown, in some embodiments, ATP platform 140 may include one or more additional server computers to perform at least a portion of the various processes discussed herein. For instance, ATP platform 140 may include one or more sourcing server computers, training server computers, honing server computers, and/or aggregating server computers. For instance, these additional server computers may be employed to source, train, hone, and aggregate crowd and expert reviewers. At least a portion of the server computers included in ATP platform 140, such as but not limited these additional server computers, ATCS 110, ATPSC 120, CSSC 130, and the like may at least partially form a data layer of the ATP platform 140. Such a data layer may interface with and append data to other platforms and other layers within ATP platform 140. For instance, the data layer may interface with other crowd-sourcing platforms.

Although not shown, ATP platform 140 may include one or more data storage devices, such as rack or chassis-based data storage systems. Any of the databases discussed herein may be at least partially stored in data storage devices within platform 140. As shown, any of the network devices, including the data storage devices included in platform 140 are accessible by other network devices, via network 108.

Various embodiments of documenting computers 112-118 are described in more detail below in conjunction with mobile computer 200 of FIG. 2. Furthermore, at least another embodiment of documenting computers 112-118 is described in more detail in conjunction with network computer 300 of FIG. 3. Briefly, in some embodiments, at least one of the documenting computers 112-118 may be configured to communicate with at least one mobile and/or network computer included in ATP platform 140, including but not limited to ATSC 110, ATPSC 120, CSSC 130, and the like. In various embodiments, one or more documenting computers 112-118 may be enabled to capture content that documents human activity. The content may be image content, including but not limited to video content. In at least one embodiment, the content includes audio content. Documenting computers 112-118 may provide the captured content to at least one computer included in ATP platform 140. In at least some embodiments, one or more documenting computers 112-118 may include or be included in various industry-specific or proprietary systems. For instance, one of documenting computers 112-118, as well as a storage device, may be included in a surgical robot, such as but not limited to a da Vinci Surgical System™ from Intuitive Surgical™. In at least one of the various embodiments, a user of a documenting computer may be enabled to generate suggestions, such as trim, timestamp, annotation, tag, and/or assessment tool suggestions to a computer included in ATP 140. The generated suggestions may be provided to ATP platform 140.

In at least one of various embodiments, documenting computers 112-118 may be enabled to capture content documenting human activity via image sensors, cameras, microphones, and the like. Documenting computers 112-118 may be enabled to communicate (e.g., via a Bluetooth or other wireless technology, or via a USB cable or other wired technology) with a camera. In some embodiments, at least some of reviewing computers 102-106 may operate over a wired and/or wireless network, including network 108, to communicate with other computing devices, including any of reviewing computers 102-108 and/or any computers included in ATP platform 140.

Generally, documenting computers 112-118 may include computing devices capable of communicating over a network to send and/or receive information, perform various online and/or offline activities, or the like. It should be recognized that embodiments described herein are not constrained by the number or type of documenting computers employed, and more or fewer documenting computers—and/or types of documenting computers—than what is illustrated in FIG. 1 may be employed. At least one documenting computer 112-118 may be a client computer.

Devices that may operate as documenting computers 112-118 may include various computing devices that typically connect to a network or other computing device using a wired and/or wireless communications medium. Documenting computers 112-118 may include mobile devices, portable computers, and/or non-portable computers. Examples of non-portable computers may include, but are not limited to, desktop computers, personal computers, multiprocessor systems, microprocessor-based or programmable electronic devices, network PCs, or the like, or integrated devices combining functionality of one or more of the preceding devices. Examples of portable computers may include, but are not limited to, laptop computer 112. Laptop computer 112 is communicatively coupled to a camera via a Universal Serial Bus (USB) cable or some other (wired or wireless) bus capable of transferring data. Examples of mobile computers include, but are not limited to, smart phone 114, tablet computers 186, cellular telephones, display pagers, Personal Digital Assistants (PDAs), handheld computers, wearable computing devices, or the like, or integrated devices combining functionality of one or more of the preceding devices. Documenting computers may include a networked computer, such as networked camera 116. As such, documenting computers 112-118 may include computers with a wide range of capabilities and features.

Documenting computers 112-118 may access and/or employ various computing applications to enable users to perform various online and/or offline activities. Such activities may include, but are not limited to, generating documents, gathering/monitoring data, capturing/manipulating images, managing media, managing financial information, playing games, managing personal information, browsing the Internet, or the like. In some embodiments, documenting computers 112-118 may be enabled to connect to a network through a browser, or other web-based application.

Documenting computers 112-118 may further be configured to provide information that identifies the documenting computer. Such identifying information may include, but is not limited to, a type, capability, configuration, name, or the like, of the documenting computer. In at least one embodiment, a documenting computer may uniquely identify itself through any of a variety of mechanisms, such as an Internet Protocol (IP) address, phone number, Mobile Identification Number (MIN), media access control (MAC) address, electronic serial number (ESN), or other device identifier.

Various embodiments of reviewing computers 102-108 are described in more detail below in conjunction with mobile computer 200 of FIG. 2. Furthermore, at least one embodiment of reviewing computers 102-108 is described in more detail in conjunction with network computer 300 of FIG. 3. Briefly, in some embodiments, at least one of the reviewing computers 102-108 may be configured to communicate with at least one mobile and/or network computer included in ATP platform 140, including but not limited to ATSC 110, ATPSC 120, CSSC 130, and the like. In various embodiments, one or more reviewing computers 102-108 may be enabled to access, interact with, and/or view user interfaces, streaming content, assessment tools, and the like provided by ATP platform 140, such as through a web browser. In at least one of various embodiments, a user of a reviewing computer may be enabled to review content and assessment tools provided by ATP platform 140. The user may be enabled to provide assessment data and/or quantitative assessment data to ATP platform 140, as well as receive one or more assessment reports from ATP platform 140.

In at least one of various embodiments, reviewing computers 102-108 may be enabled to receive content and one or more assessment tools. Reviewing computers 102-108 may be enabled to communicate (e.g., via a Bluetooth or other wireless technology, or via a USB cable or other wired technology) with ATP platform 140. In some embodiments, at least some of reviewing computers 102-108 may operate over a wired and/or wireless network to communicate with other computing devices, including any of documenting computers 112-118 and/or any computer included in APT platform 140.

Generally, documenting computers 102-108 may include computing devices capable of communicating over a network to send and/or receive information, perform various online and/or offline activities, or the like. It should be recognized that embodiments described herein are not constrained by the number or type of reviewing computers employed, and more or fewer reviewing computers—and/or types of reviewing computers—than what is illustrated in FIG. 1 may be employed. At least one reviewing computer 102-108 may be a client computer.

Devices that may operate as reviewing computers 102-108 may include various computing devices that typically connect to a network or other computing device using a wired and/or wireless communications medium. Reviewing computers 102-108 may include mobile devices, portable computers, and/or non-portable. Examples of non-portable computers may include, but are not limited to, desktop computers 102, personal computers, multiprocessor systems, microprocessor-based or programmable electronic devices, network PCs, or the like, or integrated devices combining functionality of one or more of the preceding devices. Examples of portable computers may include, but are not limited to, laptop computer 104. Examples of mobile computers include, but are not limited to, smart phone 106, tablet computers 108, cellular telephones, display pagers, Personal Digital Assistants (PDAs), handheld computers, wearable computing devices, or the like, or integrated devices combining functionality of one or more of the preceding devices. As such, documenting computers 102-108 may include computers with a wide range of capabilities and features.

Reviewing computers 102-108 may access and/or employ various computing applications to enable users to perform various online and/or offline activities. Such activities may include, but are not limited to, generating documents, gathering/monitoring data, capturing/manipulating images, reviewing content, managing media, managing financial information, playing games, managing personal information, browsing the Internet, or the like. In some embodiments, reviewing computers 102-108 may be enabled to connect to a network through a browser, or other web-based application.

Reviewing computers 102-108 may further be configured to provide information that identifies the reviewing computer. Such identifying information may include, but is not limited to, a type, capability, configuration, name, or the like, of the reviewing computer. In at least one embodiment, a reviewing computer may uniquely identify itself through any of a variety of mechanisms, such as an Internet Protocol (IP) address, phone number, Mobile Identification Number (MIN), media access control (MAC) address, electronic serial number (ESN), or other device identifier.

Various embodiments of ATSC 110 are described in more detail below in conjunction with network computer 300 of FIG. 3. At least one embodiment of ATSC 110 is described in conjunction with mobile computer 200 of FIG. 2. Briefly, in some embodiments, ATSC 110 may be operative to determined candidate assessment tools, select assessment tools, and/or associate assessment tools with content. ATSC 110 may be operative to communicate with documenting computers 112-118 to enable users of documenting computers 112-118 to generate and provide suggestions, including suggestions to process content and associate assessment tools with the content. ATSC 110 may enable users of documenting computers 112-118 to provide feedback regarding processed content and associated assessment tool. ATSC 110 may be operative to communicate with reviewing computers 102-108 to provide users of reviewing computers 102-108 various assessment tools and/or receive assessment data and qualitative assessment data.

Various embodiments of ATPSC 120 are described in more detail below in conjunction with network computer 300 of FIG. 3. At least one embodiment of ATPSC 120 is described in conjunction with mobile computer 200 of FIG. 2. Briefly, in some embodiments, ATPSC 120 may be operative to receive assessment data and qualitative assessment data. ATPSC 120 may be operative to collate reviewer data and generate a report based on the reviewer data. ATPSC 120 may be operative to communicate with documenting computers 112-118. ATSC 120 may be operative to communicate with reviewing computers 102-108 to provide users of reviewing computers 102-108 various assessment tools and/or receive assessment data and qualitative assessment data and receive assessment data.

Various embodiments of CSSC 130 are described in more detail below in conjunction with network computer 300 of FIG. 3. At least one embodiment of CSSC 130 is described in conjunction with mobile computer 200 of FIG. 2. Briefly, in some embodiments, CSSC 130 may be operative to provide content and associated assessment tools. CSSC 130 may be operative to communicate with documenting computers 112-118 to enable users of documenting computers 112-118 to provide captured content that documents human activity. ATSC 110 may be operative to communicate with reviewing computers 102-108 to provide users of reviewing computers 102-108 with content and one or more associated assessment tools. In at least one embodiment, the CSSC 130 streams the content to users of reviewing computers 102-108.

Network 108 may include virtually any wired and/or wireless technology for communicating with a remote device, such as, but not limited to, USB cable, Bluetooth, Wi-Fi, or the like. In some embodiments, network 108 may be a network configured to couple network computers with other computing devices, including reviewing computers 102-105, network computers 112, and the like. In at least one of various embodiments, sensors may be coupled to network computers via network 108, which is not illustrated in FIG. 1. In various embodiments, information communicated between devices may include various kinds of information, including, but not limited to, processor-readable instructions, remote requests, server responses, program modules, applications, raw data, control data, system information (e.g., log files), video data, voice data, image data, text data, structured/unstructured data, or the like. In some embodiments, this information may be communicated between devices using one or more technologies and/or network protocols.

In some embodiments, such a network may include various wired networks, wireless networks, or any combination thereof. In various embodiments, the network may be enabled to employ various forms of communication technology, topology, computer-readable media, or the like, for communicating information from one electronic device to another. For example, the network can include—in addition to the Internet—LANs, WANs, Personal Area Networks (PANs), Campus Area Networks, Metropolitan Area Networks (MANs), direct communication connections (such as through a universal serial bus (USB) port), or the like, or any combination thereof.

In various embodiments, communication links within and/or between networks may include, but are not limited to, twisted wire pair, optical fibers, open air lasers, coaxial cable, plain old telephone service (POTS), wave guides, acoustics, full or fractional dedicated digital lines (such as T1, T2, T3, or T4), E-carriers, Integrated Services Digital Networks (ISDNs), Digital Subscriber Lines (DSLs), wireless links (including satellite links), or other links and/or carrier mechanisms known to those skilled in the art. Moreover, communication links may further employ any of a variety of digital signaling technologies, including without limit, for example, DS-0, DS-1, DS-2, DS-3, DS-4, OC-3, OC-12, OC-48, or the like. In some embodiments, a router (or other intermediate network device) may act as a link between various networks—including those based on different architectures and/or protocols—to enable information to be transferred from one network to another. In other embodiments, remote computers and/or other related electronic devices could be connected to a network via a modem and temporary telephone link. In essence, the network may include any communication technology by which information may travel between computing devices.

The network may, in some embodiments, include various wireless networks, which may be configured to couple various portable network devices, remote computers, wired networks, other wireless networks, or the like. Wireless networks may include any of a variety of sub-networks that may further overlay stand-alone ad-hoc networks, or the like, to provide an infrastructure-oriented connection for at least reviewing computer 102-108, documenting computers 112-118, and the like. Such sub-networks may include mesh networks, Wireless LAN (WLAN) networks, cellular networks, or the like. In at least one of the various embodiments, the system may include more than one wireless network.

The network may employ a plurality of wired and/or wireless communication protocols and/or technologies. Examples of various generations (e.g., third (3G), fourth (4G), or fifth (5G)) of communication protocols and/or technologies that may be employed by the network may include, but are not limited to, Global System for Mobile communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000 (CDMA2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), time division multiple access (TDMA), Orthogonal frequency-division multiplexing (OFDM), ultra wide band (UWB), Wireless Application Protocol (WAP), user datagram protocol (UDP), transmission control protocol/Internet protocol (TCP/IP), any portion of the Open Systems Interconnection (OSI) model protocols, session initiated protocol/real-time transport protocol (SIP/RTP), short message service (SMS), multimedia messaging service (MMS), or any of a variety of other communication protocols and/or technologies. In essence, the network may include communication technologies by which information may travel between reviewing computers 102-108, documenting computers 112-118, computers included in ATP platform 140, other computing devices not illustrated, other networks, and the like.

In various embodiments, at least a portion of the network may be arranged as an autonomous system of nodes, links, paths, terminals, gateways, routers, switches, firewalls, load balancers, forwarders, repeaters, optical-electrical converters, or the like, which may be connected by various communication links. These autonomous systems may be configured to self organize based on current operating conditions and/or rule-based policies, such that the network topology of the network may be modified.

### Illustrative Mobile Computer

FIG. 2 shows one embodiment of mobile computer 200 that may include many more or less components than those shown. Mobile computer 200 may represent, for example, at least one embodiment of documenting computers 112-118, reviewing computers 102-108, or a computer included in ATP platform 140. So, mobile computer 200 may be a mobile device (e.g., a smart phone or tablet), a stationary/desktop computer, or the like.

Mobile computer 200 may include processor 202, such as a central processing unit (CPU), in communication with memory 204 via bus 228. Mobile computer 200 may also include power supply 230, network interface 232, processor-readable stationary storage device 234, processor-readable removable storage device 236, input/output interface 238, camera(s) 240, video interface 242, touch interface 244, projector 246, display 250, keypad 252, illuminator 254, audio interface 256, global positioning systems (GPS) receiver 258, open air gesture interface 260, temperature interface 262, haptic interface 264, pointing device interface 266, or the like. Mobile computer 200 may optionally communicate with a base station (not shown), or directly with another computer. And in one embodiment, although not shown, an accelerometer or gyroscope may be employed within mobile computer 200 to measuring and/or maintaining an orientation of mobile computer 200.

Additionally, in one or more embodiments, the mobile computer 200 may include logic circuitry 268. Logic circuitry 268 may be an embedded logic hardware device in contrast to or in complement to processor 202. The embedded logic hardware device would directly execute its embedded logic to perform actions, e.g., an Application Specific Integrated Circuit (ASIC), Field Programmable Gate Array (FPGA), and the like.

Also, in one or more embodiments (not shown in the figures), the mobile computer may include a hardware microcontroller instead of a CPU. In at least one embodiment, the microcontroller would directly execute its own embedded logic to perform actions and access it's own internal memory and it's own external Input and Output Interfaces (e.g., hardware pins and/or wireless transceivers) to perform actions, such as System On a Chip (SOC), and the like.

Power supply 230 may provide power to mobile computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling mobile computer 200 to one or more networks, and is constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of mobile computer 200, e.g., using voice recognition, detecting touch based on sound, and the like. A microphone may be used to capture content documenting the performance of a subject activity.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the mobile device is powered. Also, illuminator 254 may backlight these buttons in various patterns when particular actions are performed, such as dialing another mobile computer. Illuminator 254 may also cause light sources positioned within a transparent or translucent case of the mobile device to illuminate in response to actions.

Mobile computer 200 may also comprise input/output interface 238 for communicating with external peripheral devices or other computers such as other mobile computers and network computers. Input/output interface 238 may enable mobile computer 200 to communicate with one or more servers, such as MCSC 110 of FIG. 1. In some embodiments, input/output interface 238 may enable mobile computer 200 to connect and communicate with one or more network computers, such as documenting computers 112-118 and reviewing computers 102-118 of FIG. 1. Other peripheral devices that mobile computer 200 may communicate with may include remote speakers and/or microphones, headphones, display screen glasses, or the like. Input/output interface 238 can utilize one or more technologies, such as Universal Serial Bus (USB), Infrared, Wi-Fi, WiMax, Bluetooth™, wired technologies, or the like.

Haptic interface 264 may be arranged to provide tactile feedback to a user of a mobile computer 200. For example, the haptic interface 264 may be employed to vibrate mobile computer 200 in a particular way when another user of a computer is calling. Temperature interface 262 may be used to provide a temperature measurement input and/or a temperature changing output to a user of mobile computer 200. Open air gesture interface 260 may sense physical gestures of a user of mobile computer 200, for example, by using single or stereo video cameras, radar, a gyroscopic sensor inside a computer held or worn by the user, or the like. Camera 240 may be used to track physical eye movements of a user of mobile computer 200. Camera 240 may be used to capture content documenting the performance of subject activity.

GPS transceiver 258 can determine the physical coordinates of mobile computer 200 on the surface of the Earth, which typically outputs a location as latitude and longitude values. Physical coordinates of a mobile computer that includes a GPS transceiver may be referred to as geo-location data. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of mobile computer 200 on the surface of the Earth. It is understood that under different conditions, GPS transceiver 258 can determine a physical location for mobile computer 200. In at least one embodiment, however, mobile computer 200 may, through other components, provide other information that may be employed to determine a physical location of the mobile computer, including for example, a Media Access Control (MAC) address, IP address, and the like. In at least one embodiment, GPS transceiver 258 is employed for localization of the various embodiments discussed herein. For instance, the various embodiments may be localized, via GPS transceiver 258, to customize the linguistics, technical parameters, time zones, configuration parameters, units of measurement, monetary units, and the like based on the location of a user of mobile computer 200.

Human interface components can be peripheral devices that are physically separate from mobile computer 200, allowing for remote input and/or output to mobile computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a mobile computer with such peripheral human interface components is a wearable computer, which might include a remote pico projector along with one or more cameras that remotely communicate with a separately located mobile computer to sense a user's gestures toward portions of an image projected by the pico projector onto a reflected surface such as a wall or the user's hand.

A mobile computer 200 may include a browser application that is configured to receive and to send web pages, web-based messages, graphics, text, multimedia, and the like. Mobile computer's 200 browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

In various embodiments, the browser application may be configured to enable a user to log into an account and/or user interface to access/view content data. In at least one of various embodiments, the browser may enable a user to view reports of assessment data that is generated by ATP platform 110 of FIG. 1. In some embodiments, the browser/user interface may enable the user to customize a view of the report. As described herein, the extent to which a user can customize the reports may depend on permissions/restrictions for that particular user.

In various embodiments, the user interface may present the user with one or more web interfaces for capturing content documenting a performance. In some embodiments, the user interface may present the user with one or more web interfaces for reviewing content and assessing a performance of a subject activity.

Memory 204 may include RAM, ROM, and/or other types of memory. Memory 204 illustrates an example of computer-readable storage media (devices) for storage of information such as computer-readable instructions, data structures, program modules or other data. Memory 204 may store system firmware 208 (e.g., BIOS) for controlling low-level operation of mobile computer 200. The memory may also store operating system 206 for controlling the operation of mobile computer 200. It will be appreciated that this component may include a general-purpose operating system such as a version of UNIX, or LINUX™, or a specialized mobile computer communication operating system such as Windows Phone™, or the Symbian® operating system. The operating system may include, or interface with a Java virtual machine module that enables control of hardware components and/or operating system operations via Java application programs.

Memory 204 may further include one or more data storage 210, which can be utilized by mobile computer 200 to store, among other things, applications 220 and/or other data. For example, data storage 210 may store content 212 and/or assessment tool (AT) database 214. Data storage 210 may further include program code, data, algorithms, and the like, for use by a processor, such as processor 202 to execute and perform actions. In one embodiment, at least some of data storage 210 might also be stored on another component of mobile computer 200, including, but not limited to, non-transitory processor-readable removable storage device 236, processor-readable stationary storage device 234, or even external to the mobile device. Removable storage device 236 may be a USB drive, USB thumb drive, dongle, or the like.

Applications 220 may include computer executable instructions which, when executed by mobile computer 200, transmit, receive, and/or otherwise process instructions and data. Applications 220 may include content client 222. Content client 222 may capture, manage, and/or receive content that documents human activity. Applications 220 may include Assessment Tool (AT) client 224. AT client 224 may select, associate, provide, manage, and query assessment tools.

The assessment tools may be stored in AT database 214. Applications 220 may also include Assessment client 226. Assessment client 226 may provide and/or receive assessment data and qualitative assessment data. Assessment client 226 may collate reviewer data and/or generate, provide, and/or receive reports based on the reviewer data.

Other examples of application programs that may be included in applications 220 include, but are not limited to, calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

So, in some embodiments, mobile computer 200 may be enabled to employ various embodiments, combinations of embodiments, processes, or parts of processes, as described herein. Moreover, in various embodiments, mobile computer 200 may be enabled to employ various embodiments described above in conjunction with computer device of FIG. 1.

### Illustrative Network Computer

FIG. 3 shows one embodiment of network computer 300, according to one embodiment of the invention. Network computer 300 may represent, for example, at least one embodiment of documenting computers 112-118, reviewing computers 102-108, or a computer included in ATP platform 140. Network computer 300 may be a desktop computer, a laptop computer, a server computer, a client computer, and the like.

Network computer 300 may include processor 302, such as a CPU, processor readable storage media 328, network interface unit 330, an input/output interface 332, hard disk drive 334, video display adapter 336, GPS 338, and memory 304, all in communication with each other via bus 338. In some embodiments, processor 302 may include one or more central processing units.

Additionally, in one or more embodiments (not shown in the figures), the network computer may include an embedded logic hardware device instead of a CPU. The embedded logic hardware device would directly execute its embedded logic to perform actions, e.g., an Application Specific Integrated Circuit (ASIC), Field Programmable Gate Array (FPGA), and the like.

Also, in one or more embodiments (not shown in the figures), the network computer may include a hardware microcontroller instead of a CPU. In at least one embodiment, the microcontroller would directly execute its own embedded logic to perform actions and access it's own internal memory and it's own external Input and Output Interfaces (e.g., hardware pins and/or wireless transceivers) to perform actions, such as System On a Chip (SOC), and the like.

As illustrated in FIG. 3, network computer 300 also can communicate with the Internet, cellular networks, or some other communications network (either wired or wireless), via network interface unit 330, which is constructed for use with various communication protocols. Network interface unit 330 is sometimes known as a transceiver, transceiving device, or network interface card (NIC). In some embodiments, network computer 300 may communicate with a documenting computer, reviewing computer, or a computer included in an ATP platform, or any other network computer, via the network interface unit 320.

Network computer 300 also comprises input/output interface 332 for communicating with external devices, such as a various sensors or other input or output devices not shown in FIG. 3. Input/output interface 332 can utilize one or more communication technologies, such as USB, infrared, Bluetooth™, or the like.

Memory 304 generally includes RAM, ROM and one or more permanent mass storage devices, such as hard disk drive 334, tape drive, optical drive, and/or floppy disk drive. Memory 304 may store system firmware 306 for controlling the low-level operation of network computer 300 (e.g., BIOS). In some embodiments, memory 304 may also store an operating system for controlling the operation of network computer 300.

Although illustrated separately, memory 304 may include processor readable storage media 328. Processor readable storage media 328 may be referred to and/or include computer readable media, computer readable storage media, and/or processor readable storage device. Processor readable removable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 304 further includes one or more data storage 310, which can be utilized by network computer 300 to store, among other things, content 312, assessment tool (AT) database 314, reviewer data 316, and/or other data. For example, data storage 310 may further include program code, data, algorithms, and the like, for use by a processor, such as processor 302 to execute and perform actions. In one embodiment, at least some of data storage 310 might also be stored on another component of network computer 300, including, but not limited to processor-readable storage media 328, hard disk drive 334, or the like.

Content data 312 may include content that documents a subject's performance of a subject activity. Likewise, AT database 314 may include a collection of one or more ATs used to assess the performance of the subject activity that is documented in the content data 312. Reviewer data 316 may include reviewer generated assessment data, qualitative assessment data, and reviewer account preferences, credentials, and other reviewer related data.

Applications 320 may include computer executable instructions that can execute on processor 302 to perform actions. In some embodiments, one or more of applications 320 may be part of an application that may be loaded into mass memory and run on an operating system

Applications 320 may include content server 322, AT server 324, and assessment server 326. Content server 322 may capture, manage, and/or receive content that documents human activity. AT server 324 may select, associate, provide, manage, and query assessment tools. The assessment tools may be stored in AT database 314. Assessment server 326 may provide and/or receive assessment data and qualitative assessment data. Assessment server 326 may collate reviewer data and/or generate, provide, and/or receive reports based on the reviewer data.

Furthermore, applications 320 may include one or more additional applications, such as but not limited to a sourcing server, a training server a honing server, an aggregation server, and the like. These server applications may be employed to source, train, hone, and aggregate crowd and expert reviewers. At least a portion of the server applications in applications 320 may at least partially form a data layer of the ATP platform 140 of FIG. 1.

GPS transceiver 358 can determine the physical coordinates of network computer 300 on the surface of the Earth, which typically outputs a location as latitude and longitude values. Physical coordinates of a network computer that includes a GPS transceiver may be referred to as geo-location data. GPS transceiver 358 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 358 can determine a physical location for network computer 300. In at least one embodiment, however, network computer 300 may, through other components, provide other information that may be employed to determine a physical location of the mobile computer, including for example, a Media Access Control (MAC) address, IP address, and the like. In at least one embodiment, GPS transceiver 358 is employed for localization of the various embodiments discussed herein. For instance, the various embodiments may be localized, via GPS transceiver 258, to customize the linguistics, technical parameters, time zones, configuration parameters, units of measurement, monetary units, and the like based on the location of a user of mobile computer 200.

User interface 324 may enable the user to provide the collection, storage, and transmission customizations described herein. In some embodiments, user interface 324 may enable a user to view to collected data in real-time or near-real time with the network computer.

Audio interface 364 may be arranged to produce and receive audio signals such as the sound of a human voice. For example, audio interface 354 may be coupled to a speaker and microphone (not shown) to enable telecommunication with others and/or generate an audio acknowledgement for some action. A microphone in audio interface 364 can also be used for input to or control of network computer 300, e.g., using voice recognition, detecting touch based on sound, and the like. A microphone may be used to capture content documenting the performance of a subject activity. Likewise, camera 340 may be used to capture content documenting the performance of subject activity. Other sensors 360 may be included to sense a location, or other environment component.

Additionally, in one or more embodiments, the network computer 300 may include logic circuitry 362. Logic circuitry 362 may be an embedded logic hardware device in contrast to or in complement to processor 302. The embedded logic hardware device would directly execute its embedded logic to perform actions, e.g., an Application Specific Integrated Circuit (ASIC), Field Programmable Gate Array (FPGA), and the like.

So, in some embodiments, network computer 300 may be enabled to employ various embodiments, combinations of embodiments, processes, or parts of processes, as described herein. Moreover, in various embodiments, network computer 300 may be enabled to employ various embodiments described above in conjunction with computer device of FIG. 1.

### Generalized Operations

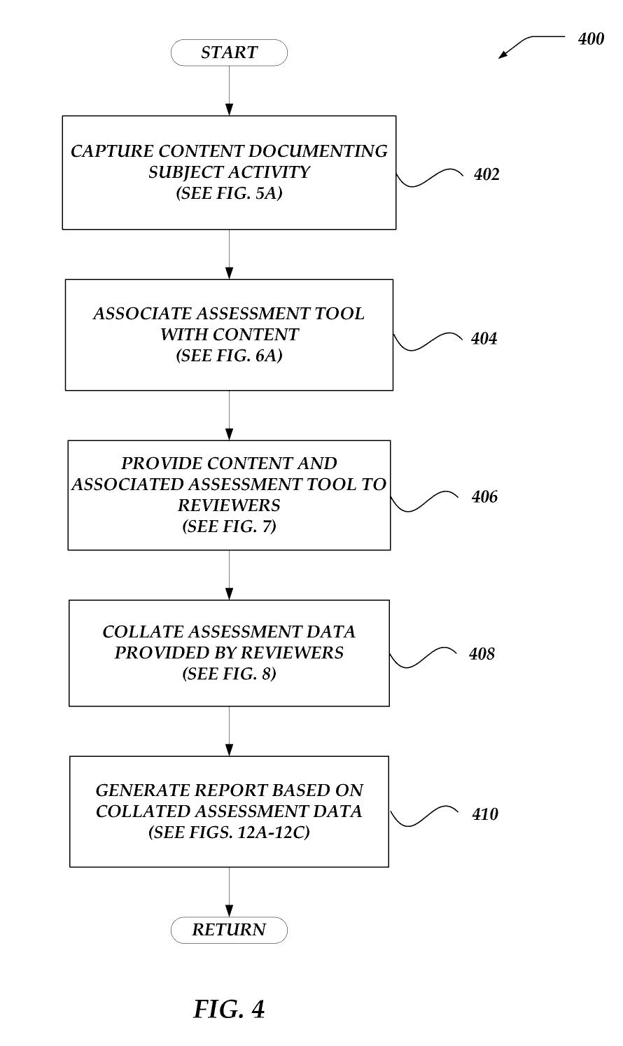

The operation of certain aspects of the invention will now be described with respect to FIGS. 4-8. In at least one of various embodiments, processes 400, 500, 540, 600, 640, 700, and 800 described in conjunction with FIGS. 4-8, respectively, or portions of these processes may be implemented by and/or executed on a network computer, such as network computer 300 of FIG. 3. In other embodiments, these processes or portions of these processes may be implemented by and/or executed on a plurality of network computers, such as network computer 300 of FIG. 3. Further, in other embodiments, these processes or portions of these processes may be implemented by and/or executed on one or more mobile computers, such as mobile computer 200 as shown in FIG. 2. Also, in at least one of the various embodiments, these processes or portions of these processes may be implemented by and/or executed on one or more cloud instances operating in one or more cloud networks. However, embodiments are not so limited and various combinations of network computers, client computer, cloud computer, or the like, may be utilized. These processes or portions of these processes may be implemented on any computer of FIG. 1, including, but not limited to documenting computers 112-118, reviewing computers 102-108, or any computer included in ATP platform 140.

FIG. 4 shows an overview flowchart for process 400 to deploy a plurality of reviewers to assess the performance of subject activity, in accordance with at least one of the various embodiments. Both technical and non-technical domains of the subject activity may be assessed with the various embodiments. In some embodiments, a crowd may be deployed to at least partially assess the performance of the subject activity, e.g. the plurality of reviewers may include a crowd, where the crowd includes a plurality of crowd reviewers. For instance, the crowd may assess technical domains of the performance of the subject activity. In at least one embodiment, the plurality of reviewers includes a honed crowd, where the honed crowd includes a plurality of honed crowd reviewers. The plurality of reviewers may include one or more expert reviewers, such that the one or more expert reviewers may perform at least a portion of the assessment of the subject activity. In various embodiments, the expert reviewers may assess non-technical domains of the performance of the subject activity. In at least one embodiment, the one or more expert reviewers may assess technical domains of the performance of the subject activity. The plurality of reviewers may include any combination of crowd reviewers, honed crowd reviewers, and/or expert reviewers.

Although various embodiments discussed herein are in the context of healthcare-related subject activity, other embodiments are not so constrained and the subject activity may be any activity that is performed by one or more humans. For instance, the subject activity may be related to law enforcement, athletics, customer service, retail, manufacturing, or any other activity that humans regularly perform. As noted throughout, the subject and the corresponding subject activity are not limited to human and human-related activities. Rather, in at least some embodiments, the one or more subjects may include an autonomous or semi-autonomous apparatus, such as but not limited to a machine or a robot.

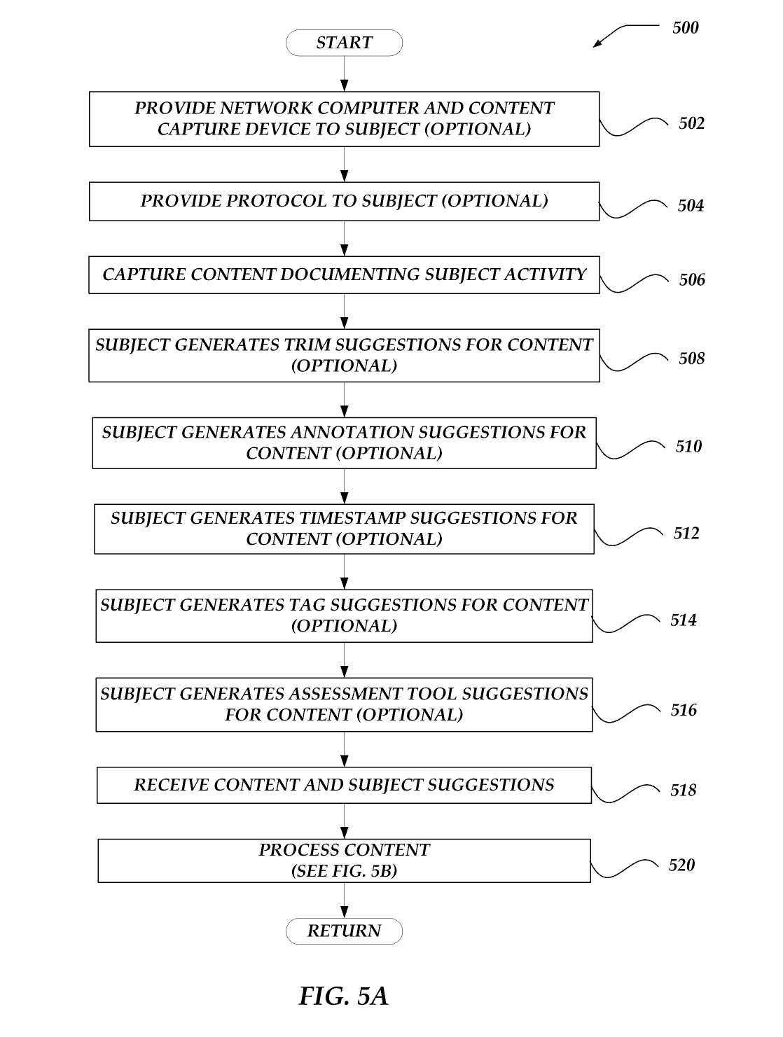

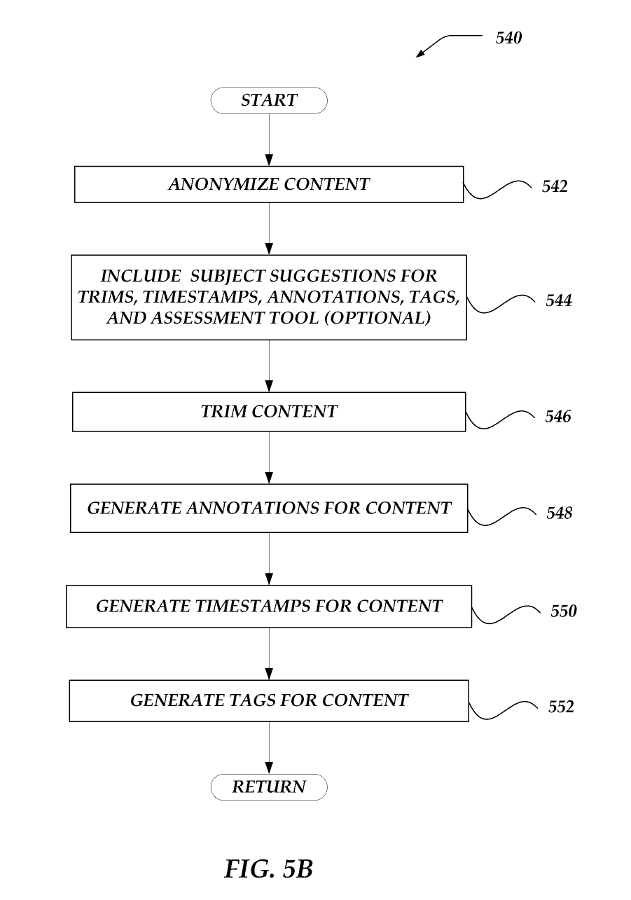

After a start block, at block 402, in at least one of the various embodiments, content documenting the subject activity is captured. Various embodiments for capturing content documenting the performance of the subject activity are discussed in at least conjunction with process 500 of FIG. 5A. However briefly, at block 402, content that documents the performance of subject activity is captured via a content capturing device, such as but not limited to a documenting computer. For instance, at least one of the documenting computers 112-118 of FIG. 1 may capture content documenting subject activity performed by a subject.

The captured content may be any content that documents the subject activity, including but not limited to still images, video content, audio content, textual content, biometrics, and the like. For example, a video that documents a surgeon performing a surgery (including but not limited to a robotic surgery) may be captured at block 502. In other embodiments, a video of a phlebotomist drawing blood from a patient or a video of a nurse operating a glucometer to obtain a patient's glucose level may be captured at block 502. The content may document the subject performing various protocols, such as a handwashing protocol, a home dialysis protocol, a training protocol, or the like. As discussed further below, at least a portion of the captured content is provided to reviewers, such as crowd reviewers. As discussed throughout, the reviewers review the content and provide assessment data in regards to the performance of the subject activity. Each reviewer provides assessment data that indicates their independent assessment of the subject's performance of the subject activity.

As mentioned above, the subject activity in the various embodiments is not limited to subjects providing healthcare. For instance, a subject may be a law-enforcement officer (LEO) and the subject activity may be the performance of one or more LEO-related duties. A camera worn on the person of a LEO (a body camera) or a camera included in a LEO vehicle, such as a dashboard camera, may capture content documenting the LEO performing one or more activities. For instance, process 400 may be directed towards the assessment of the LEO when performing a routine traffic stop, arresting a suspect, investigating a crime scene, or any other such duty that the LEO may be called upon to perform. As discussed throughout, the various embodiments may be directed towards crowd sourcing the assessment of the LED's performance of her various duties, as well as assessing the actives of the individual that the LEO is interacting with.

With the current adoption of both dashboard cameras and body cameras, the volume of video content documenting the activities of LEOs (or other governmental agents) is rapidly increasing. Various law-enforcement agencies may experience difficulty in reviewing such a volume of video content and assessing the activities of the LEOs and other individuals documented within the video content. Because the size of the crowd is practically unrestrained, deploying a large crowd to review such a volume of content and assess the performance of the LEOs may assist the various law-enforcement agencies in determining a competency of their agents.

Similarly, the “wisdom of the crowd” may be deployed to assess the performance of any activity that involves a large number of subjects and/or a large volume of content documenting the performance of the subjects. For instance, a single talent scout is often required to review large volumes of video content documenting the performance of many athletes, musicians, actors, dancers, and other such artists. In such circumstances, the crowd may be deployed to review the content and assess the performance of the subject activity, essentially distributing the activity of a single talent scout to a diffuse crowd. University or professional-level athletic organizations may deploy the crowd to review the performance of high school- and/or university-level athletes, in lieu of expensive talent scouts that may have to travel to view various games, matches, competitions, performances, and the like.

In embodiments directed toward customer service, the content may document the performance of customer service specialists. Various embodiments may deploy the crowd to assess the performance of the activity of the customer service specialists. In regards to customer service centers, many interactions between customers and customer service specialists are documented via video, audio, or textual content. For instance, telephone or Voice-Over Internet Protocols (VOIP) calls generate audio content documenting the activities of both the customer and the customer service specialist. The content is often captured by the customer service center. Many customer service specialists also provide services to customers via video, audio, and/or textual “chats” communicated by various internet protocols (IP). Such interactions also generate content, of which the various embodiments may deploy the crowd to review and assess. The crowd may assess the activities of both the customer service specialists and the customers during such interactions.

Likewise, video surveillance devices are employed in many brick-and-mortal retail locations to document the interactions between agents of the retail locations and other individuals within the retail locations, such as customers and individuals browsing merchandise within the retail location. The various embodiments may deploy the crowd to review the video content captured by the video surveillance devices and assess the activities of the retail location agents, customers, and the like. The performance of individuals employed within a manufacturing facility may also be assessed via the various embodiments disclosed herein.

Various cities around the globe have installed or are currently considering installing video surveillance devices in public spaces, such as parks, public markets, roadways, and the like. Various embodiments may deploy the crowd to review content captured by such video surveillance devices, as well as assess the activities of individuals documented in the content. In fact, given the widespread adoption of mobile devices, such as smartphones and tablets, equipped with video and audio capturing capabilities, the various embodiments may be operative to deploy reviewers, including crowd and/or expert reviewers to review content captured by mobile devices and assess the activities individuals in practically any situation where people use their mobile devices to capture content.

As discussed in conjunction of at least processes 500 and 540 of FIGS. 5A-5B, the captured content may be received and processed prior to providing the content to the plurality of reviewers. For instance, a documenting computer may provide the content to an ATP platform, such as ATP platform 140 of FIG. 1. A computer included in the ATP platform may trim, annotate, and/or tag the content. In at least one embodiment, receiving the content may also include receiving geo-location data relating to the location of the subject. For instance, geo-location data may be generated by a GPS transceiver included in the documenting computer, where the geo-location data indicates at least an approximate location of the subject when the subject is performing the subject activity.

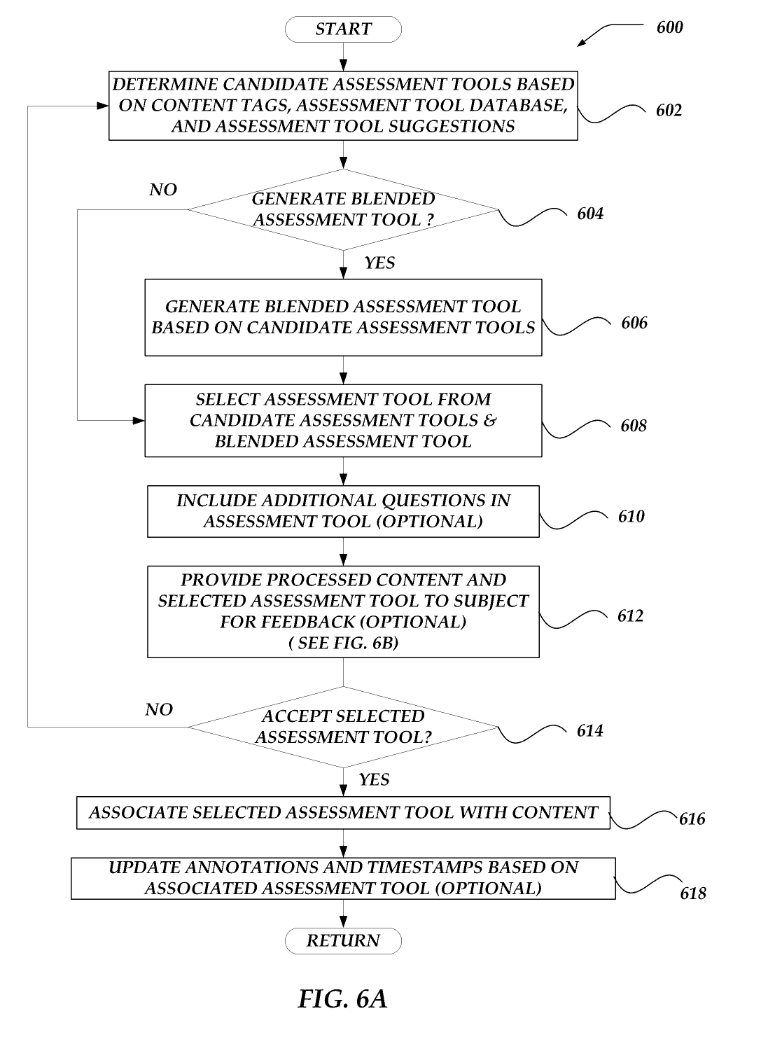

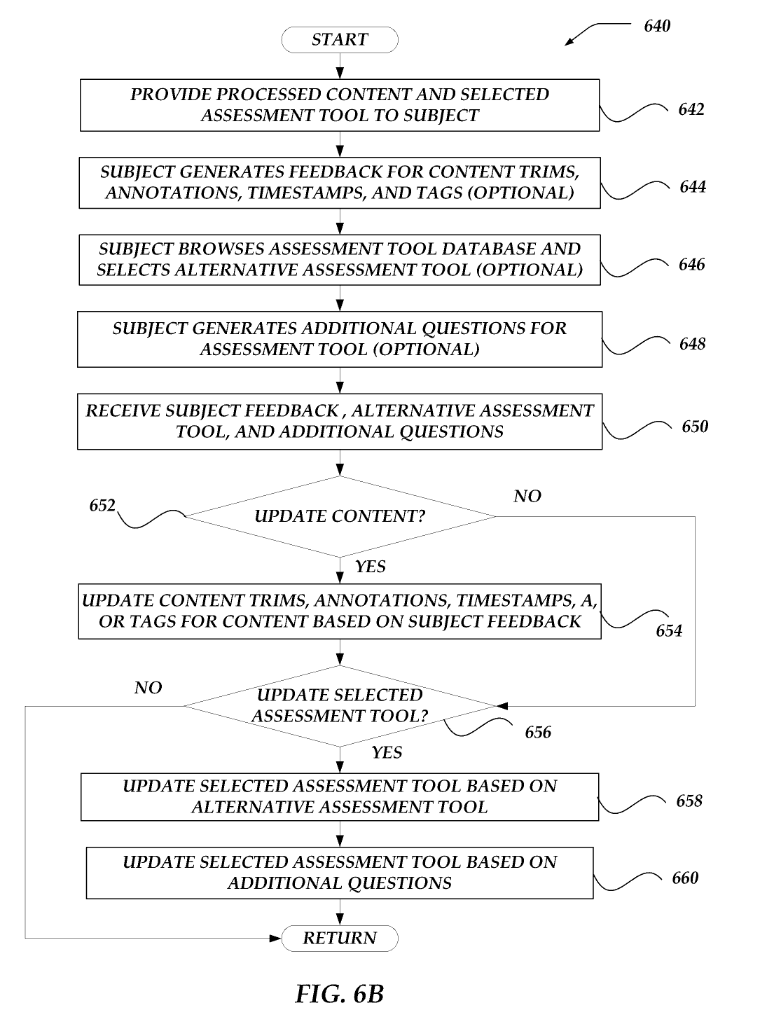

At block 404, an assessment tool is associated with the content captured at block 402. Various embodiments for associating an AT with the content are discussed in at least conjunction with processes 600 and 640 of FIGS. 6A-6B. However briefly, at block 404, an assessment tool is associated with the content based on a relationship between the assessment tool and the content. An assessment tool (or AT) may be a collection of one or more questions that are directed toward the assessment of various domains of the performance of subject activity. In various embodiments, the associated AT is a survey directed to the subject's performance of the subject activity. Accordingly, the association of the AT with the content may be based on at least the type of activity that the content is documenting. For instance, if the content is documenting the performance of a robotic surgical procedure, the AT may include questions directed towards the performance of a robotic surgery. As discussed further below, at least in conjunction with FIGS. 6A-6B, the association of the AT with the content may be based on tags included with the content.

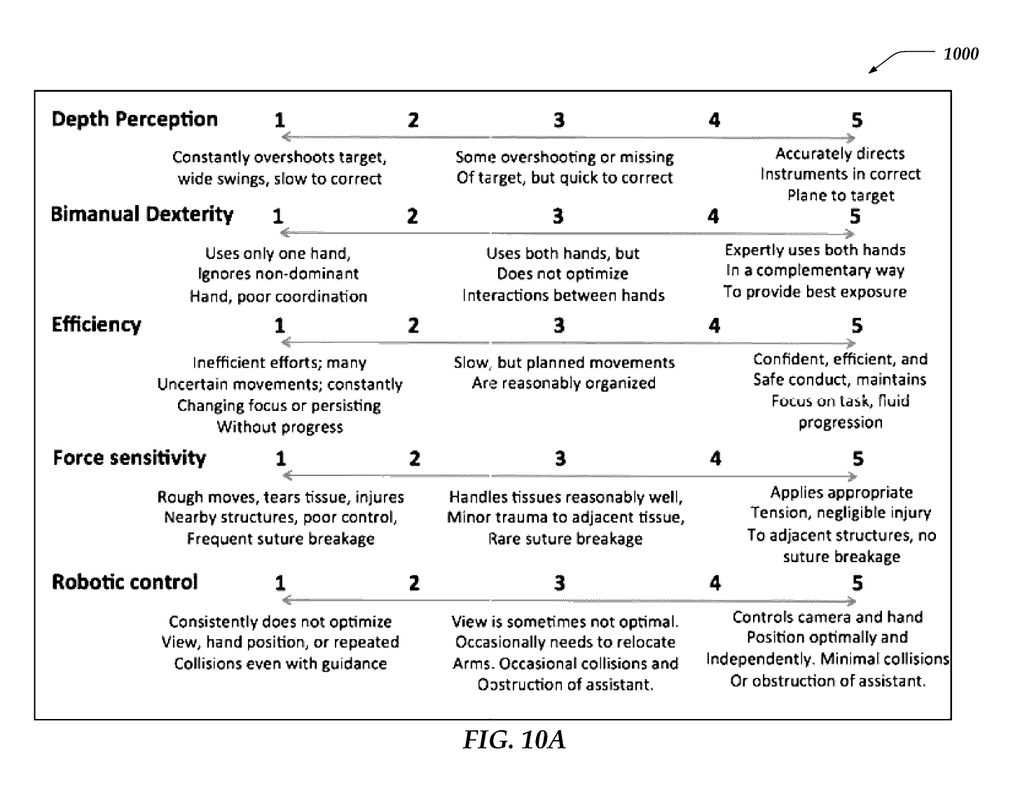

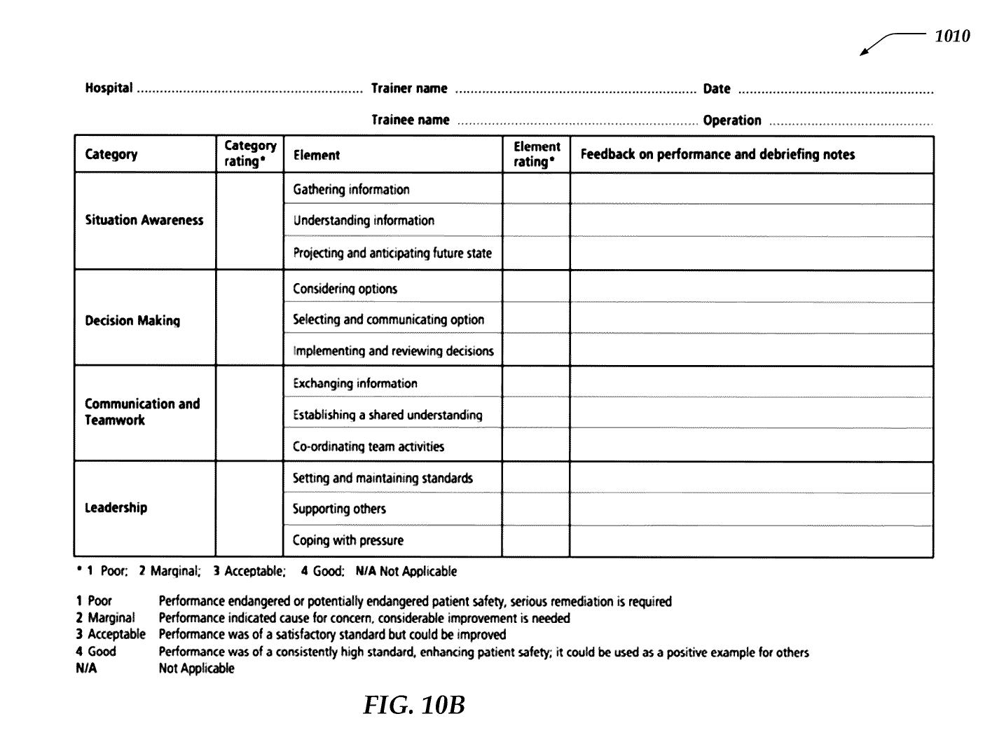

FIG. 10A illustrates an exemplary embodiment of an assessment tool 1000 that may be associated with content documenting a surgeon's performance of a robotic surgery in the various embodiments. FIG. 10B illustrates another exemplary embodiment of an assessment tool 1010 that may be associated with content documenting another performance of a healthcare provider. As in at least conjunction with block 406, the content as well as the associated AT are provided to the plurality of reviewers. Upon reviewing the content, each of the reviewers may provide assessment data that includes answers to at least a portion of the questions included in the associated AT.

Various questions included in the associated AT may be directed toward technical domains in the subject activity documented in the content. For instance, AT 1000 of FIG. 10A includes questions directed to the technical domains of depth perception, bimanual dexterity, efficiency, force sensitivity, and robotic control of a robotic surgery. Crowd reviewers, as well as expert reviewers may provide answers to such questions directed towards technical domains.

In at least one embodiment, a portion of the questions in the associated AT are directed towards non-technical domains of the subject activity. For instance, AT 1010 of FIG. 10B includes questions directed to the non-technical domains regarding providing health care services.

In some embodiments, only expert reviewers are enabled to provide answers to non-technical questions. In some embodiments, at least one of the questions included in an AT is a multiple-choice question. At least one of the included questions may be a True/False question. The answer to some of the questions included in an AT may involve filling in a blank, or otherwise providing an answer that is not otherwise a multiple choice or True/False answer. Some of the included questions may involve a ranking of possible answers. In at least one embodiment, a question included in an AT requires a numeric answer. In some embodiments, at least one question included in an AT requires a quantitative answer.

As shown in at least AT 1010 of FIG. 10B, an AT may include open-ended qualitative questions or prompt a review for generalized comments, feedback, and the like. Reviewers may provide qualitative assessment data by providing answers to such open-ended questions, including generalized comments, feedback, notes, and the like.

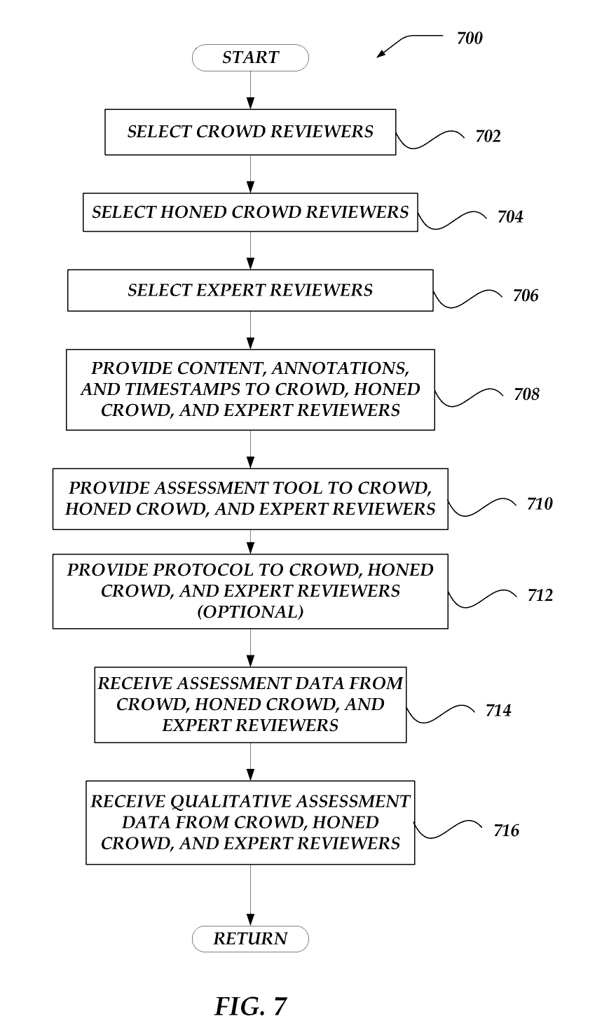

At block 406, the content and the associated AT is provided to reviewers. Various embodiments for providing the content and the AT to reviewers are discussed in at least conjunction with process 700 of FIG. 7. However briefly, at block 406, both the content and the AT are provided to a plurality of reviewers. Each of the reviewers is enabled to review the content and provide assessment data relating to their independent assessment of the performance of the subject activity. For instance, the reviewers may provide assessment data by answering at least a portion of the questions included in the AT. Upon reviewing the content, at least a portion of the reviewers may be enabled to provide qualitative assessment data in the form of generalized comments, feedback, notes, and the like.

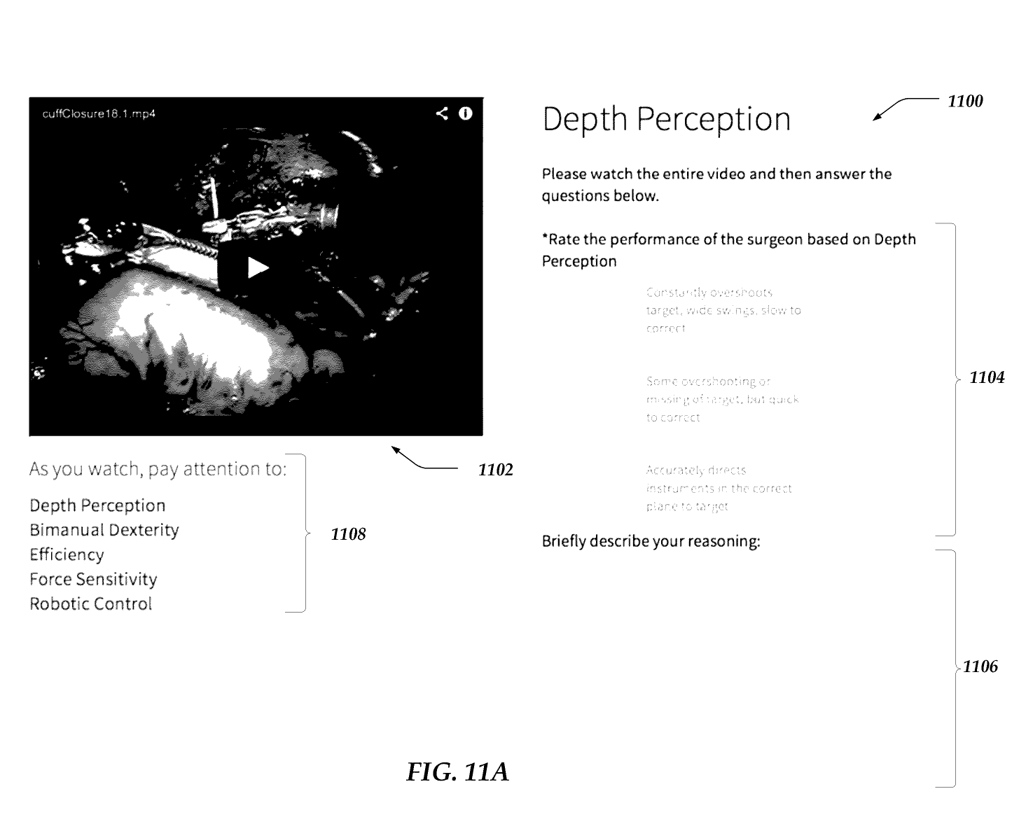

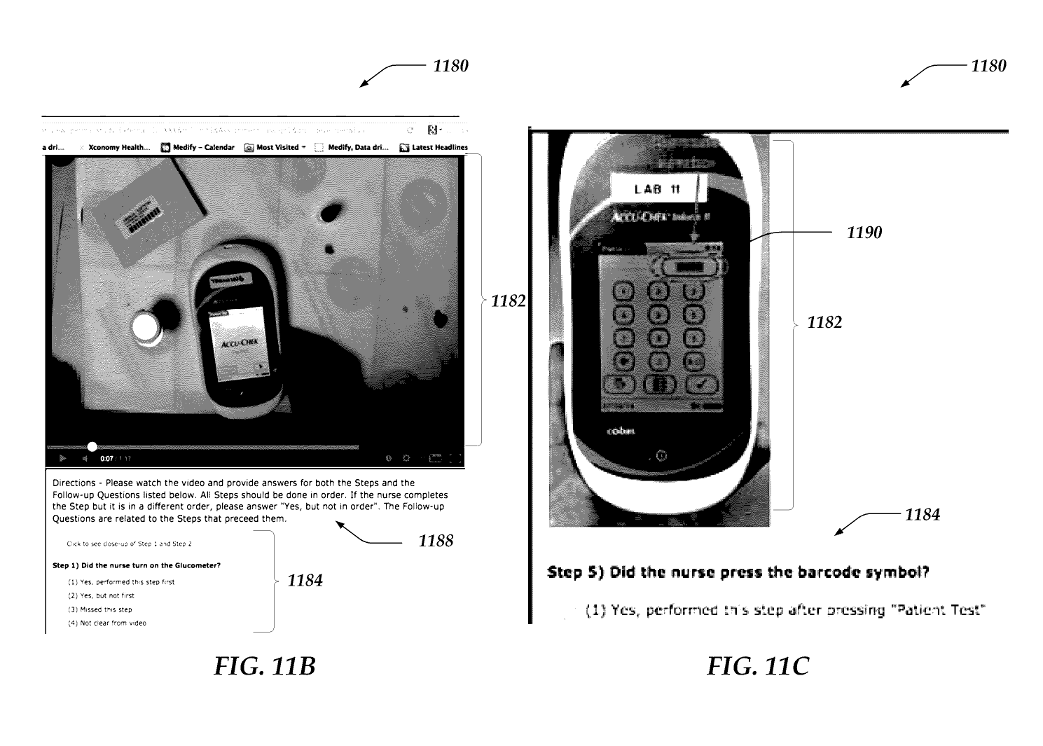

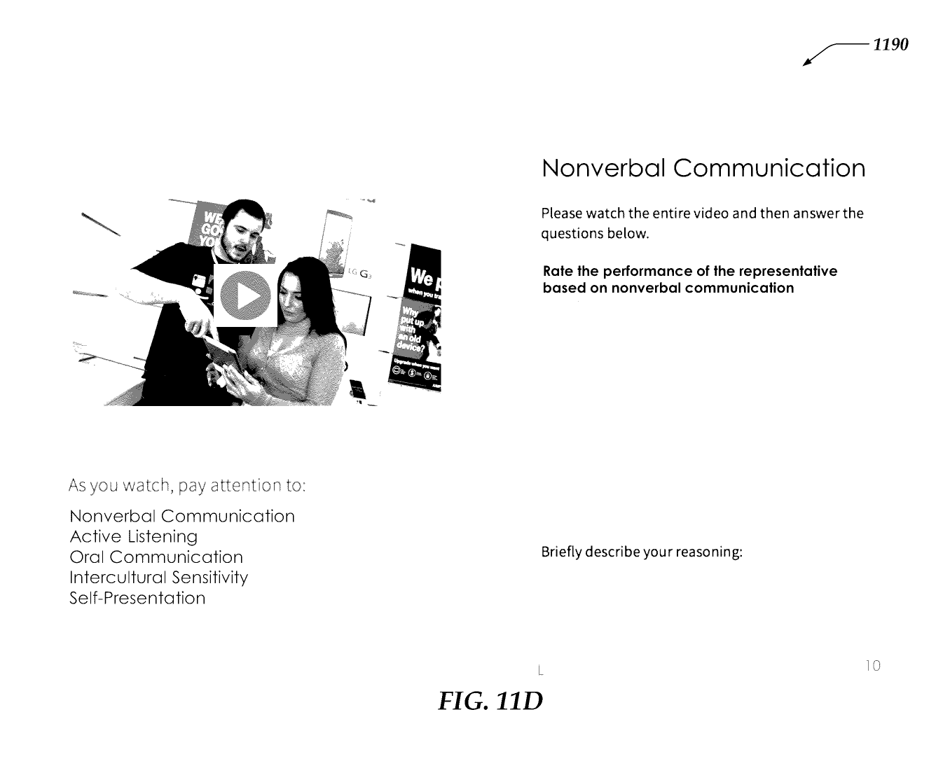

In various embodiments, a reviewer may be a user of a reviewing computer, such as, but not limited to reviewing computers 102-118 of FIG. 1. In at least one embodiment, the content and the AT is provided to a reviewer via a web interface. For instance, a link, such as a hyperlink, may be provided to a reviewer that links to the web interface. FIG. 11A illustrates an exemplary embodiment web interface 1100 employed to provide a reviewer at least content documenting a surgeon's performance of a robotic surgery and the associated AT of FIG. 10A.

Web interface 1100 provides content, such as video content 1102, which documents a surgeon's performance of a robotic surgery. In at least one embodiment, a computer included in an ATP platform, such as ATP platform 140 of FIG. 1, provides the content to the reviewer. For instance, CSSC 130 of FIG. 1 may provide the content to a reviewing computer used by the reviewer, by streaming the content. In another embodiment, a computer outside of the ATP platform provides the content.

Web interface 1100 provides the reviewer the associated AT 1104. The reviewer may be enabled to provide assessment data regarding her assessment of the performance of the subject activity by answering at least a portion of the questions in AT 1104, as the reviewer reviews video content 1102. The reviewer may answer the questions in AT 1104 by selecting the answering, typing via a keyboard, or by employing any other such user interface provided in the reviewing computer. In this exemplary, but non-limiting embodiment, AT 1104 corresponds to AT 1000 of FIG. 10A.

The questions in AT 1104 may be provided sequentially to the reviewer, or the AT 1104 may be provided in its entirety to the reviewer all at once. As discussed throughout, a web interface, such as web interface 1100 may provide annotations 1108 to the reviewer. Annotations 1108 may provide the reviewer indicators and/or signals of what to pay attention to when reviewing content 1102. Web interface 1100 may enable the reviewer to provide qualitative assessment data, such as comments, descriptions, notes, and other feedback via an interface, such as interface 1106.

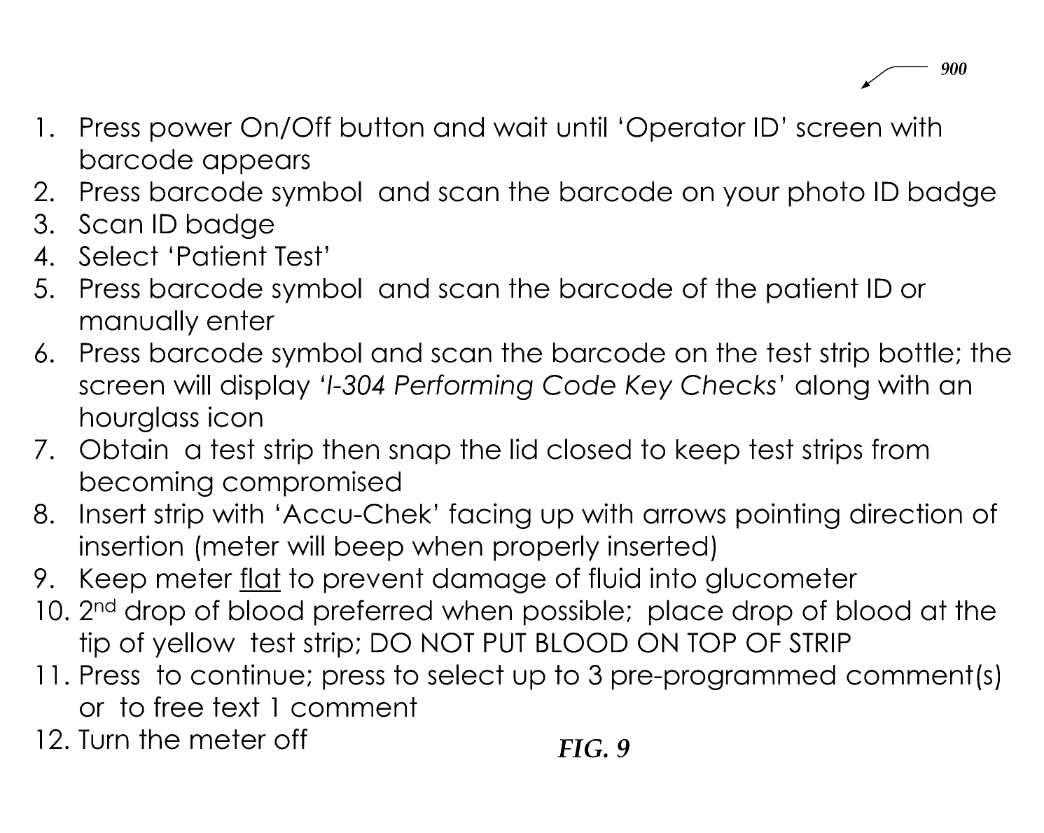

FIGS. 11B-11C illustrates another exemplary embodiment of web interface 1180 employed to provide a reviewer at least content 1182 documenting a nurse's performance of using a glucometer to measure blood glucose levels and an associated AT. Similar to web interface 1100 of FIG. 11A, web interface 1180 provides video content 1182, as well as the associated AT 1184 to the reviewer. In various embodiments, the associated AT 1184 may correspond to a protocol that the subject is presumed to follow while performing the subject activity. Crowd reviewers may be enabled to assess at least whether the subject accurately and/or precisely followed the protocol. For instance the AT 1184 corresponds to protocol 900 of FIG. 9. Web interface 1180 also includes annotations 1188 and 1190 to provide the reviewer guidance when reviewing the content, as well providing assessment data, in the form of answering questions included in AT 1184. The annotations may include timestamps, such that the annotations 1188 and 1190 are provided to the reviewer at corresponding points in time when reviewing content 1182. Likewise, the individual questions in AT 1184 may be include timestamps such that the questions are provided to the reviewer at corresponding times when reviewing content 1182.

As noted above, the plurality of reviewers may include a plurality of crowd reviewers. In at least one embodiment, the plurality of reviewers may also include one or more expert reviewers. In addition to crowd reviewers, the plurality of reviewers may include one or more honed crowd reviewers. In various embodiments, a honed crowd reviewer is a crowd reviewer that has been selected to review the current content (that was captured at block 402) and assess the corresponding subject activity based on one or more previous reviews of other content and assessments of the subject activity documented in the other content.

A honed crowd reviewer may be a crowd reviewer that has previously reviewed and assessed a predetermined number of other subjects. For example, a honed crowd reviewer may be a crowd reviewer that has reviewed and assessed the technical performance of a specific number of other subjects performing subject activity. A honed crowd reviewer may be a reviewer that has been qualified, validated, certified, credentialed, or the like based on previous reviews and assessments. Various embodiments may include various levels, or tiers, of crowd reviewers. For instance, a top (or first)-tiered honed crowd reviewer may be a “master reviewer,” “a platinum-level reviewer,” “five star reviewer,” and the like. Other tiers or rating systems may exist, such as but not limited to second-, third-, fourth-tiered, and the like. The tiered-level of a honed crowd reviewer may be based on the reviewer's previous experience and/or performance in regards to assessing the performance of previous subject activity. For example, a top-tiered reviewer may have assessed the performance of at least 200 other subjects, while a second tiered-reviewer has assessed at least 100 other subjects.

In at least one embodiment, for a honed crowd reviewer, the content reviewed in at least a portion of the previously reviewed content must be associated with the subject activity that is documented in the present content to be reviewed and assessed, e.g. the content captured in block 402. For instance, for a crowd reviewer to be selected as a honed crowd reviewer for reviewing and assessing the technical performance of surgeons performing robotic surgery, the crowd reviewer must have previously reviewed and assessed the technical performance of other similar robotic surgeries. Accordingly, a reviewer may be a honed crowd reviewer for some subject activity but not for other subject activity. Similarly, a honed crowd reviewer may be a top-tiered reviewer for robotic surgery, but a third-tiered reviewer for assessing a traffic stop performed by a LEO.

In some embodiments, certifying, credentialing, or validating a honed crowd reviewer may include selecting the honed crowd reviewer based on at least an accuracy or precision of the previous assessments performed by the crowd reviewer, in relation to a corresponding assessment performed by other reviewers, such as expert reviewers, honed crowd reviewers, or crowd reviewers. For instance, a crowd reviewer may be certified as a top-tiered crowd reviewer based on an exceptionally high correlation between assessments of previous performance of subject activity with assessments provided by expert reviewers, or other previously certified top-tiered honed reviewers.

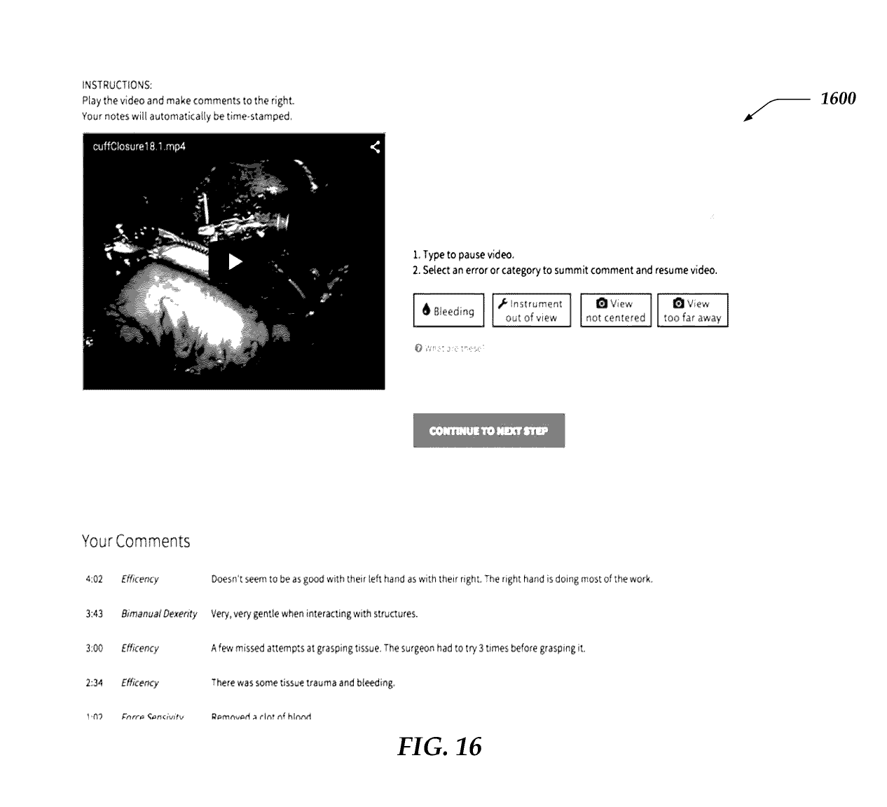

In various embodiments, a platform, such as ATP platform 140 of FIG. 1, provides training for crowd reviewers to progress to honed crowd reviewers, as well as to progress upward through the tiered-levels of honed crowd reviewers. For instance, training modules may be provided to crowd reviewers. FIG. 16 shows a training module 1600 that is employed to train a crowd reviewer and is consistent with the various embodiments disclosed herein. The training modules provided by the platform may provide a plurality of previously captured content to a reviewer in training. The previously captured content may have been previously reviewed by a plurality of already trained and/or expert reviewers. The content may be focused on a particular type of subject activity that the reviewer in training is training to review.

The reviewer in training may view the plurality of content within the training module and review the performance documented in the content. The reviewer's review may be compared to one or more other reviews provided by already trained and/or expert reviewers. The review provided by the reviewer in training may be compared to the mean or average review of the already trained and/or expert reviewers. The reviewer in training may keep reviewing separate content of the particular type of subject activity, until the reviews provided by the reviewer in training substantially and/or reliably converge on the trained group's average reviews.

For instance, a reviewer may be considered trained for the particular type of subject activity after providing a predetermined number of consecutive reviews that are consistent with of other trained and/or expert reviewers to within a predetermined level of accuracy. A honed crowd reviewer may progress through the tiered-levels by increasing the reliability demonstrated by the level of accuracy of their training reviews. In at least one embodiment, at least a portion of the crowd reviewers have received at least some training and demonstrated a base-level of accuracy in their reviews. The review modules may be automated, or at least semi-automated training modules.

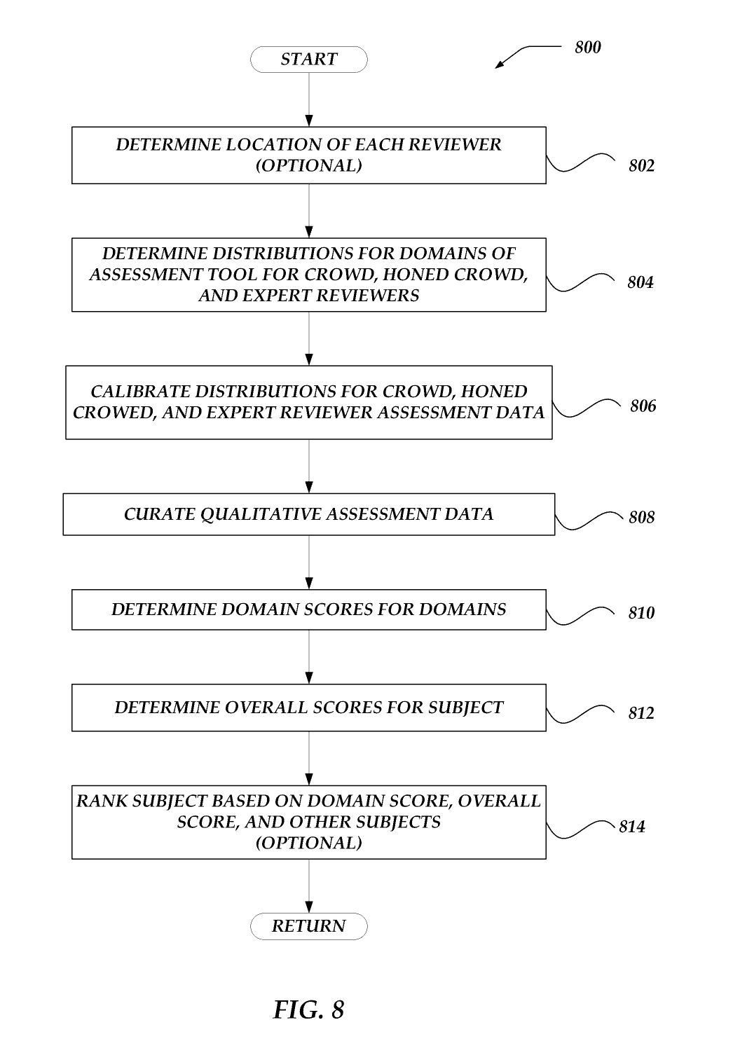

At block 408, assessment data provided by reviewers is collated. Various embodiments for collating assessment data are discussed in at least conjunction with process 800 of FIG. 8. However briefly, at block 408, the assessment data provided by the reviewers may include answers to the questions in the associated AT. When questions require a quantitative or numerical answers, such as the questions included in AT 1000 of FIG. 10A, a statistical distribution may be generated. For instance, for each of the questions that involve a numerical answer, a histogram of the reviewers' answers may be generated. In various embodiments, the crowd is large enough to generate statistically significant distributions for each of the questions included in the AT. When collating the data, the mean, variance, skewness, or other moments may be determined for the distribution for each quantitative question. Domain scores in one or more domains of the assessment of the subject activity may be generated at block 408 based on the reviewer distributions corresponding to questions pertaining to the various domains.

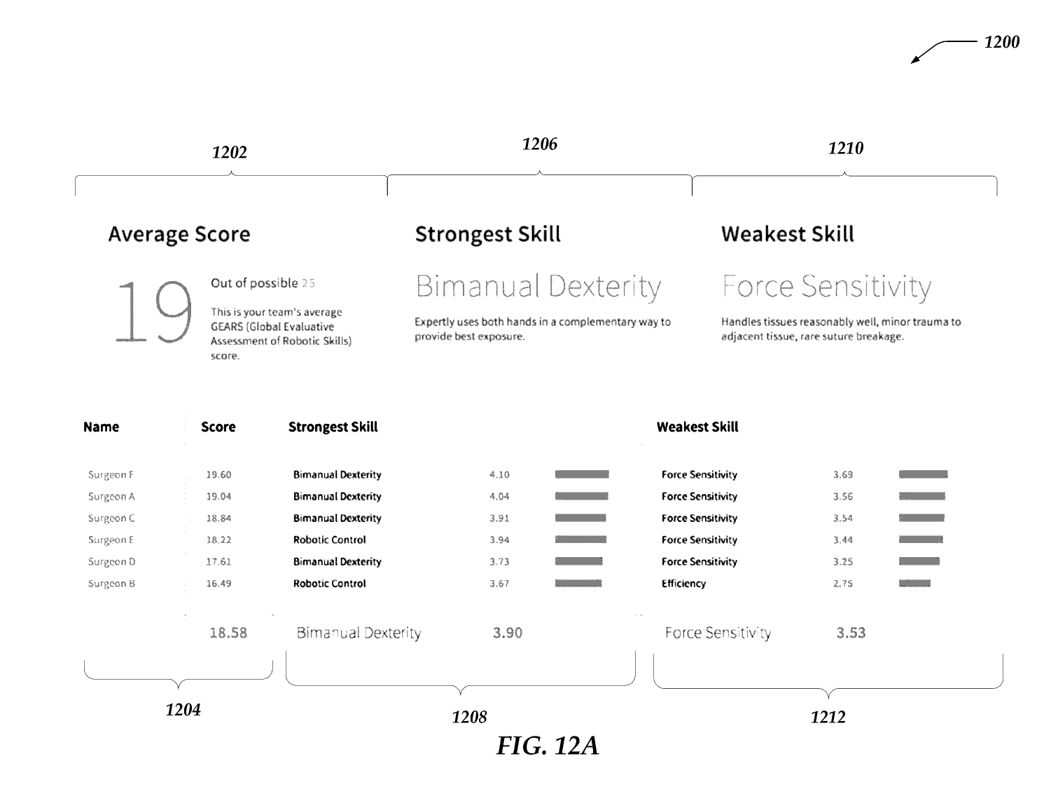

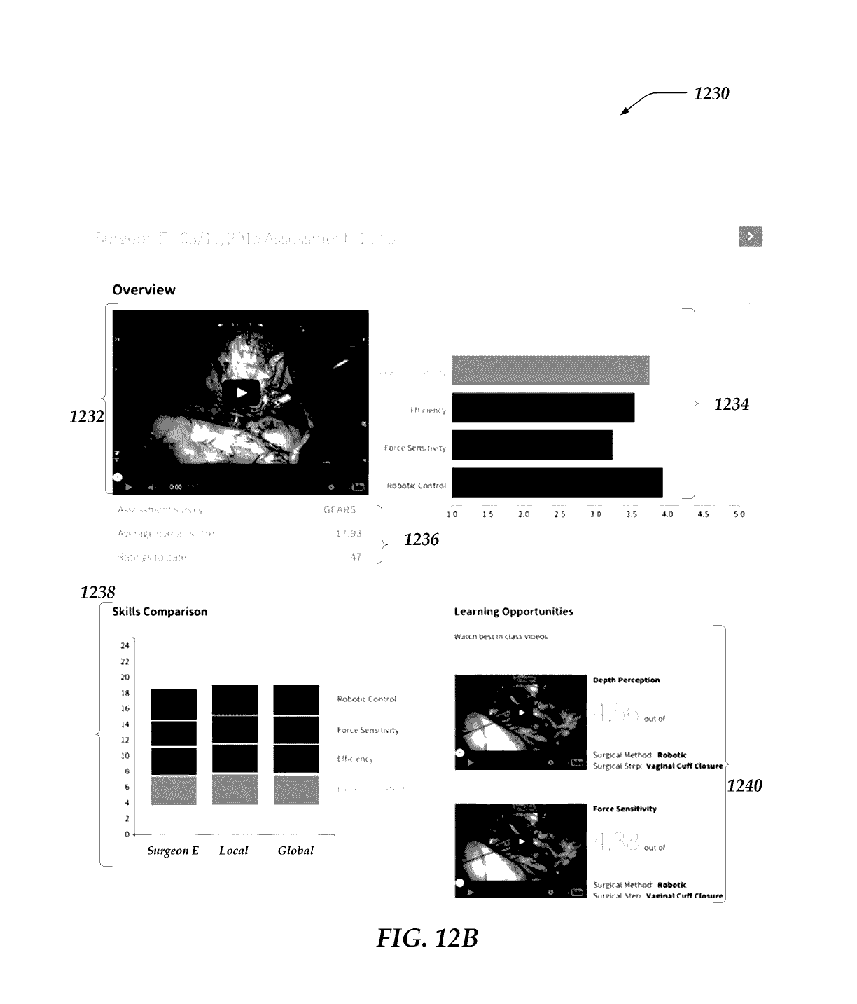

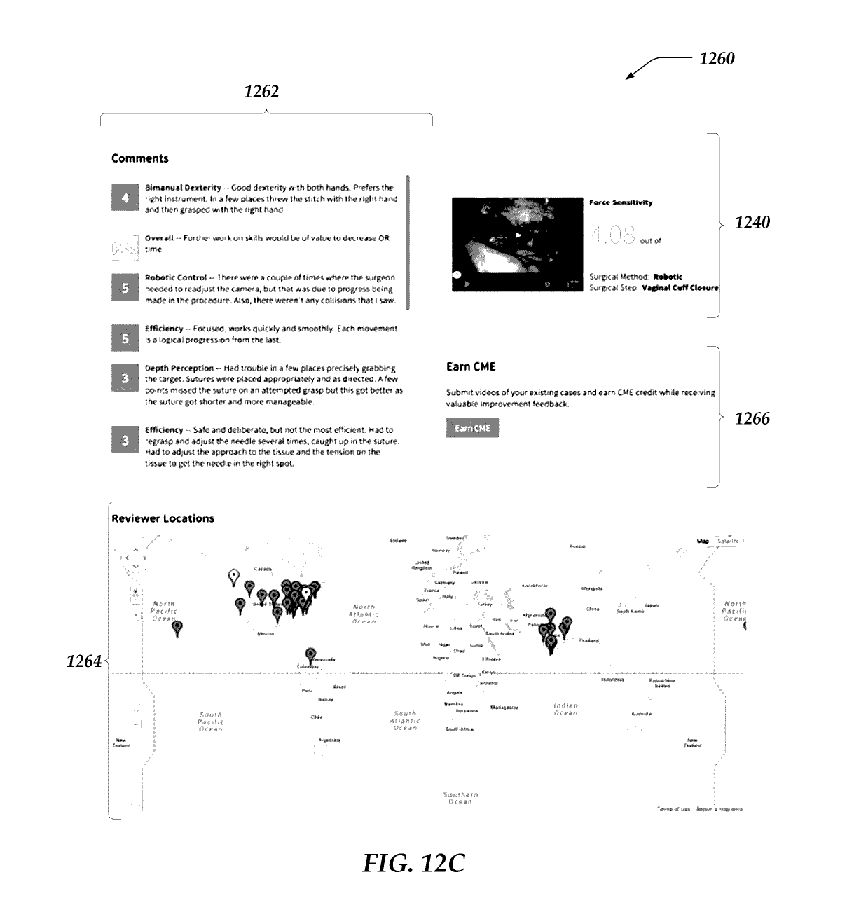

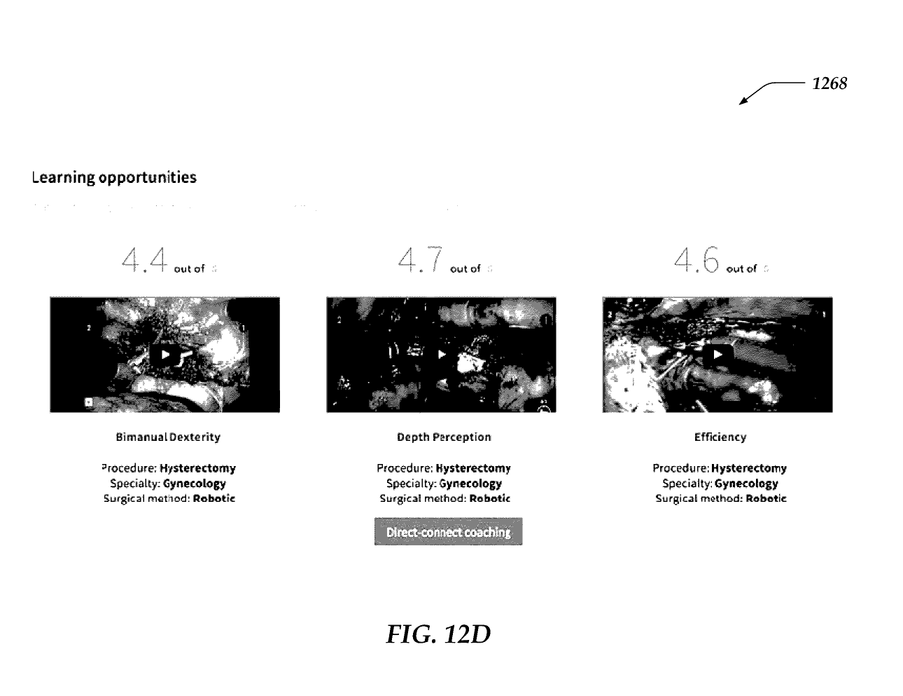

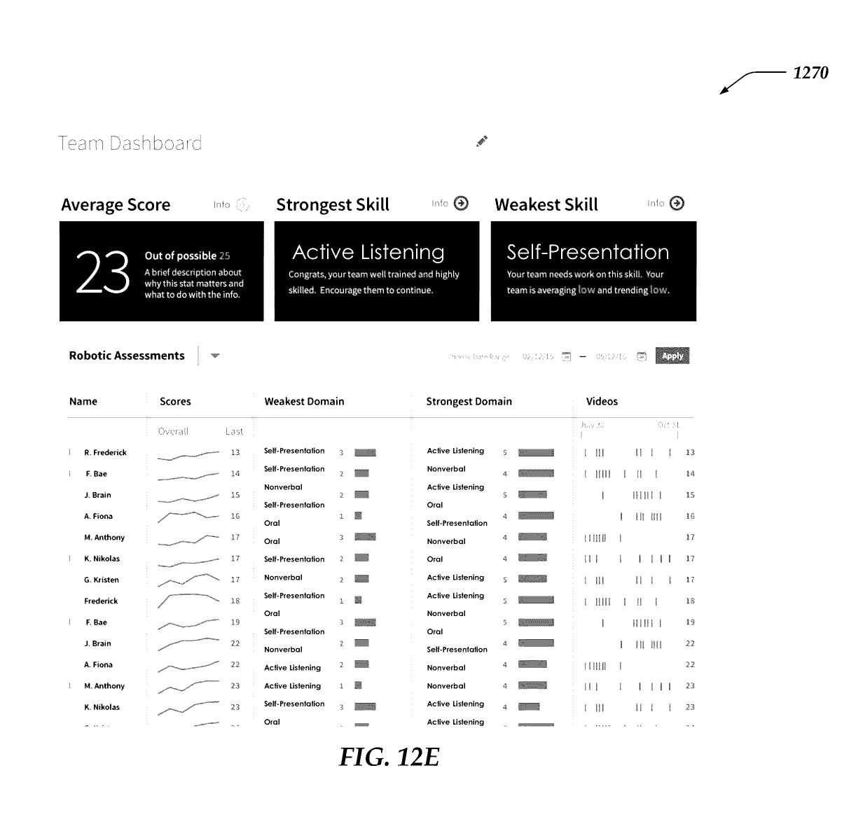

At block 410, one or more reports are generated. The reports may be based on the collated assessment data. The reports may provide an overview of the plurality of reviewers' assessment of domains of the performance of the subject activity. FIG. 12A illustrates an exemplary embodiment of report portion 1200, generated by various embodiments disclosed here, that provides a detailed overview of the crowd-sourced assessment of the subject's performance of the subject activity. FIG. 12B illustrates an exemplary embodiment of another report portion 1230 of the report of FIG. 12A, generated by various embodiments disclosed here, that provides the detailed overview of the crowd-sourced assessment of the subject's performance of the subject activity. FIG. 12C illustrates an exemplary embodiment of yet another report portion 1260 of the report of FIG. 12A, generated by various embodiments disclosed here, that provides the detailed overview of the crowd-sourced assessment of the subject's performance of the subject activity.

Report portions 1200, 1230, and 1260 of FIGS. 12A-12C are discussed in greater detail below. However, briefly the report illustrated in FIGS. 12A-12C was generated based on a crowd-sourced assessment of a robotic surgeon performing a robotic surgery. The AT associated with the content that was used in the crowd-sourced assessment is a Global Evaluative Assessment of Robotic Skill (GEARS) validated AT. However, the exemplary embodiments shown in FIGS. 12A-12C should not be construed as limiting, and as discussed throughout, the subject activity and the AT are not limited to healthcare-related activities.

The report of FIGS. 12A-12C is for a team of six surgeons (Surgeon A—Surgeon F). Report portion 1200 of FIG. 12A shows an overview of the team's crowd-sourced assessment. Report portion 1200 includes a ranking of each surgeon 1204, where the surgeons are ranked by an overall score out of 25, the maximum score for the specific AT used in the particular assessment. The overall score for each surgeon may be determined based on the collated assessment data for each surgeon. Likewise, report portion 1200 includes an average score 1202 for the team. Note that the average score 1202 has been rounded from the actual average team score displayed in the surgeon ranking 1204.

Report portion 1200 also includes a listing of each surgeon's strongest skill 1208 and a listing of each surgeon's weakest skill 1212, based on the crowd-sourced assessment of each surgeon. Report portion 1200 also includes the strongest skill for the team as a whole 1206, as well as the weakest skill for the team as a whole 1210. It should be understood that information included in report portion 1200 may be used by the team for promotional and marketing purposes.

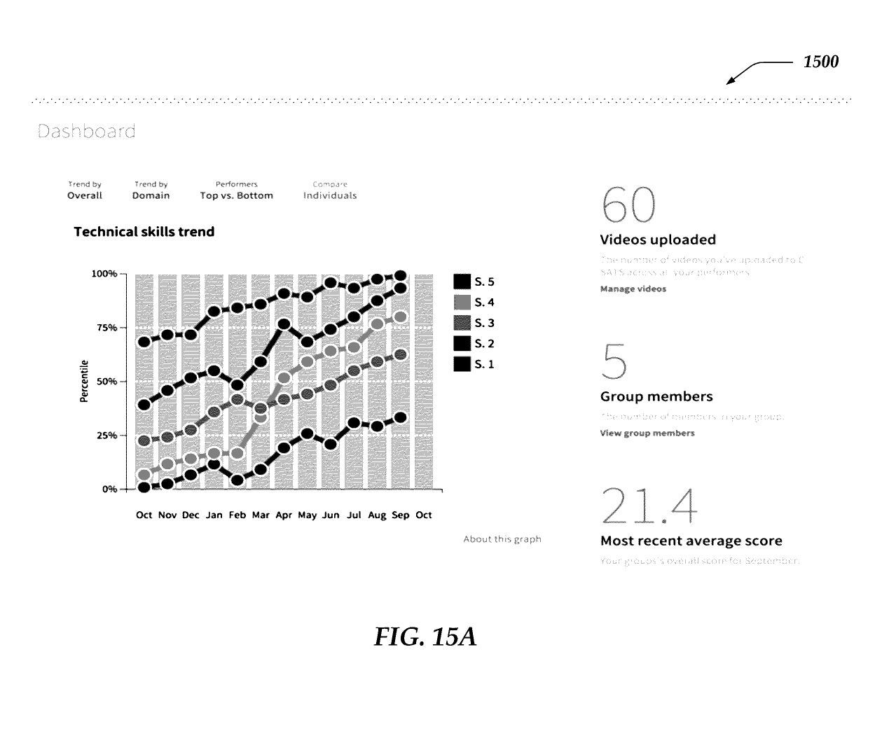

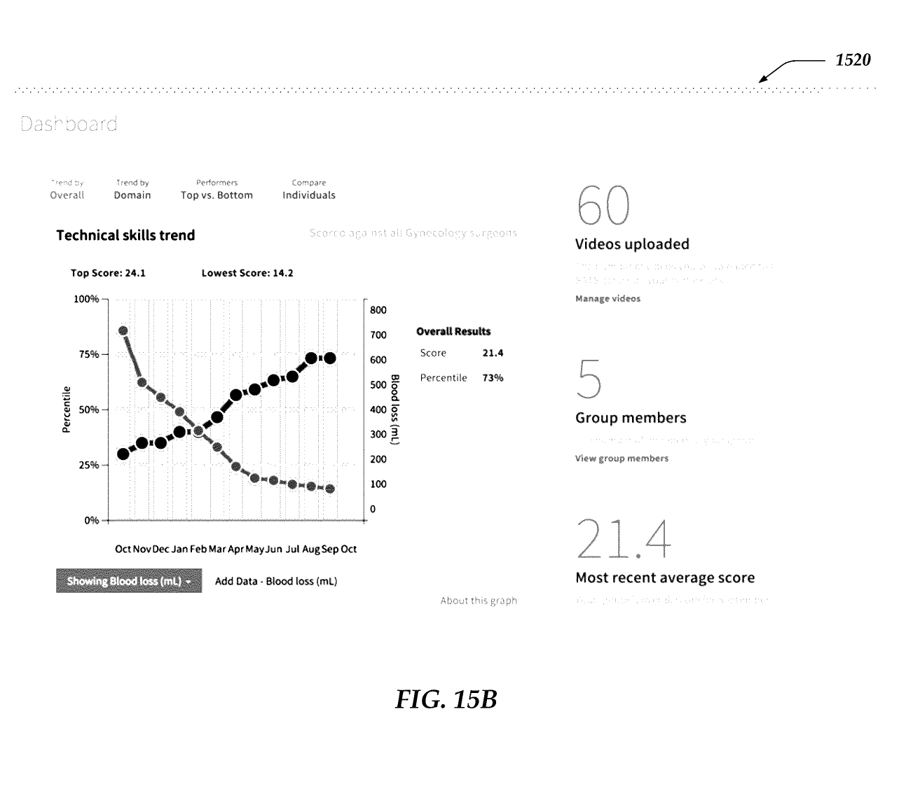

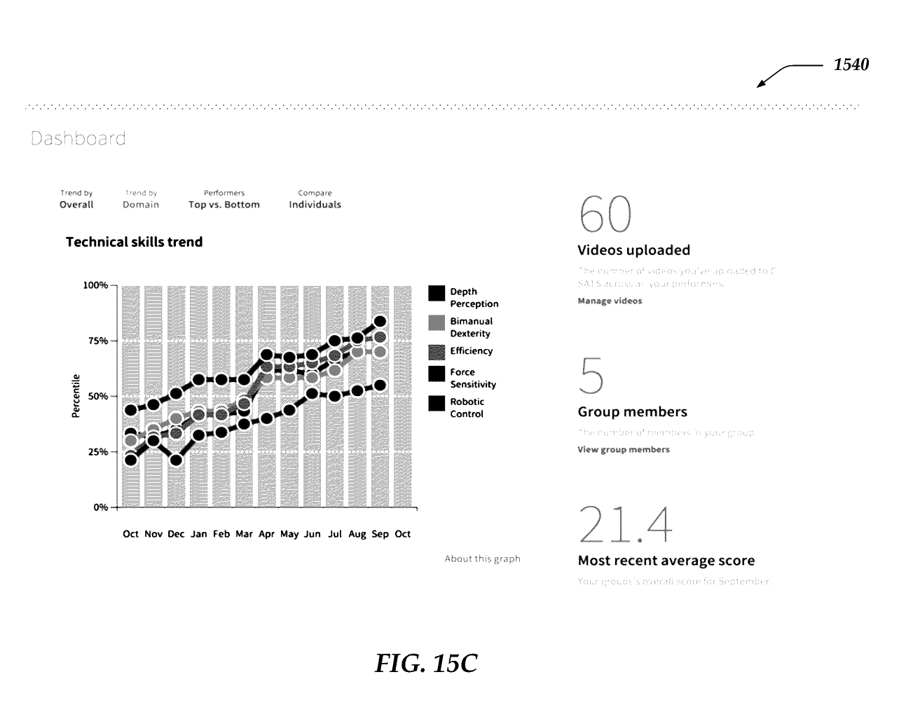

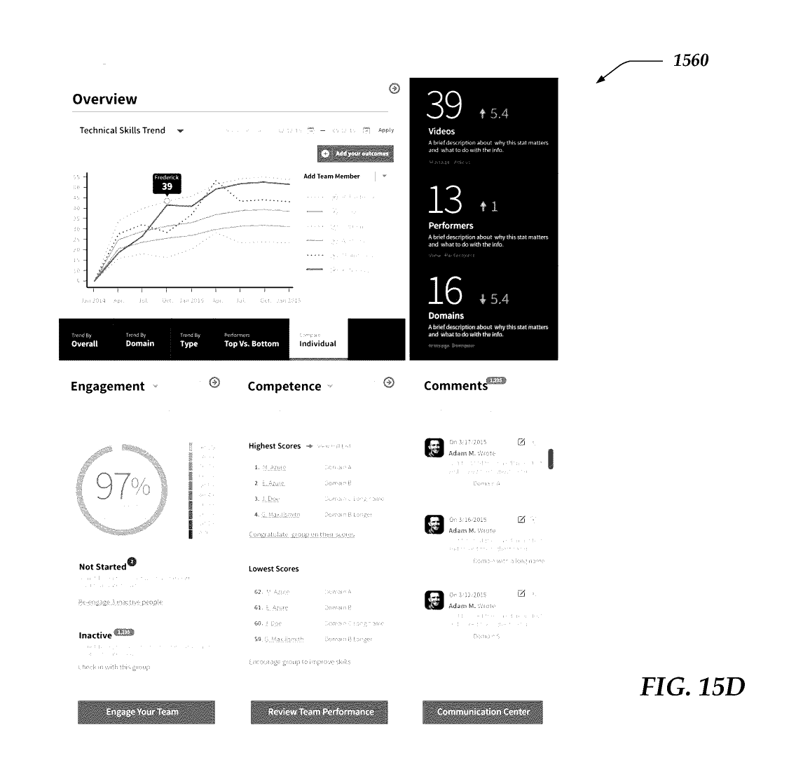

FIG. 12E shows an exemplary embodiment of a team dashboard 1270 that is included in a report, generated by various embodiments disclosed here, that provides a detailed overview of the crowd-sourced assessment of a sales team's performance of various customer interactions. Team dashboard 1270 may be analogous to report portion 1200, but is directed towards the performance of a sales team, rather than the performance of a team of surgeons. One or more performances for each of the members of the sales team may have been reviewed by a plurality of reviewers via web interface 1190 of FIG. 11D. FIGS. 15A-15D show various team dashboards that show the training and improvement of a team of surgeons.

Report portion 1230 of FIG. 12B is specific to Surgeon E (the subject). Report portion 1230 includes the video content 1232 that was assessed by the plurality of reviewers. As discussed further below, video content 1232 provided in the report may have been annotated by one or more of the plurality of reviewers. Such annotations may serve as specific and targeted feedback for the subject to improve her skills and performance. Accordingly, a report generated by the various embodiments may serve as a learning or training tool.

Report portion 1230 also includes a domain score 1234 for each of the technical domains assessed via content 1232 and the associated AT (AT 1000 of FIG. 10A). Note the correspondence between the domain scores 1234 determined based on the crowd-sourced assessment and the questions included in AT 1000. In various embodiments, the domain score 1234 for each technical domain is determined based on a distribution of assessment data for each of the corresponding questions included in AT 1000. For instance, each determined domain score 1234 may be equivalent or similar to the mean or median value of a crowd-sourced distribution for each corresponding question included in the AT 1000.

Report portion 1230 also includes indicators 1236 for the AT employed to assess the performance of Surgeon E, as well as the overall scored for Surgeon E, and the number of crowd reviewers that have contributed to Surgeon E's assessment. In at least one embodiment, the reports are generated in real-time or near real-time as the assessment data is received. In such embodiments, the report portion 1230 is updated as new assessment data is received. For instance, if another reviewer where to provide additional assessment data, the “Ratings to date” entry would automatically increment to 48, and at least each of the scores associated with the technical domains 1234 would automatically be updated based on the additional assessment data.

Report portion 1230 also includes a skill comparison 1238 of the subject with other practitioners. For instance, skill comparison 1238 may compare the crowd-sourced assessment of the various domains for the subject to cohorts of practitioners, such as a local cohort and a global cohort of practitioners. Geo-location data of the subject may be employed to determine a location of the subject and locations of one or more relevant cohorts to compare with the subject's assessment. The skills distribution of local and global cohorts may be employed to determine local and global standards of care for practitioners.

Report portion 1230 also includes learning opportunities 1240. Learning opportunities 1240 may provide exemplary content for at least a portion of the domains, such as but not limited to the technical domains of the subject activity. The content provided in learning opportunities 1230 may document superior skills for at least a portion of the domains. Separate exemplary content may be provided for each domain assessed by the crowd.

In various embodiments, a platform, such as ATP platform 140 of FIG. 1, automatically or semi-automatically associates content to be included or at least recommended in learning opportunities 1240. The automatic association may be based on at least one or more tags of the learning opportunity content, one or more tags associated with the content that corresponds to report portion 1230, or the domain for which the content is recommended for as a learning opportunity.

In at least one embodiment, the automatic association may be based on a score, as determined via previous reviews of the recommended content. The scores may be scores for the domain of which the content is recommended as a learning opportunity. For instance, learning opportunities 1240 is shown recommending exemplary content for both the depth perception and force sensitivity technical domains of a robotic surgery.

In at least some embodiments, recommending these particular exemplary choices of content is based on the technical scores, as determined previously by reviewers, of the associated technical domains. As shown in FIG. 12B, the reviewer determined score for the depth perception recommended content is 4.56 out of 5 and the reviewer determined score for the force sensitivity recommended content is 4.38 out of 5. In some embodiments, the recommended content is automatically determined by ranking previously reviewed content available in a content library or database. In some embodiments, at least the content with the highest ranking score for the domain is recommended as a learning opportunity for that domain.

In some embodiments, more than a single instance of content may be recommended as a learning opportunity. For instance, the content with the three best scores for a particular domain may be recommended as a learning opportunity for the domain. In some embodiments, content with a low score may also be recommended as a learning opportunity. As such, but superior and deficient content for a domain may be provided so that a viewer of report portion 1230 may compare and contrast superior examples of a domain with deficient examples. Learning opportunities 1240 may provide an opportunity to compare and contrast the contest corresponding to report portion with superior and/or deficient examples of learning opportunity content. An information classification system or a machine learning system may be employed to automatically recommend content with learning opportunities 1240.

Report portion 1260 of FIG. 12C includes a continuation of learning opportunities 1240 from report portion 1230 of FIG. 12B. Report portion 1260 may include curated qualitative assessment data 1262. For instance, comments provided by at least a portion of the reviewers may be provided in report portion 1262. Each of the comments may be curated to be directed towards a specific domain that was assessed.

As discussed herein in at least the context of process 800 of FIG. 8, at least one of an information classification system or a machine learning system may be employed to automate, or at least semi-automate, at least a portion of the curation of the comments to be provided in report portion 1262. The qualitative assessment data provided by the plurality of reviewers many be automatically classified and mined to identify the comments that provide the best opportunity for providing instructive feedback to the subject being reviewed in report portion 1260.

Report portion 1260 may also include a map 1264 with pins to indicate at least a proximate location of the reviewers that contributed to the assessment of the performance of the subject activity. In at least one embodiment, the location of the reviewers is determined based on geo-location data generated by a GPS transceiver included in a reviewing computer used by the reviewer associated with the pin. In some embodiments, the pins indicate whether the associated reviewer is a crowd reviewer, a honed crowd reviewer, or an expert reviewer. The pins may indicate a tiered-level of a honed crowd reviewer. The pins may indicate the status of a reviewer via color coding of the pin.

Report portion 1260 may also include continuing education opportunities 1266 for the subject. For instance, report portion 1260 may include a clickable link, which would provide Surgeon E an opportunity to earn continuing medical education (CME) credits by providing assessment data for another subject.

Process 400 terminates and/or returns to a calling process to perform other actions.

FIG. 5A shows an overview flowchart for process 500 for capturing content documenting subject activity, in accordance with at least one of the various embodiments. After a start block, process 500 begins at block 502 where at least one of a network computer, mobile computer, or a content capture device (such as a camera) is optionally provided to the subject. For instance, at least one of documenting computers 112-118 of FIG. 1 may be optionally provided to the subject to capture the content. In at least one embodiment, a specialized network computer and/or a camera is provided to the subject. In at least one embodiment, a removable storage device, such as processor readable removable storage 236 of FIG. 2 or processor readable removable storage 328 of FIG. 3 is provided to the subject at block 502. In some embodiments, a USB storage drive device is provided to the subject at block 502. At least one of the computers, devices, storage device, and the like provided to the subject at block 502 includes self-executing processor readable instructions that will automatically provide the captured content to an ATP platform. For instance, a USB storage drive may be provided to the subject, where the USB storage drive includes such self-executing instruction sets. Once the content is captured, the self-executing instructions on the USB storage drive will cause the content to be automatically uploaded to the ATP platform.

In at least one embodiment, the computer, device, storage device, or the like is provided to another party that wishes to determine the subject's performance. For instance, an employer, such as a law-enforcement agency may be provided with the USB storage drive, rather than a particular subject (the LEO). In some embodiments, at least one computer, device, storage device, and the like provided at block 502 includes a content capturing device, such as a camera and/or a microphone.

At block 504, a protocol is optionally provided to the subject. For instance, the provided protocol may be a protocol for the subject to follow when performing the subject activity to be documented. The protocol may be a protocol for any subject activity. FIG. 9 shows a non-limiting exemplary embodiment of a protocol 900 for a nurse to follow when measuring the glucose level of a patient. Other embodiments are not limited to health-care related protocols. In some embodiments, the protocol may be provided via the computer or device provided to the subject in block 502. For instance, the protocol may be provided via a USB storage drive provided in block 502. In other embodiments, the protocol is provided to a subject over a wired or wireless communication network, such as network 108 of FIG. 1. For example, the protocol may be provided to the subject via a documenting computer, such as one of documenting computers 112-118 of FIG. 1.

At block 506, content documenting the subject performing the subject activity is captured. In some embodiments, at least one of a documenting computer, such as documenting computers 112-118. In at least one embodiment, one of the computers or devices provided to the subject in block 502 is used to capture the content.

In at least one embodiment, at least an approximate location of the subject is determined at block 506, or at any other block in conjunction with processes 400, 500, 540, 600, 640, 700, and 800 of FIGS. 4-8. The location of the subject may be determined via geo-location data generated by a GPS transceiver included in the documenting computer that captures the content at block 506. In some embodiments, the subject or some other individual may prompted to provide the location of the subject. At least the geo-location data, or the subject provided location, may be included in the content captured at block 506. For instance, the geo-location data may be included in a tag, or some other structured metadata associated with the content. The metadata may include a geo-stamp, tag, or the like. In a least one embodiment, a localization of at least a portion of the software that is running on the documenting computer is performed based on at least the geo-location data. For instance, time zone parameters, currency type, units, language parameters, and the like are set or otherwise configured in various portions of software included in one or more documenting computers.

Blocks 508-516 are each optional blocks and are directed towards the subject, or another party, such as the subject's employer, training/educational institution, insurance provider, or the like generating suggestion's regarding processing the content and associating an assessment tool (AT) with the content. At block 508, the subject may be enabled to generate trim suggestions for the content. For instance, reviewers may not be required to review portions of the captured content because those portions are not relevant to assessing the subject activity. The beginning or final portions of the content may not be relevant to the assessment. Additionally, portions of the content may be trimmed to anonymize the identity of the subject, or a patient, criminal defendant, customer, or the like that the subject is providing services for or otherwise interacting with. Accordingly, in block 508, the subject may generate trim suggestions, regarding which portions of the content to trim or excise prior to providing the content to the plurality of reviewers.

At optional block 510, the subject (or another party) may generate annotation suggestions for the content Annotations for the content may include visual indicators to overlay atop the content to provide a reviewer a signal to pay special attention or otherwise bring out characteristics of the content when reviewing. Annotations may include special instructions for the reviewers when assessing the subject activity documented in the content.

At optional block 512, the subject may generate timestamp suggestions for the content. Timestamps for the content may corresponds to one or more annotations for the content. For instance, a timestamp may indicate what time to provide an annotation to the reviewer. An annotation may involve overlaying an indicator on a feature in the content. A timestamp may indicate at which time to overlay an annotation on the content, or otherwise provide the annotation that corresponds to the timestamp to an individual reviewing the content. Timestamps may also indicate when to provide various questions included in an associated AT to the reviewer.

At optional block 514, the subject may generate one or more tag suggestions for the content. A tag for the content may include any metadata to associate with the content. For instance, a tag may indicate the type of subject activity that is documented in the content. Thus, a tag may include a descriptor of the performance to be reviewed. A tag may indicate an employee number, or some other identification of the subject. Tags may be arranged in folder or tree-like structures to create cascades of increasing specificity of the metadata to associate with the content. For instance, one tag may indicate that the subject is a healthcare provider, while a sub-tag may indicate that the subject is a surgeon. A sub-sub tag may indicate that the subject is a robotic surgeon.

At optional block 516, the subject may generate assessment tool suggestions for the content. The subject may suggest one or more ATs to associate with the content. At block 518, the content and the subject suggestions are received. For instance, the subject may provide the content and generated subject suggestions via a documenting computer, to a computer included in an ATP platform, over a network. As mentioned in at least conjunction with block 502, in some embodiments, self-executing code included on a USB storage drive, or another device that is provided to the subject, will automatically provide the content and subject suggestions to an ATP, after the content has been captured, and optionally, after the subject has completed generating subject suggestions.

At block 520, the received content is processed. Various embodiments of processing content are discussed in conjunction with at least process 540 of FIG. 5B. However briefly, at block 520, the content is anonymized, trimmed, annotated, and tagged prior to providing the content with the plurality of reviewers. Process 500 terminates and/or returns to a calling process to perform other actions.

FIG. 5B shows an overview flowchart for process 540 for processing captured content, in accordance with at least one of the various embodiments. After a start block, process 540 begins at block 542, where the received content is anonymized. Anonymizing the content may include removing, excising, distorting, redacting, or the like, identifying portions of the content that may include identifying information with respects to individuals being documented in the content. For instance, anonymizing the content may involve blurring and/or pixelating portions of video content that may identify the subject, a patient, customer, an employer, location, or the like. The content may be anonymized in block 542 to protect the privacy of individuals and/or institutions associated with the content. Anonymizing the content may include anonymizing personally-identifiable information (PII) regarding the subjects, or any other individuals, machines, robots, brand names, trade names, parties, organizations, and the like that may be documented in the content. Anonymizing the content may be automated, or at least semi-automated. Additionally, the content may be anonymized so that the reviewer's are blinded to the identity of the subject being assessed. In this way, the various embodiments remove bias from the assessment process, such that the assessment is a blinded objective assessment.

At optional block 544, any of the subject suggestions, including but not limited to trim, annotation, timestamp, and tag suggestions, as well as assessment tool suggestions may be considered and/or included. In other embodiments, it may be decided at block 544 to not include, or otherwise discard the subject suggestions of process 500 of FIG. 5A.

At block 546, the content is trimmed. In at least one embodiment, trimming the content is based on trim suggestions provided via process 500 of FIG. 5A. As noted above, the content may be trimmed to remove non-relevant portions, or identifying portions of the content. As such, anonymizing the content in block 542 may continue in block 546. The content may be trimmed for time issues. For instance, a reviewer may need to only review a portion of the content to adequately assess the performance documented in the content. In at least one embodiment, the content is trimmed to include only portions that are relevant to the assessment of the domains of the performance of the subject activity. To reduce the bandwidth required to provide the content to the plurality of reviewers, a resolution (or definition) of the content may be reduced at block 546.

At block 548, annotations for the content may be generated. At least a portion of the annotations may be based on annotation suggestions provided via process 500 of FIG. 5A. Non-limiting examples of content annotations are shown in FIGS. 11A-11C, as 1008, 1188, and 1190. As noted above, annotation may include indicators or overlays to be paired with the content. Annotations may include instructions to guide the reviewers when reviewing the content. At block 550, timestamps are generated for the content. At least a portion of the timestamps may be based on timestamp suggestions provided via process 500 of FIG. 5A. One or more timestamps may correspond to an annotation for the content. For instance, a timestamp may indicate, at which time during reviewing the content, should the annotation be overlaid on the content, or otherwise provided to an individual reviewing the content. One or more timestamps may indicate, at which time during the reviewing of the content, should a question included in the associated AT shall be provided to the reviewer in a web interface, such as web interfaces 1100 and 1180 of FIGS. 11A-11C.

At block 552, tags for the content may be generated. At least a portion of the tags may be based on annotation suggestions provided via process 500 of FIG. 5A. A tag for the content may include any metadata to associate with the content. For instance, a tag may indicate the type of subject activity that is documented in the content. A tag may indicate an employee number, or some other identification of the subject. Tags may be arranged in folder or tree-like structures to create cascades of increasing specificity of the metadata to associate with the content. For instance, one tag may indicate that the subject activity is a customer service transaction, while a sub-tag may indicate that the subject activity involves a customer returning a product. A sub-sub tag may indicate that the customer is returning an article of clothing because of manufacturing defect. Process 500 terminates and/or returns to a calling process to perform other actions.

FIG. 6A shows an overview flowchart for process 600 for associating an assessment tool with content, in accordance with at least one of the various embodiments. After a start block, process 560 begins at block 602, where one or more candidate assessment tools (ATs) are determined. In various embodiments, determining one or more candidate ATs may be based on the content tags generated via process 5040 of FIG. 5B. In at least one embodiment, determining the one or more candidate ATs may be based on the AT suggestions provided via process 500 of FIG. 5A.

In some embodiments, one or more candidate ATs may be selected from an assessment tool database. For instance, an AT database, such as AT database 214 of FIG. 2 or AT database 314 of FIG. 3 may include a plurality of ATs. At least a portion of the ATs included in the AT database may have been previously been validated. A tag of the content may indicate that the subject activity documented in the content is a nurse measuring the glucose level of a patient. A portion of the ATs included in the AT database have been previously validated for a nurse measuring the glucose level of a patient. These previously validated ATs may be selected as candidate ATs at block 602. The candidate ATs may be further filtered on other tags for the content, or assessment tool suggestions. In at least one embodiment, when the candidate ATs include a plurality of candidate ATs, the candidate ATs are ranked or prioritized via other tags for the content, AT suggestions, or other selection criteria.

At decision block 604, it is determined if a blended AT is to be generated. For instance, a blended AT may be generated by blending a plurality of candidate ATs. The decision to generate a new blended AT may be based on the plurality of tags for the content, AT suggestions, or other criteria. For instance, if the AT database does not include a previously validated AT for the specific subject activity, but does include validated ATs for similar subject activities, the ATs for the similar subject activities may be selected as candidate ATs at block 602. A blended AT may be generated based on the validated ATs for the similar subject activities. If a blended AT is to be generated, process 600 flows to block 606. Otherwise, process 600 flows to block 608.

At block 606, a blended AT is generated based on the plurality of candidate assessment tools. For instance, a portion of the questions included in a first candidate AT may be included with a portion of the questions included in a second candidate AT to generate a blended AT. The blending of multiple ATs may be based on one or more tags for the content, as well as assessment tool suggestions. For instance, an assessment tool suggestion may indicate to generate a blended AT that includes questions 1-4 from a first suggested AT and questions 5-10 from a second suggested AT.

At block 608, one or more ATs are selected from the plurality of candidate ATs and/or the blended AT. The selected AT may be, but need not be, a validated AT. The selection of the AT may be based on a ranking of the candidate ATs. For instance, in at least one embodiment, a top-ranked AT from the candidate ATs may be selected at block 608. In another embodiment, a blended AT, generated at block 606, may be selected at block 608. At optional block 610, one or more additional questions may be included in the selected AT. For instance, additional questions may be included in the selected AT based on one or more tags for the content, assessment tool suggestions, and the like. The subject being assessed may suggest additional questions to included in the sleeted AT. In other embodiments, the subject employer, or potential employer, may suggest additional questions. In at least one embodiment, a training institution or an institution that credentials or certifies subjects based on their assessed performance of subject activities may suggest additional questions to include in the selected AT. In some embodiments, a party that validates ATs may suggest additional questions to include in the selected AT, where the additional are required to validate the selected AT. In at least one embodiment, the additional questions may be appended onto the selected AT.

At optional block 612, the processed content and the selected AT is provided to the subject for feedback. Various embodiments for providing the processed content and the selected AT are discussed in conjunction with at least process 640 of FIG. 6B. However briefly, the content and the selected AT may be provided to the subject, or other party, such as but not limited to the subject's employer at block 604. The subject, or the other party may provide feedback to enhance a further processing of the content, selected an alternative AT, provide additional questions to include in the selected AT, and the like.

At decision block 614, it is decided whether to accept the selected AT. If the selected AT is to be accepted, process 600 flows to block 616. Otherwise, process 600 flows back to block 602 to determine another one or more candidate ATs. In at least one embodiment, determining whether the selected AT is to be accepted is based on at least feedback received in response to providing the processed content and the selected AT to the subject, the subjects' employer, or another party, in optional block 612.

At block 616, the selected AT is associated with the content. In at least one embodiment, associated the selected AT with the content includes generating a tag for the content, where the tag indicates the associated AT.

At optional block 618, the annotations and timestamps for the content may be updated. The annotations and the timestamps may be updated based on the associated AT. One or more annotations and/or timestamps for the content may be generated based on the associated AT. For instance, based on the associated AT, annotations for the content may be generated to provide a reviewers signals or other indications regarding what to pay specific attention to when reviewing the content. The associated AT may include specific questions that are associated with specific annotations and/or timestamps for the content. These associated annotations and timestamps may be generated and/or updated to include with the content. Process 600 terminates and/or returns to a calling process to perform other actions

FIG. 6B shows an overview flowchart for process 640 for providing processed content and an associated assessment tool to the subject for subject feedback, in accordance with at least one of the various embodiments. After a start block, process 640 begins at block 642, where the processed content and the selected assessment tool (AT) is provided to the subject. As noted above, the content and the selected AT may be provided to another individual or party, such as, but not limited to the subject's employer, training/educational institution, certifying or credentialing institution, law-enforcement agency, and the like, for feedback. In at least one embodiment, a computer included in an ATP platform, such as ATP platform 140 of FIG. 1, may provide a user of a documenting computer, such as one of documenting computers 112-118 of FIG. 1, the processed content and the selected AT for feedback.

At optional block 644, the subject, or another individual, may generate feedback regarding the content trims, annotations, timestamps, and/or tags for the content that were generated in process 540 of FIG. 5B. For instance, the subject may suggest further trims, or additional annotations, timestamps, and tags for the content. In at least one embodiment, the subject may generate feedback in regards to a portion of the content that was trimmed in process 540 of FIG. 5B. In such feedback, the subject may suggest that to assess their performance of the subject activity, it would be beneficial to include a previously trimmed portion of the content. The subject may suggest additional and/or alternative annotations, timestamps, and tags for the content.

At optional block 646, the subject may browse an AT database, such as AT database 214 of FIG. 2 or AT database 314 of FIG. 3. The subject may suggest an AT included in the AT database, as an alternative to the selected AT. At optional block 648, the subject may generate additional questions to include in either the provided AT or the alternative AT selected at block 644. For instance, the subject may suggest questions that are directed specifically to her performance. At block 650, the subject feedback is received. For instance, a computer included in the ATP platform may receive the subject feedback from one or more documenting computers. The subject feedback may include additional and/or alternative trims, annotations, timestamps, tags, and the like for the content. The alternative AT, as well as the additional questions may be received at block 650.

At decision block 652, it is decided whether to update the processed content, in view of the subject feedback received at block 650. For instance, at decision block 652, it may be determined whether the subject feedback would bias, either favorably or unfavorably, the reviewers' assessment of the subject performance. If so, the processed content would not be updated. However, if the subject's suggestions would make reviewing the content more efficient or more clear to the reviewer, then at block 652 it would be decided to update the processed content. If the processed content is to be updated, process 640 flows to block 652. Otherwise, process 640 flows to decision block 656. At block 654, the processed content is updated based on the subject feedback received at block 650. For instance, at least one of the trims, annotations, timestamps, and/or tags for the content may be updated at block 654.

At decision block 656, it is determined whether to update the selected AT, based on the subject feedback received at block 650. For instance, if the subject feedback regarding an alternative AT or additional questions is determined to be beneficial, regarding the reviewers' assessment, then it would be decided at block 656 to update the selected AT. If the selected AT is to be updated, process 640 flows to block 658. Otherwise, process 640 terminates and/or returns to a calling process to perform other actions. At block 658, the selected AT is updated based on the alternative AT received at block 650. For instance, the selected AT may be replaced by the alternative AT. In at least one embodiment, the selected AT is only updated and/or replaced if the alternative AT is a validated AT. At block 660, the selected and/or alternative AT is updated based on the additional questions provided at block 650. For instance, the selected AT may be updated by appending the additional questions onto the selected AT.

FIG. 7 shows an overview flowchart for process 700 for providing the content and the associated assessment tool (AT) to reviewers, in accordance with at least one of the various embodiments. After a start block, process 700 begins at block 702, where a plurality of crowd reviewers are selected to review the content and assess the domains of the performance of the subject activity documented in the content. Similarly, at block 704, one or more honed crowd reviewers are selected to review the content and assess the performance of the subject activity. In addition, at block 706, one or more expert reviewers are selected to review the content and assess the performance of the subject activity.

Selecting the reviewers in each of blocks 702, 704, and 706 may be based on the type of subject activity that is documented in the content, as well as budgetary and time constraints associated with assessing the performance of the subject activity. Selecting reviewers in at least one blocks 702, 704, or 706 may be based on qualifying and/or matching the crowd, honed, and/or expert reviewers for at least the type of subject activity documented in the content. In some embodiments, selecting reviewers is based on the historical accuracy of the reviewers reviewing other content for the particular type of subject activity.

The selecting process may be based on at least a comparison between the past reviews provided potential reviewers and a distribution of past reviews provided by other reviewers, such as but not limited to expert reviewers, honed crowd reviewers, trained reviewers, and the like. For example, selecting a reviewer from a pool of reviewers during at least one of blocks 702, 704, or 706 may include comparing the reviewer's past reviews for the particular type of subject activity to the mean, average, or median reviews provided by an already selected cohort of reviewers, such as but not limited to a cohort of expert reviewers, honed crowd reviewers, trained reviewers, or the like.

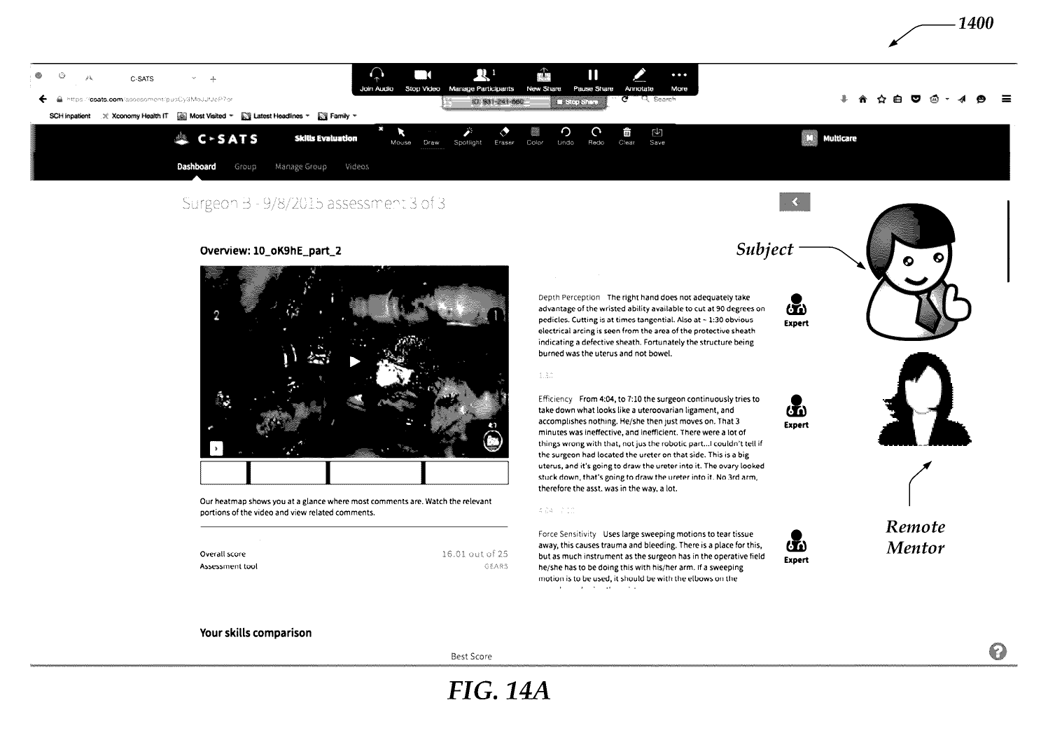

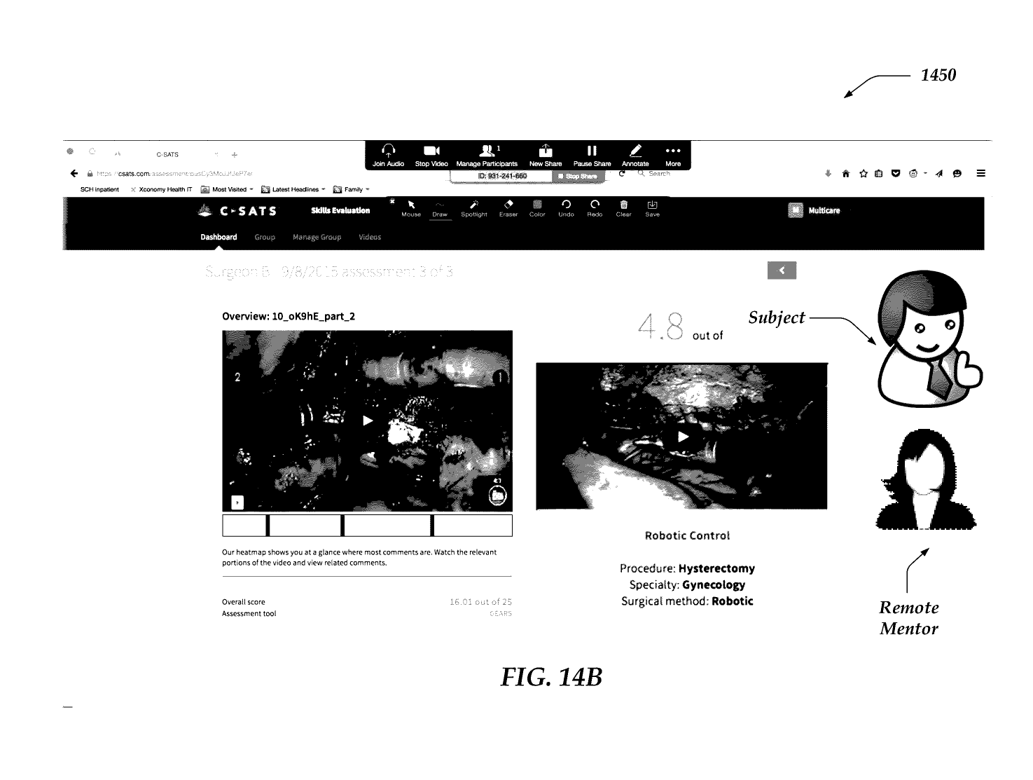

Accordingly, selecting a reviewer may be based on the reviewer's reliably demonstrated accuracy of past reviews for the particular type of subject activity, i.e. how close the reviewer's previous reviews tracked with the mean of a group of already qualified or expert reviewers, honed crowd reviewers, trained reviewers, or the like. In some embodiments, selecting the reviewers may be based on previous training the reviewers have received. For instance, to be selected as a reviewer at blocks 702 or 704, a reviewer may be required to be at least a partially trained reviewer. The reviewer may be required to have previously demonstrated a predetermined level of accuracy via a training module. FIGS. 14A-14B show exemplary embodiment web interfaces 1400 and 1450 that enable real-time remote mentoring. Selecting a reviewer during any of blocks 702, 704, or 706 may be automated or at least semi-automated.

For instance, in various embodiments, where reviewers are paid for their reviewing and assessing services, the total number of and mix of crowd reviewers, honed crowd reviewers, and expert reviewers may be based on budgetary constraints, as well as an availability of the reviewers.

In various embodiments, the services provided by an expert reviewer are significantly more costly than the services provided by a honed crowd reviewer, which are typically more costly than the services provided by a crowd reviewer. Furthermore, the services of a top-tiered honed crowd reviewer are likely more costly than a second- or third-tiered honed crowd reviewer. Additionally, the pool of available crowd reviewers may be significantly greater than the pool of available expert reviewers. Upon providing the content, as well as the associated assessment tool (AT), crowd reviewers may generate a statisitically significant assessment of domains of the performance of the subject activity within hours, while it may take weeks to receive assessment data from just a single, or a few expert reviewers, depending upon the availability of the much smaller expert reviewer pool.

Thus, the number of each of crowd reviewers, honed crowd reviewers, and expert reviewers selected at blocks 702, 704, and 706 respectively may be based on a budget and a time constraint for the assessing task. Likewise, the ratios of the number of crowd reviewers, honed crowd reviewers, and expert reviewers selected at blocks 702, 704, and 706 respectively may be based on a budget and a time constraint for the assessing task. In various embodiments, the specific reviewers, as well as the absolute numbers and/or ratios of the crowd reviewers, honed crowd reviewers, and expert reviewers selected at blocks 702, 704, and 706 are determined based on the statistical validity desired for the review process, as well as the specific experience and rating history of the selected reviewers.

The crowd reviewers selected at block 702 may be selected from a pool of available crowd reviewers. For instance, a crowd reviewer may establish an account with a party associated with the ATP platform. The crowd reviewer may periodically update an availability status. The availability status may be directed to one or more specific subject activities or may be a general availability status. The availability status may indicate that the reviewer is willing to review and assess a specific number of subject performances a month. The pool of available crowd reviewers may include at least a portion of the crowd reviewers that have a positive availability status.

In various embodiments, if it is desired to include at least N crowd reviewers in the crowd-sourced assessment, where N is a positive integer, ceiling(m*N) crowd reviewers are selected from the pool of available crowd reviewers, where m is a number greater than 1. For instance, if it is desired to include the independent assessments of at least 100 crowd reviewers (N=100), 1000 crowd reviewers (m=10) are selected from the pool of available crowd reviewers. In at least one embodiment, the selection of crowd reviewers from the pool of available crowd reviewers may be a random selection. In at least one other embodiment, the selection of crowd reviewers may be based on tags for the content, the type of subject activity documented in the content, the history of the available crowd reviewers and their accuracy in evaluating certain procedures, or some other selection criteria. The selection of honed crowd reviewers in block 704 and the selection of expert reviewers in block 706 may be similar and include similar considerations.

In at least some embodiments, the reviewers selected at least one of the blocks 702, 704, and 706 are selected based on the location of the reviewers. For instance, for some assessment tasks, it may be desirable to more heavily weight crowd reviewers located in a particular global region, country, state, county, city, neighborhood, or the like. In such embodiments, at least a portion of the crowd reviewers selected at block 702 are selected based on their location. For instance, a GPS transceiver included in a computer used by a reviewer may provide geo-location data of the reviewer. In at least one embodiment, where it is desired to determine a local opinion, standard or care, or some other localized determination, only reviewers located near the specific local are selected at blocks 702, 704, or 706.

At block 708, the content, along with the annotations, timestamps, and tags are provided to each of the selected crowd reviewers, honed crowd reviewers, and expert reviewers. Likewise, at block 710, the associated AT is provided to each of the selected crowd reviewers, honed crowd reviewers, and expert reviewers. In various embodiments providing the content and associated AT to the reviewers includes at least sending a message or alert to a reviewing computer, such as reviewing computers 102-108 of FIG. 1, to indicate to a user of the reviewing computer (one of the selected reviewers) that content is available to be reviewed. The alert or message may include a link to a web interface that provide the content and the associated AT.

The reviewer may access the web interface via a reviewing computer, or another computer that is communicatively coupled to an ATP platform through a wired or wireless network. In at least one embodiment, a computer that is not under the control of a party that is in control of the ATP platform provides at least the content in a web interface. In some embodiments, a reviewer may receive a local copy of the content to locally store on a computer. In other embodiments, the content may be streamed to a computer used by the reviewer.

FIG. 11A illustrates an exemplary embodiment of web interface 1100 employed to provide a reviewer at least content documenting a surgeon's performance of a robotic surgery and the associated AT of FIG. 10A. As discussed in conjunction with at least block 406 of process 400 of FIG. 4, web interface 1100 provides content, such as content 1102, which documents a surgeon's performance of a robotic surgery. In at least one embodiment, a computer included within the ATP platform provides the content to the reviewer. In other embodiments, a computer not included in the ATP platform provides the content to the reviewer.

Web interface 1100 provides the reviewer the associated AT 1104. The reviewer may be enabled to provide assessment data regarding her assessment of the performance of the subject activity by answering at least a portion of the questions in AT 1104, as the reviewer reviews content 1102. In this exemplary, but non-limiting embodiment, AT 1104 corresponds to AT 1000 of FIG. 10A.

As discussed throughout, a web interface, such as web interface 1100 may provide annotations 1108 to the reviewer. Annotations 1108 may provide the reviewer indicators and/or signals of what to pay attention to when reviewing content 1102. Web interface 1100 may enable the reviewer to provide qualitative assessment data, such as comments, descriptions, notes, and other feedback via an interface, such as interface 1106. FIG. 11D illustrates another exemplary embodiment web interface 1190 that is similar to web interface 1100 of FIG. 11A, but is directed to a sales associate's performance of a customer interaction, and includes a corresponding AT directed to evaluating the sale associate's performance.

FIGS. 11B-11C illustrates another exemplary embodiment of web interface 1180 employed to provide a reviewer at least content 1182 documenting a nurse's performance of using a glucometer to measure blood glucose levels and an associated AT. Similar to web interface 1100, web interface 1180 provides content 1182, as well as the associated AT 1184 to the reviewer Web interface 1180 also includes annotations 1188 and 1190 to provide the reviewer guidance when reviewing the content, as well providing assessment data, in the form of answering questions included in AT 1184. The appearance of the annotations may be synced with the content via timestamps. Likewise, the appearance of individual questions in AT 1184 may be synced with the content via timestamps for the content.

At optional block 712, a protocol may be provided to each of the crowd, honed crowd, and expert reviewers. The protocol may be provided to the reviewers via a web interface or any other mechanism. FIG. 9 shows a non-limiting exemplary embodiment of a protocol 900 for a nurse to follow when measuring the glucose level of a patient. The provided protocol may correspond to a protocol that the subject is presumed to follow while performing the subject activity. For instance the AT 1184 of web interface 1180 corresponds to protocol 900 of FIG. 9. Providing the protocol, which the subject is presumed to follow, to the reviewers may assist the reviewers when assessing the performance of the subject activity. For instance, a reviewer may determine whether the subject missed steps in the protocol.

At block 714, assessment data is received from at least one of the crowd reviewers, honed crowd reviewers, or the expert reviewers. The assessment data may be received from one or more reviewing computers, over at network. In at least one embodiment, at least a portion of the assessment data is received by one or more computers included in the ATP platform. The assessment data may include answers to a plurality of questions included in the associated AT. At least a portion of the assessment data may be quantitative assessment data or numerical assessment data. For instance, each of the answers included in exemplary embodiment AT 1000 of FIG. 10A requires a numerical answer ranging between 1 and 5. The reviewers may provide assessment data by interacting with a web interface, such as web interfaces 1100 and 1180 of FIGS. 11A-11C.

In at least one embodiment, the received assessment data includes at least geo-location data regarding the location of at least a portion of the reviewers that have provided the assessment data. The geo-location data may be generated by a GPS transceiver included in a reviewing computer used by the reviewer. In at least one embodiment, for reviewing computers that do not include a GPS transceiver, a reviewer may be prompted to provide at least an approximate location, via a user interface displayed on the documenting computer. In at least one embodiment, at least a portion of the software on a documenting computer is localized based on geo-location data generated by a GPS transceiver.

At block 716, qualitative assessment data is received from at least one of the crowd reviewers, honed crowd reviewers, or the expert reviewers. Qualitative assessment data may include qualitative comments, descriptions, notes, audio comments and other feedback based on at least a portion of the reviewers' assessments. In some embodiments, only a portion of the reviewers are enabled to provide qualitative assessment data. For instance, in at least one embodiment, only expert reviewers are enabled to provide qualitative assessment data because qualitative assessment data may require expert-level judgement. In another embodiment, only expert reviewers and honed crowd reviewers are enabled to provide qualitative assessment data. In at least one embodiment, each reviewer is enabled to provide qualitative assessment data through a web interface, such as web interfaces 1100 and 1180 of FIGS. 11A-11C.

In at least one embodiment, when a predetermined number of crowd reviewers, honed crowd reviewers, or expert reviewers have provided a predetermined volume of assessment data, or qualitative assessment data, the selected reviewers that have not yet provided assessment data are not longer operative to provide assessment data. For instance, when enough assessment data has been received such that the assessment of the various domains includes a statistical significance of a predetermined threshold, no more assessment data is required for the assessment task.

In the above exemplary embodiment, where 1000 crowd reviewers are selected at block 702, after the first 100 crowd reviewers have provided assessment data in regards to the questions in the associated AT, the other 900 crowd reviewers are no longer enabled to view the content and/or provide additional assessment data. In at least one embodiments, at least a portion of the reviewers that are no longer enabled to provide assessment data may still be enabled to provide qualitative assessment data. Process 700 terminates and/or returns to a calling process to perform other actions.

FIG. 8 shows an overview flowchart for process 800 for collating assessment data provided by reviewers, in accordance with at least one of the various embodiments. After a start block, process 800 may begin at optional block 802 where a location of at least a portion of the reviewers is determined. As noted in at least conjunction with block 714 of process 700 of FIG. 7, at least a portion of the assessment data provided by the reviewers may include GPS transceiver generated, or reviewer provided, geo-location data of the reviewer. The location of reviewers that have included geo-location data within their assessment data is determined based on the geo-location data. The location of the reviewers may be employed to construct a map of the location of the reviewers in a report detailing the assessment of the reviewer. For instance, the location of the reviewers may be used to construct map 1264 of report portion 1260 of FIG. 12C.

At block 804, distributions for domains of the assessment tool (AT) are determined based on the assessment data. At least a portion of the assessment data may have been received at block 714 or block 716 of process 700 of FIG. 7. The distributions may be based on the answers provided by the plurality of reviewers to the plurality of questions included in the AT associated with the content. In an exemplary embodiment, a distribution of reviewer numerical answers is determined for each questions of AT 1000 of FIG. 10A. Each distribution may include a histogram of the numerical answers provided by the plurality of reviewers.

In some embodiments, a separate histogram may be generated for each type of reviewer and each quantitative question in the AT. For instance, a crowd reviewer histogram may be generated for the crowd reviewer assessment data regarding the depth perception question of AT 1000. A honed crowd histogram may be generated for the honed crowd assessment data regarding the depth perception question of AT 1000. An expert histogram may be generated for the expert reviewer assessment data regarding the depth perception question of AT 1000. Each question in the AT may correspond to a separate domain that is assessed. One or more distributions may be generated for each question included in the AT and for each cohort of reviewers. The mean, variance, skewness, and other moments may be determined for the distribution for each question for each reviewer cohort.

At block 806, the distributions for the crowd reviewer assessment data, the honed crowd reviewer assessment data, and the expert reviewer assessment data are calibrated. Calibrating the distributions at block 806 may include at least comparing the distributions for crowd reviewer assessment data to the distributions of the honed crowd reviewer data and to the distributions for the expert crowd reviewers assessment data. At block 806, the reviewer distributions may be normalized based on expert generates assessment data. Such comparisons may include comparing the mean, variance, and other moments of the distributions between the crowd, honed crowd, and expert reviewer cohorts.

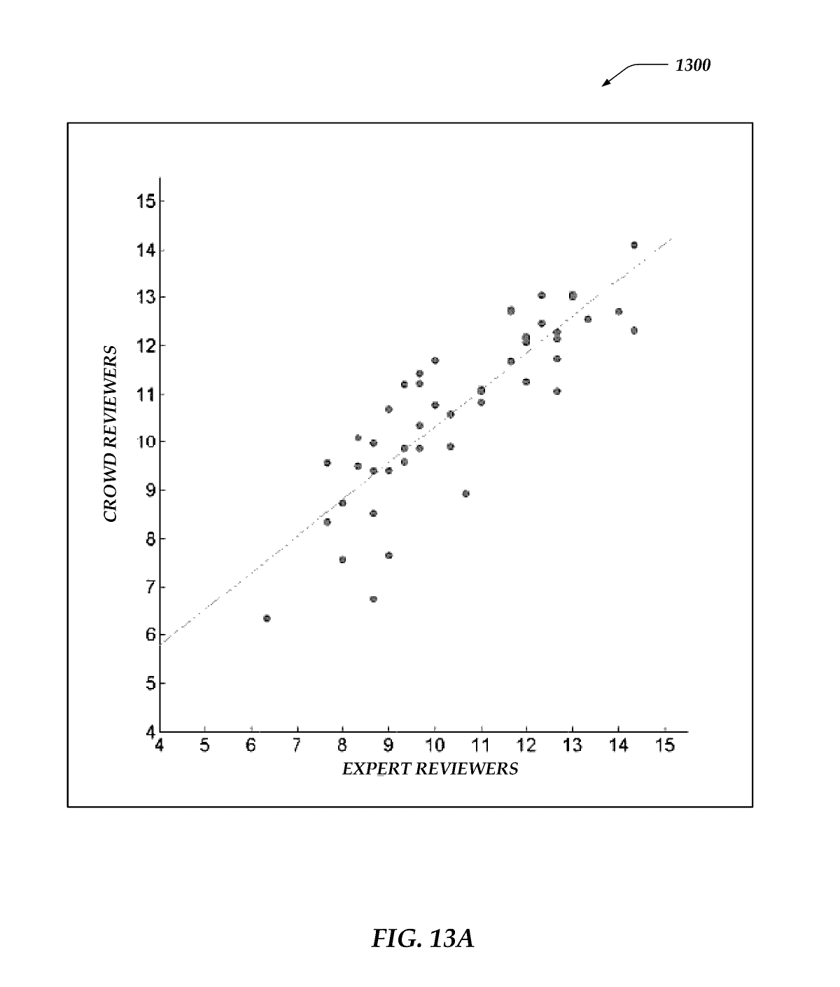

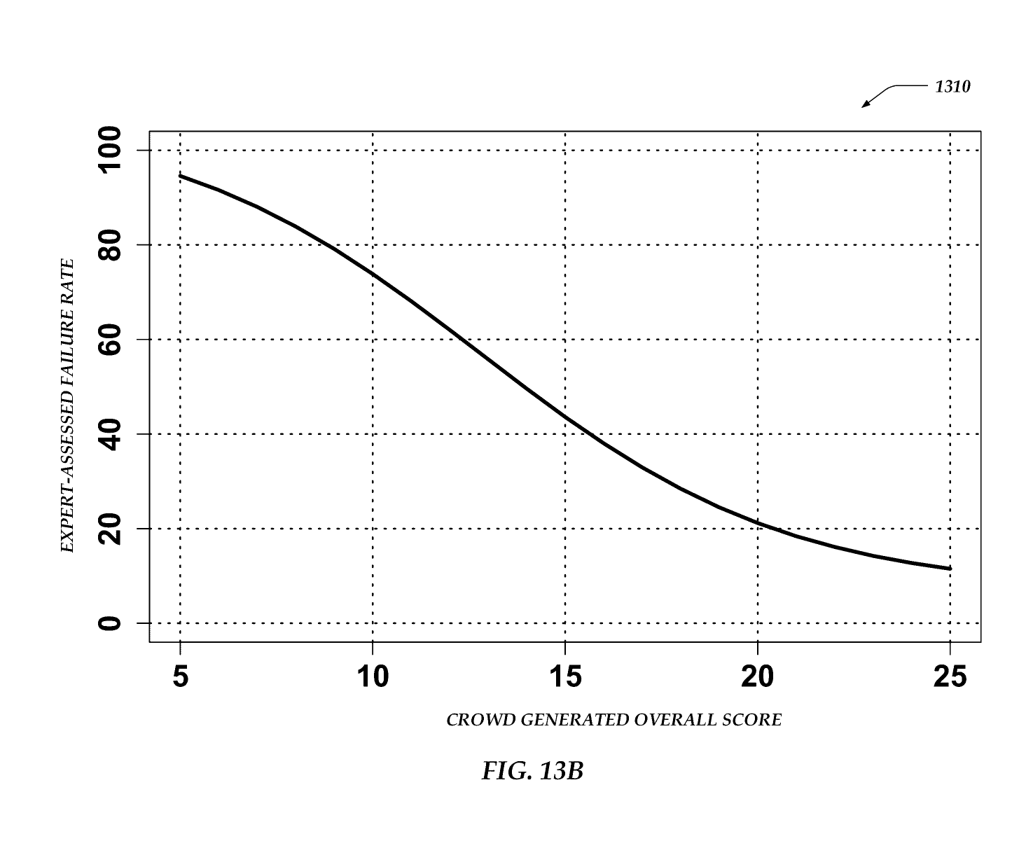

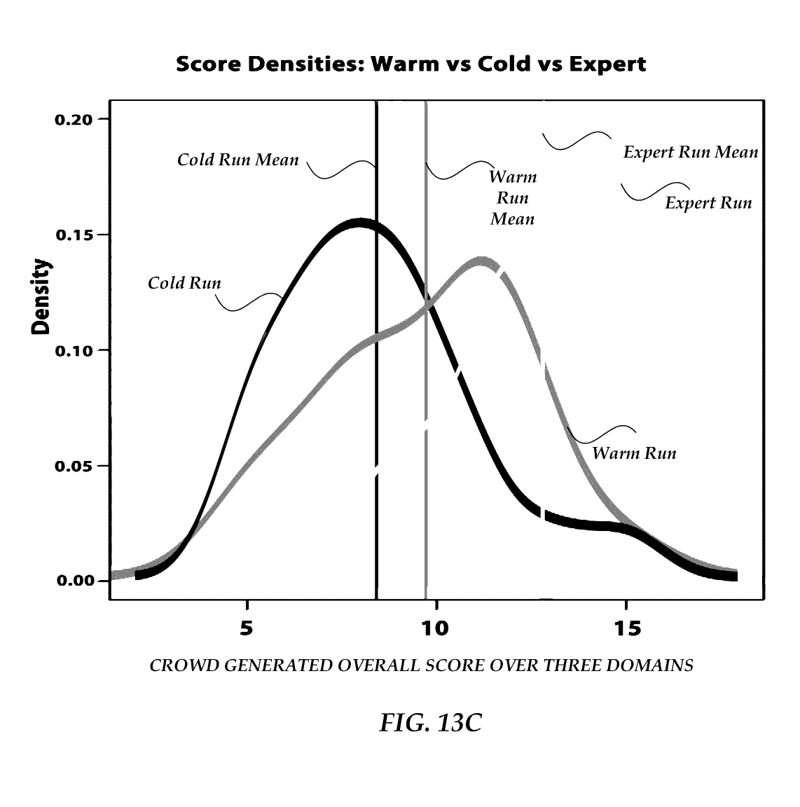

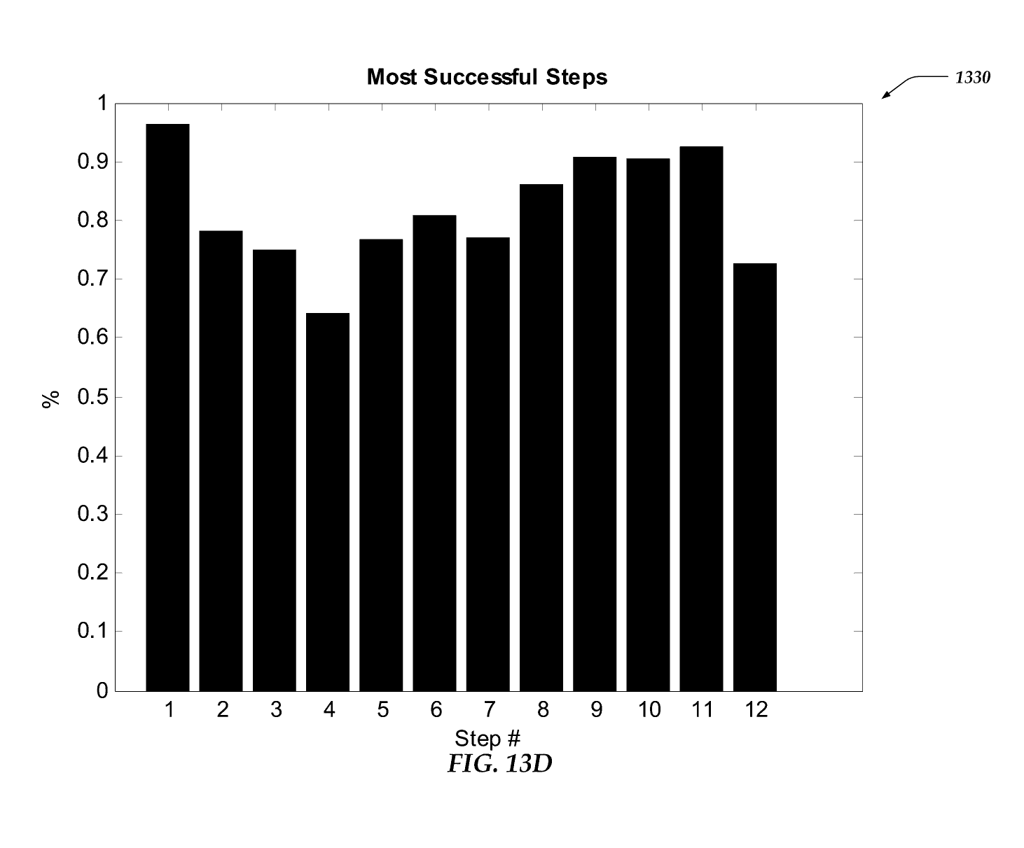

Calibrating the distributions may include determining at least a correspondence, relationship, correlation, or the like between the distributions (or moments of the distributions) of the various reviewer cohorts. Determining a calibration may include using previously determined correlations between crowd reviewer generated scores and expert reviewer generated scores. For instance, FIG. 13A illustrates a scatterplot 1300 showing a correlation between a reviewer generated overall score and an expert reviewer generated overall scores. Such plots may be used to determine calibrations and/or correlations between the distributions, scores, rankings, and the like generated by crowd reviewers, honed crowd reviewers, and expert reviewers.

At block 808, qualitative assessment data may be curated. At least a portion of the qualitative assessment data may have been received at block 716 of process 700 of FIG. 7. Such a curation may include determining which reviewer generated generalized comments, feedback, notes, and the like to include in a report, such as report portion 1260 of FIG. 12C. For instance, curating the qualitative assessment data may include which reviewer generated comments are most specific, accurate, instructive, on point, and the like. A curation of qualitative assessment data may include associating one or more reviewer generated comments with one or more domains or questions included in the associated AT. Curating qualitative data at block 808 may include associating a timestamp with a comment, where the timestamp indicates a portion of the content that corresponds to the comment.

In various embodiments, at least one of an information classification system or a machine learning system is employed to automate, or at least semi-automate, at least a portion of the curation of the qualitative assessment data at block 808. In at least one embodiment, at least a portion of the qualitative assessment data, such as but not limited to the reviewer generated comments are automatically classified and searched over. The searcher may identify the comments that may provide learning opportunities for the subject associated with the content, or others individuals or parties that may use the content and the curated qualitative assessment data as a learning, training, or an improvement opportunity.

Furthermore, at block 808, annotations for the content may be generated. The annotations may be based on at least assessment data or the qualitative assessment data provided by the reviewers. The annotations may be timestamped such that the annotations are associated with particular portions of the content. As a training or learning tool, the assessed subject may playback the content and the curated qualitative assessment data, such as reviewer generated comments and annotations, may be provided to the subject to signal a correspondence between the qualitative assessment data and the performance documented in the content. Accordingly, the reports generated in the various embodiments provide a rich learning and training environment for the assessed subjects. Upon studying an assessment report and incorporating the curated qualitative assessment data into future performance, a subject's skill in performing the subject activity is increased.

At block 810, one or more domain scores are determined for one or more domains. The domain scores may be determined based on the distributions for the domains. For instance, the domain score for a particular domain may be based on one or more moments of the distribution for the domain. The domain score may be based on the calibration of the distributions of block 806. For instance, the distributions of the crowd reviewer assessment data may be shifted, normalized, or otherwise updated based on a correlation with the expert assessment data. At block 810, the reviewer distributions may be normalized based on expert generated assessment data. A systematic calibration may be applied to the crowd assessment data, may be applied to any of the crowd cohort assessment data based on the calibrations of block 806.

A domain score may be based on the mean of the distribution (calibrated or un-calibrated), as well as the variance of the distribution. In at least one embodiment, the domain score includes an indicator of the variance of the distribution, such as an error bar. A separate domain score may be generated for each of crowd reviewers, honed crowd reviewers, and expert reviewers and for each question included in the associated AT.

In an exemplary embodiment, report portion 1230 of FIG. 12B includes the domain scores 1234 of the technical domains of AT 1000 of FIG. 10A. Each of the domain scores may be a mean or median value of the corresponding domain distribution in the reviewer generated assessment data. One or more of the domain scores may be based on a combination of or a blend of the corresponding crowd reviewer domain distributions, honed crowd reviewer domain distributions, and the expert reviewer domain distributions.

At block 812, an overall score for the subject may be determined. The overall score may include a combination or a blending of each of the domain scores for the subject. An overall score for the subject may be determined based on a weighted average of the domain scores for the subjects, where each individual domain score is weighted by a predetermined or dynamically determined domain weight. For instance, indicator 1236 of report portion 1230 of FIG. 12B shows an average overall score of Surgeon E. The overall score may be an average or mean of the domain scores 1234.

At optional block 814, the subject may be ranked based on at least one domain score, the overall score and other subjects. For instance report portion 1200 of FIG. 12A shows a ranking of each surgeon 1204, based on an overall score for each surgeon. Other rankings and/or comparisons are possible in the various embodiments. For instance, report portion 1230 includes a skill comparison between Surgeon E and a local cohort, as well as a global cohort. Process 800 terminates and/or returns to a calling process to perform other actions. Similarly, team dashboard 1270 of FIG. 12E shows a ranking for members of a sales team.

### Illustrative Use Cases

FIG. 9 shows a non-limiting exemplary embodiment of a protocol 900 for a nurse to follow when using a glucometer to measure the glucose level of a patient. Other embodiments are not limited to health-care related protocols. In some embodiments, protocol 900 may be provided to a subject to assess. In at least one embodiment, a protocol, such as protocol 900, may be provided to at least a portion of the plurality of reviewers. Crowd reviewers may assess various domains of the performance of the subject activity by being provided the protocol that the subject is presumed to follow when performing the subject activity.

FIG. 10A illustrates an exemplary embodiment of an assessment tool 1000 that may be associated with content documenting a surgeon's performance of a robotic surgery in the various embodiments. FIG. 10B illustrates another exemplary embodiment of an assessment tool 1010 that may be associated with content documenting another performance of a healthcare provider. The content, as well as the associated AT, are provided to the plurality of reviewers. Upon reviewing the content, each of the reviewers may provide assessment data that includes answers to at least a portion of the questions included in the associated AT.

Various questions included in the associated AT may be directed toward technical domains in the subject activity documented in the content. For instance, AT 1000 of FIG. 10A includes questions directed to the technical domains of depth perception, bimanual dexterity, efficiency, force sensitivity, and robotic control of a robotic surgery. Crowd reviewers, as well as expert reviewers may provide answers to such questions directed towards technical domains.

In at least one embodiment, a portion of the questions in the associated AT are directed towards non-technical domains of the subject activity. For instance, AT 1010 of FIG. 10B includes questions directed to the non-technical domains regarding services directly to consumers. In some embodiments, only expert reviewers are enabled to provide answers to non-technical questions. In some embodiments, at least one of the questions included in an AT is a multiple-choice question. At least one of the included questions may be a True/False question. The answer to some of the questions included in an AT may involve filling in a blank, or otherwise providing an answer that is not otherwise a multiple choice or True/False answer. Some of the included questions may involve a ranking of possible answers. In at least one embodiment, a question included in an AT requires a numeric answer. In some embodiments, at least one question included in an AT requires a quantitative answer.

As shown in at least AT 1010 of FIG. 10B, an AT may include open-ended qualitative questions or prompt a review for generalized comments, feedback, and the like. Reviewers may provide qualitative assessment data by providing answers to such open-ended questions, including generalized comments, feedback, notes, and the like.

FIG. 11A illustrates an exemplary embodiment of web interface 1100 employed to provide a reviewer at least content documenting a surgeon's performance of a robotic surgery and the associated AT of FIG. 10A. Web interface 1100 provides video content 1102, which documents a surgeon's performance of a robotic surgery. In at least one embodiment, a computer included in an ATP platform, such as ATP platform 140 of FIG. 1, provides the content to the reviewer. In another embodiment, a computer outside of the ATP platform provides the content.

Web interface 1100 provides the reviewer the associated AT 1104. The reviewer may be enabled to provide assessment data regarding her assessment of the performance of the subject activity by answering at least a portion of the questions in AT 1104, as the reviewer reviews video content 1102. The reviewer may answer the questions in AT 1104 by selecting the answering, typing via a keyboard, or by employing any other such user interface provided in the reviewing computer. In this exemplary, but non-limiting embodiment, AT 1104 corresponds to AT 1000 of FIG. 10A.

The questions in AT 1104 may be provided sequentially to the reviewer, or the AT 1104 may be provided in its entirety to the reviewer all at once. As discussed throughout, a web interface, such as web interface 1100 may provide annotations 1108 to the reviewer. Annotations 1108 may provide the reviewer indicators and/or signals of what to pay attention to when reviewing content 1102. Web interface 1100 may enable the reviewer to provide qualitative assessment data, such as comments, descriptions, notes, and other feedback via an interface, such as interface 1106.

FIGS. 11B-11C illustrates another exemplary embodiment of web interface 1180 employed to provide a reviewer at least content 1182 documenting a nurse's performance of using a glucometer to measure blood glucose levels and an associated AT. Similar to web interface 1100 of FIG. 11A, web interface 1180 provides video content 1182, as well as the associated AT 1184 to the reviewer. In various embodiments, the associated AT 1184 may correspond to a protocol that the subject is presumed to follow while performing the subject activity. Crowd reviewers may be enabled to assess at least whether the subject accurately and/or precisely followed the protocol. For instance the AT 1184 corresponds to protocol 900 of FIG. 9. Web interface 1180 also includes annotations 1188 and 1190 to provide the reviewer guidance when reviewing the content, as well providing assessment data, in the form of answering questions included in AT 1184. The annotations may include timestamps, such that the annotations 1188 and 1190 are provided to the reviewer at corresponding points in time when reviewing content 1182. Likewise, the individual questions in AT 1184 may be include timestamps such that the questions are provided to the reviewer at corresponding times when reviewing content 1182.

FIG. 11D illustrates an exemplary embodiment web interface 1190 employed to provide a reviewer at least content documenting a sales associate's performance of a customer interaction and an associated assessment tool. Similar to web interface 1100 of FIG. 11A, web interface 1190 provides content, such as video content, which documents a sales associate's performance of a customer interaction and an associated assessment tool. In at least one embodiment, a computer included in an ATP platform, such as ATP platform 140 of FIG. 1, provides the content to the reviewer. For instance, CSSC 130 of FIG. 1 may provide the content to a reviewing computer used by the reviewer, by streaming the content. In another embodiment, a computer outside of the ATP platform provides the content.

Web interface 1190 provides the reviewer an associated AT. The reviewer may be enabled to provide assessment data regarding her assessment of the performance of the subject activity by answering at least a portion of the questions in the AT provided by web interface 1190, as the reviewer reviews video content. The reviewer may answer the questions in the AT by selecting the answering, typing via a keyboard, or by employing any other such user interface provided in the reviewing computer. In this exemplary, but non-limiting embodiment, the AT shown in web interface includes a question directed to a nonverbal communication domain of the sale associate's performance.

Similar to AT 1104 provided in web interface 1100, the questions in the AT shown in FIG. 11D may be provided sequentially to the reviewer, or the AT may be provided in its entirety to the reviewer all at once. As discussed throughout, a web interface, such as web interface 1190 may provide annotations to the reviewer. The annotations may provide the reviewer indicators and/or signals of what to pay attention to when reviewing content. The annotations provided in web interface 1190 instruct the reviewer to pay attention to the sale associate's nonverbal communication, active listening, oral communication, intercultural sensitivity, and self-preservation skills. Also similar to web interface 1100, web interface 1190 may enable the reviewer to provide qualitative assessment data, such as comments, descriptions, notes, and other feedback via an interface.

FIG. 12A illustrates an exemplary embodiment of report portion 1200, generated by various embodiments disclosed here, that provides a detailed overview of the crowd-sourced assessment of the subject's performance of the subject activity. FIG. 12B illustrates an exemplary embodiment of another report portion 1230 of the report of FIG. 12A, generated by various embodiments disclosed here, that provides the detailed overview of the crowd-sourced assessment of the subject's performance of the subject activity. FIG. 12C illustrates an exemplary embodiment of yet another report portion 1260 of the report of FIG. 12A, generated by various embodiments disclosed here, that provides the detailed overview of the crowd-sourced assessment of the subject's performance of the subject activity.

The report illustrated in FIGS. 12A-12C was generated based on a crowd-sourced assessment of a robotic surgeon performing a robotic surgery. The AT associated with the content that was used in the crowd-sourced assessment is a Global Evaluative Assessment of Robotic Skill (GEARS) validated AT. However, the exemplary embodiments shown in FIGS. 12A-12C should not be construed as limiting, and as discussed throughout, the subject activity and the AT are not limited to healthcare-related activities.

The report of FIGS. 12A-12C is for a team of six surgeons (Surgeon A-Surgeon F). Report portion 1200 of FIG. 12A shows an overview of the team's crowd-sourced assessment. Report portion 1200 includes a ranking of each surgeon 1204, where the surgeons are ranked by an overall score out of 25. The overall score for each surgeon may be determined based on the collated assessment data for each surgeon. Likewise, report portion 1200 includes an average score 1202 for the team. Note that the average score 1202 has been rounded from the actual average team score displayed in the surgeon ranking 1204.

Report portion 1200 also includes a listing of each surgeon's strongest skill 1208 and a listing of each surgeon's weakest skill 1212, based on the crowd-sourced assessment of each surgeon. Report portion 1200 also includes the strongest skill for the team as a whole 1206, as well as the weakest skill for the team as a whole 1210. It should be understood that information included in report portion 1200 may be used by the team for promotional and marketing purposes.

Report portion 1230 of FIG. 12B is specific to Surgeon E (the subject). Report portion 1230 includes the video content 1232 that was assessed by the plurality of reviewers. As discussed further below, video content 1232 provided in the report may have been annotated by one or more of the plurality of reviewers. Such annotations may serve as specific and targeted feedback for the subject to improve her skills and performance. Accordingly, a report generated by the various embodiments may serve as a learning or training tool.

Report portion 1230 also includes a domain score 1234 for each of the technical domains assessed via content 1232 and the associated AT (AT 1000 of FIG. 10A). Note the correspondence between the domain scores 1234 determined based on the crowd-sourced assessment and the questions included in AT 1000. In various embodiments, the domain score 1234 for each technical domain is determined based on a distribution of assessment data for each of the corresponding questions included in AT 1000. For instance, each determined domain score 1234 may be equivalent or similar to the mean or median value of a crowd-sourced distribution for each corresponding question included in the AT 1000.

Report portion 1230 also includes indicators 1236 for the AT employed to assess the performance of Surgeon E, as well as the overall scored for Surgeon E, and the number of crowd reviewers that have contributed to Surgeon E's assessment. In at least one embodiment, the reports are generated in real-time or near real-time as the assessment data is received. In such embodiments, the report portion 1230 is updated as new assessment data is received. For instance, if another reviewer where to provide additional assessment data, the “Ratings to date” entry would automatically increment to 48, and at least each of the scores associated with the technical domains 1234 would automatically be updated based on the additional assessment data.

Report portion 1230 also includes a skill comparison 1238 of the subject with other practitioners. For instance, skill comparison 1238 may compare the crowd-sourced assessment of the various domains for the subject to cohorts of practitioners, such as a local cohort and a global cohort of practitioners. Geo-location data of the subject may be employed to determine a location of the subject and locations of one or more relevant cohorts to compare with the subject's assessment. The skills distribution of local and global cohorts may be employed to determine local and global standards of care for practitioners.

Report portion 1230 also includes learning opportunities 1240. Learning opportunities 1240 may provide exemplary content for each of the technical domains, where the content documents superior skills for each of the technical domains. Separate exemplary content may be provided for each domain assessed by the crowd.

In various embodiments, a platform, such as ATP platform 140 of FIG. 1, automatically or semi-automatically associates content to be included or at least recommended in learning opportunities 1240. The automatic association may be based on at least one or more tags of the learning opportunity content, one or more tags associated with the content that corresponds to report portion 1230, or the domain for which the content is recommended for as a learning opportunity.

In at least one embodiment, the automatic association may be based on a score, as determined via previous reviews of the recommended content. The scores may be scores for the domain of which the content is recommended as a learning opportunity. For instance, learning opportunities 1240 is shown recommending exemplary content for both the depth perception and force sensitivity technical domains of a robotic surgery.

In various embodiments, the platform may determine a customized curriculum that includes at least a portion of the content recommended in learning opportunities 1240. For instance, exercises and other training may be automatically targeted to improve specific skills identified during the review of the subject's performance.

In at least one embodiment, the platform may provide remote or tele-mentoring based on the reviewer provided reviews of the performance of the subject activity, as well as the expert provided reviews. The platform may enable an expert to provide real-time, or near real-time mentoring off the subject, based on the reviewed performance. For instance, the platform may enable collaborative evaluation and reviewing of content focused of specific areas of improvement. The remote mentor and subject may simultaneously review and discuss specific observations within the annotated content, via video conferencing features included in the platform. Learning opportunity content may be automatically selected or manually selected by the mentor to provide opportunities for improvement in the subject's performance. The selection may be based on the performance and skills of the mentee or subject. Learning opportunity content may be selected from a database that includes a large number of previously reviewed and/or annotated content that documents the performance of other subjects.

In at least some embodiments, recommending these particular exemplary choices of content is based on the technical scores, as determined previously by reviewers, of the associated technical domains. As shown in FIG. 12B, the reviewer determined score for the depth perception recommended content is 4.56 out of 5 and the reviewer determined score for the force sensitivity recommended content is 4.38 out of 5. In some embodiments, the recommended content is automatically determined by ranking previously reviewed content available in a content library or database. In some embodiments, at least the content with the highest ranking score for the domain is recommended as a learning opportunity for that domain. FIGS. 14A-14B show exemplary embodiment web interfaces 1400 and 1450 that enable real-time remote mentoring. Within web interfaces 1400 and 1450, the remote mentor and the subject are video conferencing such that the remote mentor may provide instructions to the subject. Cameras included in mobile or network computers employed by the subject and remote mentor may enable the real-time remote mentoring over a network.

In some embodiments, more than a single instance of content may be recommended as a learning opportunity. For instance, the content with the three best scores for a particular domain may be recommended as a learning opportunity for the domain. In some embodiments, content with a low score may also be recommended as a learning opportunity. As such, but superior and deficient content for a domain may be provided so that a viewer of report portion 1230 may compare and contrast superior examples of a domain with deficient examples. Learning opportunities 1240 may provide an opportunity to compare and contrast the contest corresponding to report portion with superior and/or deficient examples of learning opportunity content. An information classification system or a machine learning system may be employed to automatically recommend content with learning opportunities 1240.

Report portion 1260 of FIG. 12C includes a continuation of learning opportunities 1240 from report portion 1230 of FIG. 12B. FIG. 12D illustrates additional learning opportunities 1268 that are automatically provided to the subject by the various embodiments disclosed herein. Report portion 1260 may include curated qualitative assessment data 1262. For instance, comments provided by at least a portion of the reviewers may be provided in report portion 1262. Each of the comments may be curated to be directed towards a specific domain that was assessed.

Report portion 160 may also include a map 1264 with pins to indicate at least a proximate location of the reviewers that contributed to the assessment of the performance of the subject activity. In at least one embodiment, the location of the reviewers is determined based on geo-location data generated by a GPS transceiver included in a reviewing computer used by the reviewer associated with the pin. In some embodiments, the pins indicate whether the associated reviewer is a crowd reviewer, a honed crowd reviewer, or an expert reviewer. The pins may indicate a tiered-level of a honed crowd reviewer. The pins may indicate the status of a reviewer via color coding of the pin.

Report portion 1260 may also include continuing education opportunities 1266 for the subject. For instance, report portion 1260 may include a clickable link, which would provide Surgeon E an opportunity to earn continuing medical education (CME) credits by providing assessment data for another subject.

FIG. 12E shows an exemplary embodiment of a team dashboard 1270 that is included in a report, generated by various embodiments disclosed here, that provides a detailed overview of the crowd-sourced assessment of a sales team's performance of various customer interactions. Team dashboard 1270 may be analogous to report portion 1200, but is directed towards the performance of a sales team, rather than the performance of a team of surgeons. One or more performances for each of the members of the sales team may have been reviewed by a plurality of reviewers via web interface 1190 of FIG. 11D.

FIG. 13A illustrates a scatterplot 1300 showing a correlation between a reviewer generated overall score and an expert reviewer generated overall scores. Such plots may be used to determine calibrations and/or correlations between the assessment data distributions, domain scores, overall scores, rankings, and the like generated by crowd reviewers, honed crowd reviewers, and expert reviewers.

FIG. 13B illustrates a curve 1310 showing a correlation between a reviewer generated overall score and an expert-assessed failure rate. Such a curve may be used to employ crowd-generated assessment data to determine a crowd generated pass/fail determination that reliably replicates pass/fail determinations generated by costly experts.

FIG. 13C illustrates the curve demonstrating the various embodiments enabling the improvement of subject skills. The cold run curve represents the crowd-generated distribution of a composite score of a subject initially performing a subject activity. The warm run curve represents the crowd-generated distribution of a composite score of a subject performing a subject activity after receiving crowd-generate feedback through a report, such as the report shown in FIGS. 12-12C. The expert run curve represents the crowd-generated distribution of a composite score of an expert performing a subject activity. The shift in the warm run mean towards the expert run means demonstrates an objective improvement in the subject's skill. Thus, the subject has shown a fast and objective improvement in the subject's skill that is enabled by an affordable and convenient platform.

FIG. 13D illustrates a histogram showing a crowd-sourced assessment of the success rate for performing each step in a protocol that is provided to a subject. Histogram 1330 is based on crowd reviewers assessing whether each step in protocol 900 of FIG. 9 was successfully completed by a plurality of nursing subjects.

FIGS. 14A-14B show exemplary embodiment web interfaces 1400 and 1450 that enable real-time remote mentoring.

FIG. 15A shows an exemplary embodiment team dashboard for a team of five surgeons being trained by one of the various embodiments disclosed herein, wherein the dashboard 1500 shows the improvement of each of the surgeons over a period of time. FIG. 15B shows the exemplary embodiment team dashboard of FIG. 15A, wherein the dashboard 1520 shows the team's overall improvement over the period of time. FIG. 15C shows the exemplary embodiment team dashboard of FIG. 15A, wherein the dashboard 1540 shows the team's improvement over the period of time for various technical domains. FIG. 15D shows the exemplary embodiment team dashboard of FIG. 15A, wherein the dashboard 1560 shows various metrics for the team that may be viewable by a manager of the team. Dashboard 1560 aggregates various metrics regarding the training and improvement of a team via the various embodiments disclosed herein. This aggregation may be utilized by team managers as an overview of the training of the team members and the team as a whole.

FIG. 16 shows a training module 1600 that is employed to train a crowd reviewer and is consistent with the various embodiments disclosed herein. It will be understood that each block of the flowchart the illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowcharts to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Additionally, in one or more steps or blocks, may be implemented using embedded logic hardware, such as, an Application Specific Integrated Circuit (ASIC), Field Programmable Gate Array (FPGA), Programmable Array Logic (PAL), or the like, or combination thereof, instead of a computer program. The embedded logic hardware may directly execute embedded logic to perform actions some or all of the actions in the one or more steps or blocks. Also, in one or more embodiments (not shown in the figures), some or all of the actions of one or more of the steps or blocks may be performed by a hardware microcontroller instead of a CPU. In at least one embodiment, the microcontroller may directly execute its own embedded logic to perform actions and access its own internal memory and its own external Input and Output Interfaces (e.g., hardware pins and/or wireless transceivers) to perform actions, such as System On a Chip (SOC), or the like.

The above specification, examples, and data provide a complete description of the manufacture and use of the composition of the invention. Since many embodiments of the invention can be made without departing from the spirit and scope of the invention, the invention resides in the claims hereinafter appended.

1. A method for assessing one or more visual performances of one or more physical non-verbal activities by one or more subjects, wherein a network computer includes one or more processors that execute instructions that perform actions to implement the method, comprising:
receiving, over a network by the one or more processors, content that documents the one or more visual performances of the one or more physical non-verbal activities by the one or more subjects, wherein a computer readable non-transitory memory is configured and arranged to store the content;
providing an assessment tool engine to perform actions, including:
modifying, by the one or more processors, the content to include geolocation data for a physical location of the one or more subjects based on a signal provided by a Global Positioning System (GPS) transceiver, wherein the geolocation data is employed to improve the content by providing localization of one or more time zone parameters, currency types, units, or spoken language parameters;
associating, by the one or more processors, one or more assessment tools (ATs) with the content based on at least one or more types of the one or more physical non-verbal activities visually documented by the content, wherein the one or more associated ATs include a plurality of questions directed towards one or more domains for the performance of the one or physical non-verbal activities;
providing, over the network by the one or more processors, the content and the associated one or more ATs to each of a plurality of reviewers;
receiving, over the network by the one or more processors, assessment data provided by one or more of the plurality of reviewers, wherein the assessment data includes one or more answers to the plurality of questions based on an independent assessment, by the one or more of the plurality of reviewers, of viewing the one or more visual performances of the one or more physical non-verbal activities, and wherein the computer readable non-transitory storage memory is configured and arranged to store the assessment data; and
providing an assessment engine, by the one or more processors, to provide and display a report with one or more domain scores, wherein the report is based on the assessment data and content retrieved from the computer readable non-transitory storage media.

2. The method of claim 1, further comprising;
providing, by the one or more processors, a plurality of domain scores, for a first subject included in the one or more subjects, based on the received assessment data;
providing, by the one or more processors, an overall score, for the first subject, based on the plurality of domain scores; and
providing, by the one or more processors, a rank for the first subject based on the overall score and a plurality of other overall scores for a plurality of other subjects.

3. The method of claim 1, further comprising:
providing, by the one or more processors, the one or more subjects with one or more processor readable non-transitory storage media, wherein the one or more processor readable storage media includes instructions, wherein execution of the instructions by the one or more processors performs actions, including one or more of:
capturing, by the one or more processors, the content that documents the one or more visual performances of the one or more physical non-verbal activities by the one or more subjects; or
automatically transmitting the content, over the network, to a platform.

4. The method of claim 1, further comprising:
trimming, by the one or more processors, the content;
providing, by the one or more processors, one or more annotations for the content;
providing, by the one or more processors, one or more timestamps for the content; and
providing, over the network by the one or more processors, the trimmed content, to each of the plurality of reviewers, such that when each of the plurality of reviewers reviews the trimmed content, the one or more annotations are provided to each of the plurality of reviewers at one or more times corresponding to the one or more timestamps.

5. The method of claim 1, wherein the plurality of reviewers includes a plurality of crowd reviewers and each of the plurality of crowd reviewers is unauthorized to perform the one or more physical non-verbal activities.

6. The method of claim 1, further comprising:
providing, by the one or more processors, one or more tags for the content, wherein the one or more tags indicate the one or more types of the physical non-verbal activities; and
automatically associating, by the one or more processors, one or more previously validated ATs with the content based on the one or more tags.

7. The method of claim 1, further comprising:
providing, by the one or more processors, one or more reviewer distributions for the one or more domains based on the assessment data;
normalizing, by the one or more processors, the one or more reviewer distributions based on expert generated assessment data; and
providing, by the one or more processors, the one or more domain scores based on the calibrated one or more reviewer distributions for the one or more domains.

8. The method of claim 1, further comprising:
receiving, over the network by the one or more processors, qualitative assessment data generated by at least a portion of the plurality of reviewers;
curating, by the one or more processors, the qualitative assessment data based on at least a type of a reviewer that generated the qualitative assessment data, wherein the at least type includes one or more of a crowd reviewer, a honed reviewer, and an expert reviewer; and
providing, over the network by the one or more processors, the content, the one or more domain scores, and the curated qualitative assessment data to the one or more subjects.

9. A computer readable non-transitory storage medium that includes instructions for assessing one or more visual performances of one or more physical non-verbal activities by one or more subjects, wherein an execution of the instructions by a network computer that includes one or more processors enables actions, comprising:
receiving, over a network by the one or more processors, content that documents the one or more visual performances of the one or more physical non-verbal activities by the one or more subjects, wherein a computer readable non-transitory memory is configured and arranged to store the content;
providing an assessment tool engine to perform actions, including:
modifying, by the one or more processors, the content to include geolocation data for a physical location of the one or more subjects based on a signal provided by a Global Positioning System (GPS) transceiver, wherein the geolocation data is employed to improve the content by providing localization of one or more time zone parameters, currency types, units, or spoken language parameters;
associating, by the one or more processors, one or more assessment tools (ATs) with the content based on at least one or more types of the one or more physical non-verbal activities visually documented by the content, wherein the one or more associated ATs include a plurality of questions directed towards one or more domains for the performance of the one or physical non-verbal activities;
providing, over the network by the one or more processors, the content and the associated one or more ATs to each of a plurality of reviewers;
receiving, over the network by the one or more processors, assessment data provided by one or more of the plurality of reviewers, wherein the assessment data includes one or more answers to the plurality of questions based on an independent assessment, by the one or more of the plurality of reviewers, of viewing the one or more visual performances of the one or more physical non-verbal activities, and wherein the computer readable non-transitory storage memory is configured and arranged to store the assessment data; and
providing an assessment engine, by the one or more processors, to provide and display a report with one or more domain scores, wherein the report is based on the assessment data and content retrieved from the computer readable non-transitory storage media.

10. The storage medium of claim 9, wherein the actions further comprise;
providing, by the one or more processors, a plurality of domain scores, for a first subject included in the one or more subjects, based on the received assessment data;
providing, by the one or more processors, an overall score, for the first subject, based on the plurality of domain scores; and
providing, by the one or more processors, a rank for the first subject based on the overall score and a plurality of other overall scores for a plurality of other subjects.

11. The storage medium of claim 9, wherein the actions further comprise:
capturing, by the one or more processors, the content that documents the one or more visual performances of the one or more physical non-verbal activities by the one or more subjects; or
automatically transmitting the content, over the network by the one or more processors, to a platform.

12. The storage medium of claim 9, wherein the actions further comprise:
trimming, by the one or more processors, the content;
providing, by the one or more processors, one or more annotations for the content;
providing, by the one or more processors, one or more timestamps for the content; and
providing, over the network by the one or more processors, the trimmed content, to each of the plurality of reviewers, such that when each of the plurality of reviewers reviews the trimmed content, the one or more annotations are provided to each of the plurality of reviewers at one or more times corresponding to the one or more timestamps.

13. The storage medium of claim 9, wherein the plurality of reviewers includes a plurality of crowd reviewers and each of the plurality of crowd reviewers is unauthorized to perform the one or more physical non-verbal activities.

14. The storage medium of claim 9, wherein the actions further comprise:
providing, by the one or more processors, one or more tags for the content, wherein the one or more tags indicate the one or more types of the physical non-verbal activities; and
automatically associating, by the one or more processors, one or more previously validated ATs with the content based on the one or more tags.

15. The storage medium of claim 9, wherein the actions further comprise:
providing, by the one or more processors, one or more reviewer distributions for the one or more domains based on the assessment data;
normalizing, by the one or more processors, the one or more reviewer distributions based on expert generated assessment data; and
providing, by the one or more processors, the one or more domain scores based on the calibrated one or more reviewer distributions for the one or more domains.

16. The storage medium of claim 9, wherein the actions further comprise:
receiving, over the network by the one or more processors, qualitative assessment data generated by at least a portion of the plurality of reviewers;
curating, by the one or more processors, the qualitative assessment data based on at least a type of a reviewer that generated the qualitative assessment data, wherein the at least type includes one or more of a crowd reviewer, a honed reviewer, and an expert reviewer; and
providing, over the network by the one or more processors, the content, the one or more domain scores, and the curated qualitative assessment data to the one or more subjects.

17. A system for assessing one or more visual performances of one or more physical non-verbal activities by one or more subjects, comprising:
a content capturing device that captures content that documents the one or more visual performances of the one or more physical non-verbal activities by the one or more subjects, wherein the content is stored in a computer readable non-transitory memory; and
a network computer that includes one or more processors that execute instructions that perform actions, comprising:
receiving, over a network by the one or more processors, the content that documents the one or more visual performances of the one or more physical non-verbal activities by the one or more subjects;
providing an assessment tool engine to perform actions, including:
modifying, over the network by the one or more processors, the content to include geolocation data for a physical location of the one or more subjects based on a signal provided by a Global Positioning System (GPS) transceiver, wherein the geolocation data is employed to improve the content by providing localization of one or more time zone parameters, currency types, units, or spoken language parameters;
associating, over the network by the one or more processors, one or more assessment tools (ATs) with the content based on at least one or more types of the one or more physical non-verbal activities visually documented by the content, wherein the one or more associated ATs include a plurality of questions directed towards one or more domains for the performance of the one or physical non-verbal activities;
providing, over the network by the one or more processors, the content and the associated one or more ATs to each of a plurality of reviewers;
receiving, over the network by the one or more processors, assessment data provided by one or more of the plurality of reviewers, wherein the assessment data includes one or more answers to the plurality of questions based on an independent assessment, by the one or more of the plurality of reviewers, of viewing the one or more visual performances of the one or more physical non-verbal activities, and wherein the computer readable non-transitory storage memory is configured and arranged to store the assessment data; and
providing an assessment engine, by the one or more processors, to provide and display a report with one or more domain scores, wherein the report is based on the assessment data and content retrieved from the computer readable non-transitory storage media.

18. The system of claim 17, wherein the actions further comprise;
providing, by the one or more processors, a plurality of domain scores, for a first subject included in the one or more subjects, based on the received assessment data;
providing, by the one or more processors, an overall score, for the first subject, based on the plurality of domain scores; and
providing, by the one or more processors, a rank for the first subject based on the overall score and a plurality of other overall scores for a plurality of other subjects.

19. The system of claim 17, wherein the actions further comprise:
providing the one or more subjects with one or more processor readable non-transitory storage media, wherein the one or more processor readable storage media includes instructions, wherein execution of the instructions by the one or more processors performs actions, including one or more of:
capturing, by the one or more processors, the content that documents the one or more visual performances of the one or more physical non-verbal activities by the one or more subjects; or
automatically transmitting the content, over the network by the one or more processors, to a platform.

20. The system of claim 17, wherein the actions further comprise:
trimming, by the one or more processors, the content;
providing, by the one or more processors, one or more annotations for the content;
providing, by the one or more processors, one or more timestamps for the content; and
providing, over the network by the one or more processors, the trimmed content, to each of the plurality of reviewers, such that when each of the plurality of reviewers reviews the trimmed content, the one or more annotations are provided to each of the plurality of reviewers at one or more times corresponding to the one or more timestamps.

21. The system of claim 17, wherein the plurality of reviewers includes a plurality of crowd reviewers and each of the plurality of crowd reviewers is unauthorized to perform the one or more physical non-verbal activities.

22. The system of claim 17, wherein the actions further comprise:
providing, by the one or more processors, one or more tags for the content, wherein the one or more tags indicate the one or more types of the physical non-verbal activities; and
automatically associating, by the one or more processors, one or more previously validated ATs with the content based on the one or more tags.

23. The system of claim 17, wherein the actions further comprise:
providing, by the one or more processors, one or more reviewer distributions for the one or more domains based on the assessment data;
normalizing, by the one or more processors, the one or more reviewer distributions based on expert generated assessment data; and
providing, by the one or more processors, the one or more domain scores based on the calibrated one or more reviewer distributions for the one or more domains.

24. The system of claim 17, wherein the actions further comprise:
receiving, over the network by the one or more processors, qualitative assessment data generated by at least a portion of the plurality of reviewers;
curating, by the one or more processors, the qualitative assessment data based on at least a type of a reviewer that generated the qualitative assessment data, wherein the at least type includes one or more of a crowd reviewer, a honed reviewer, and an expert reviewer; and
providing, over the network by the one or more processors, the content, the one or more domain scores, and the curated qualitative assessment data to the one or more subjects.
